(19) United States
(12) Patent Application Publication
(10) Pub. No.: US 2005/0052452 A1
(43) Pub. Date: Mar. 10, 2005

(54) 3D computer surface model generation

(75) Inventor: Adam Michael Baumberg, Surrey (GB)

Correspondence Address: FITZPATRICK CELLA HARPER & SCINTO, 30 ROCKEFELLER PLAZA, NEW YORK, NY, 10112, US

(73) Assignee: CANON EUROPA N.V., Amstelveen (NL)

(21) Appl. No.: 10/924,955

(22) Filed: Aug. 25, 2004

(30) Foreign Application Priority Data
Sep. 5, 2003 (GB) 0320874.1
Sep. 5, 2003 (GB) 0320876.6

(51) Int. Cl. G06T 15/00

(52) U.S. Cl. 345/419

(57) ABSTRACT

A 3D computer model of an object is generated by processing a preliminary 3D computer model and the silhouette of the object in images recorded at different positions and orientations. The processing comprises calculating smoothing parameters to smooth the 3D computer model in dependence upon a geometric property of different parts of the silhouettes, such as a curvature or width of the silhouette parts, calculating displacements to move surface points in the 3D computer model to positions closer to the projection of the silhouette boundaries in 3D space, and moving surface points in the 3D computer model in accordance with the smoothing parameters and displacements. The 3D computer model is smoothed to different extents in different areas, resulting in a 3D surface in which unwanted artefacts are smoothed out but high curvature features and thin features representing features present on the subject object are not over-smoothed.

The application claims the right of priority under 35 U.S.C. § 119 based on British Patent Application Numbers 0320874.1 and 0320876.6, both filed on 5 Sep. 2003, which are hereby incorporated by reference herein in their entirety as if fully set forth herein.

The present invention relates to computer processing to generate data defining a three-dimensional (3D) computer model of the surface of an object.

Many methods are known for generating a 3D computer model of the surface of an object.

The known methods include “shape-from-silhouette” methods, which generate a 3D computer model by processing images of an object recorded at known positions and orientations to back project the silhouette of the object in each image to give a respective endless cone containing the object and having its apex at the position of the focal point of the camera when the image was recorded. Each cone therefore constrains the volume of 3D space occupied by the object, and this volume is calculated. The volume approximates the object and is known as the “visual hull” of the object, that is the maximal surface shape which is consistent with the silhouettes.

Examples of shape-from-silhouette methods are described, for example, in “Looking to build a model world: automatic construction of static object models using computer vision” by Illingworth and Hilton in Electronics and Communication Engineering Journal, June 1998, pages 103-113, and “Automatic reconstruction of 3D objects using a mobile camera” by Niem in Image and Vision Computing 17 (1999) pages 125-134. The methods described in both of these papers calculate the intersections of the silhouette cones to generate a “volume representation” of the object made up of a plurality of voxels (cuboids). More particularly, 3D space is divided into voxels, and the voxels are tested to determine which ones lie inside the volume defined by the intersection of the silhouette cones. Voxels inside the intersection volume are retained and the other voxels are discarded to define a volume of voxels representing the object. Alternatively, a signed distance function may be evaluated, for example at the voxel centres, and the value 1 is set if the voxel centre is inside all silhouettes or −1 if the voxel centre is outside any silhouette (such a representation sometimes being referred to as a “level set” representation). In both cases the volume representation is then converted to a surface model comprising a plurality of polygons for rendering. This may be done, for example, using the “marching cubes” algorithm described in “Marching Cubes: A High Resolution 3D SURFACE Construction Algorithm” by Lorensen and Cline in Computer Graphics 21 (4): 163-169, proceedings of SIGGRAPH '87.

“A Volumetric Intersection Algorithm for 3d-Reconstruction Using a Boundary-Representation” by Martin Löhlein at http://i31www.ira.uka.de/diplomarbeiten/da_martin_loehlein/Reconstruction.html discloses a shape-from-silhouette method of generating a 3D computer model which does not result in a voxel representation. Instead, the intersections of the silhouette cones from a plurality of images are calculated directly. More particularly, the method starts with a cube containing the object, and intersects it with the first silhouette cone to give a first approximation of the object. This approximation is then intersected with the next cone to give a second approximation, and so on for each respective silhouette cone. To intersect a silhouette cone with an approximation, the cone and the approximation are projected into the image from which the cone was taken. This reduces the cone to the 2d-polygon (silhouette) from which it was made and reduces the approximation from 3d-polygons to 2d-polygons. The cone polygon is then intersected with all the approximation's polygons using a conventional algorithm for 2d-polygon intersection.

EP-A-1,267,309 describes a shape-from-silhouette method of generating a 3D computer model, in which each silhouette is approximated by a plurality of connected straight lines. The back projection of each straight line into 3D space defines the planar face of a polyhedron (the back-projection of all the straight lines from a given silhouette defining a complete polyhedron). The 3D points of intersection of the planar polyhedra faces are calculated and connected to form a polygon mesh. To calculate the points of intersection of the polyhedra faces, a volume containing the subject object is subdivided into parts, each part is tested against the polyhedra and then the part is discarded, subdivided further, or the point of intersection of the polyhedra planar surfaces which pass through the volume is calculated. A volume part is discarded if it lies outside at least one polyhedron because it cannot contain points representing points on the subject object. The volume is subdivided into further parts for testing if it is intersected by more than a predetermined number of polyhedra faces.

All of the techniques described above, however, suffer from the problem that they generate a 3D computer surface model comprising the visual hull of the subject object (whereas, in fact, there are an infinite number of surfaces that are consistent with the silhouettes) and artefacts often appear in a visual hull 3D computer model which do not exist on the object in real-life.

Two particular types of artefacts which decrease the accuracy of a visual hull 3D computer model of an object are convex artefacts which appear on top of planar surfaces forming a “dome” on the planar surface, and convex and concave artefacts which appear in high curvature surface regions forming “creases” and “folds” in the surface that are not present on the object.

A further problem that often arises with a visual hull 3D computer model of an object is that a thin part of the object is not represented by sufficient surface points in the computer model to accurately model the part's shape. This problem arises principally because there are insufficient images from different directions of the thin part for a shape-from-silhouette technique to accurately model the part.

To address the problem of artefacts in a 3D computer surface model, it is known to smooth the 3D surface. This is done by applying a smoothing filter to move points defining the 3D surface to produce an overall smoother surface. Such techniques are described, for example, in “A Signal Processing Approach to Fair Surface Design” by Taubin in SIGGRAPH'95 Conference Proceedings, Annual Conference Series, pages 351-358, Edison-Wesley, August 1995 and “Anisotropic Geometric Diffusion in Surface Processing” by Clarenz et al in Proceedings Visualization 2000, IEEE Computer Society Technical Committee on Computer Graphics 2000, pages 397-405.

All of these smoothing techniques, however, generate a smoothed surface which, if projected into the images containing the silhouettes used to generate the original 3D computer surface model, will not generate the starting silhouettes. In many cases, the techniques result in loss of detail and an overly-smooth 3D surface. To prevent this over-smoothing, the amount of smoothing can be reduced by reducing the size of the smoothing kernel. However, this means that artefacts are only slightly smoothed and remain present in the 3D computer surface model. In addition, it has also been noticed that Gaussian smoothing operations do not preserve the volume of the subject object and that 3D computer surface models have a tendency to shrink when Gaussian smoothing is applied.

A further problem with known smoothing techniques is that they remove, or significantly distort, parts of the 3D computer model representing thin parts of the object.

“Stereoscopic Segmentation” by Yezzi and Soatto in ICCV 01, pages I:56-66, 2001 describes a technique for reconstructing scene shape and radiance from a number of calibrated images. The technique generates a 3D computer surface model that has the smoothest shape which is photometrically consistent with the starting data. In this technique, a cost function is set up for a starting 3D surface which imposes a cost on the discrepancy between the projection of the surface and images showing the subject object. The cost function depends upon the surface itself as well as the radiance function of the surface and the radiance function of the background. The technique adjusts the 3D surface model and radiance to match the images of the subject object. The cost function comprises the weighted sum of three terms, namely a data term that measures the discrepancy between images of the subject object and images predicted by the model, a smoothness term for the estimated radiances and a geometric prior. In order to find the surface and the radiances that minimise the cost function, an iterative procedure is performed which starts with an initial surface, computes optimal radiances based upon this surface, and then updates the 3D surface through a gradient flow based on the first variation of the cost function.

This technique, too, suffers from problems, however. More particularly, the surface is updated through a gradient flow that applies uniform smoothing to the surface, resulting in an over-smoothed 3D computer surface model similar to that produced by the other smoothing techniques described above.

The present invention has been made with these problems in mind.

According to the present invention, there is provided a 3D computer graphics processing method and apparatus for processing a preliminary 3D surface for a subject object in accordance with measurements made on at least one geometric property of silhouettes of the subject object for different viewing directions so as to apply variable smoothing to the surface in accordance with the measurements.

The present invention also provides a 3D computer processing apparatus and method for generating a 3D computer surface model of an object by measuring at least one geometric property of silhouettes of the object arranged at different positions and orientations in 3D space, and calculating a three-dimensional surface representing the object in dependence upon the measurements.

Examples of the geometric property that may be measured are the curvature of the silhouettes and the width of the silhouettes although other geometric properties may be measured instead.

It has been found that these features facilitate the generation of a 3D computer surface model of the subject object with fewer artefacts than prior art techniques.

In addition, the features facilitate the generation of an acceptably accurate 3D computer surface model of a subject object using fewer silhouettes than techniques which generate a visual hull 3D computer surface model.

The present invention also provides a 3D computer graphics processing method and apparatus for processing a preliminary 3D surface for a subject object in accordance with silhouettes of the subject object for different viewing directions so as to apply variable smoothing to the surface such that the surface is smoothed except in high curvature regions which, as a result of tests on the silhouettes, have been determined to represent features actually present on the subject object.

The present invention also provides a 3D computer processing apparatus and method for generating a 3D computer surface model of an object by measuring the curvature of silhouettes of the object arranged at different positions and orientations in 3D space, and calculating a three-dimensional surface representing the object in dependence upon the measured curvatures.

It has been found that these features facilitate the generation of a 3D computer surface model of the subject object with fewer artefacts than prior art techniques.

In addition, the features facilitate the generation of an acceptably accurate 3D computer surface model of a subject object using fewer silhouettes than techniques which generate a visual hull 3D computer surface model.

The present invention also provides a 3D computer processing method and apparatus for processing a preliminary 3D surface for a subject object in accordance with silhouettes of the subject object for different viewing directions so as to apply variable smoothing to the surface such that the surface is smoothed except in regions which, as a result of tests on the silhouettes, have been determined to represent relatively thin features of the subject object.

The present invention also provides a 3D computer processing apparatus and method for generating a 3D computer surface model of an object by measuring the widths of silhouettes of the object arranged at different positions and orientations in 3D space, and calculating a three-dimensional surface representing the object in dependence upon the measured widths.

According to the present invention, there is provided a 3D computer processing method and apparatus for processing a preliminary 3D surface for a subject object in accordance with silhouettes of the subject object for different viewing directions so as to change the relative numbers of points representing different parts of the subject object such that the number of points is increased for parts which, as a result of tests on the silhouettes, have been determined to represent relatively thin features of the subject object.

It has been found that these features facilitate the generation of a 3D computer surface model of the subject object with fewer artefacts and/or in which thin parts of the subject object are more accurately modelled than prior art techniques.

In addition, the features facilitate the generation of an acceptably accurate 3D computer surface model of a subject object using fewer silhouettes than techniques which generate a visual hull 3D computer surface model.

The present invention also provides a physically-embodied computer program product, for example a storage device carrying instructions or a signal carrying instructions, having instructions for programming a programmable processing apparatus to become operable to perform a method as set out above or to become configured as an apparatus as set out above.

Embodiments of the invention will now be described, by way of example only, with reference to the accompanying drawings, in which:

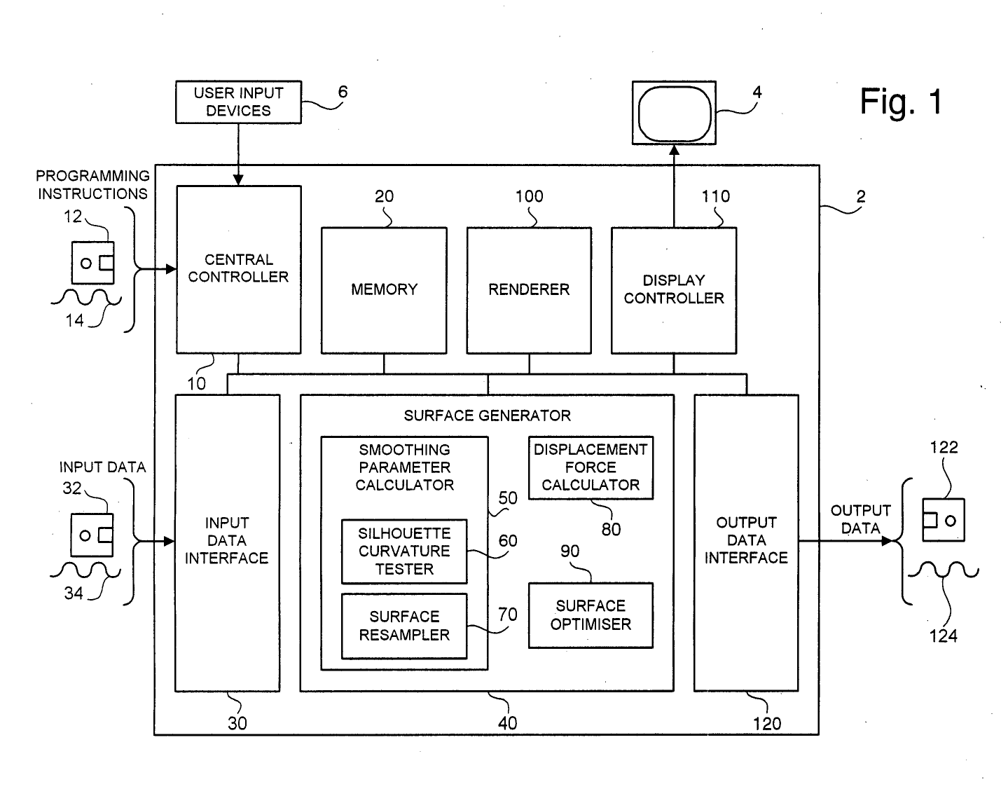

FIG. 1 schematically shows the components of a first embodiment of the invention, together with the notional functional processing units into which the processing apparatus component may be thought of as being configured when programmed by programming instructions;

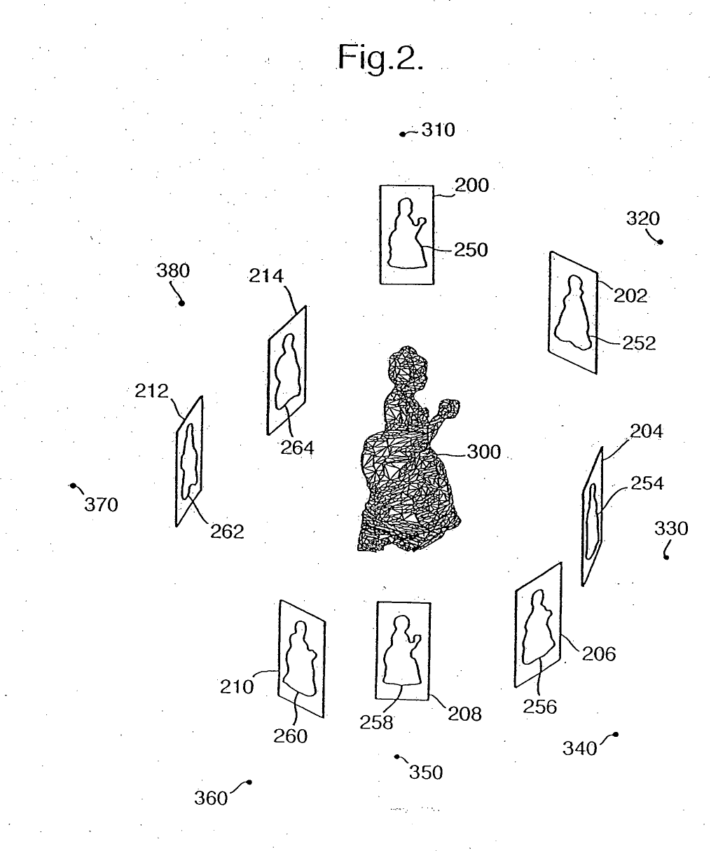

FIG. 2 shows an example to illustrate the data input to the processing apparatus in FIG. 1 to be processed to generate a 3D computer surface model;

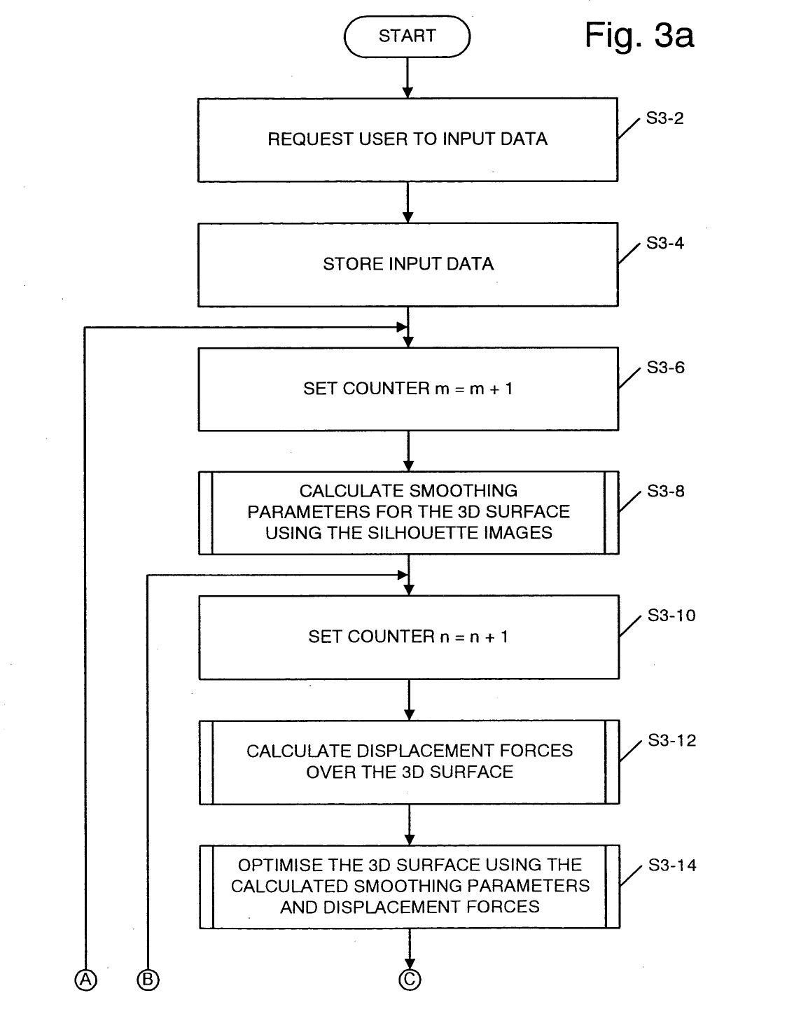

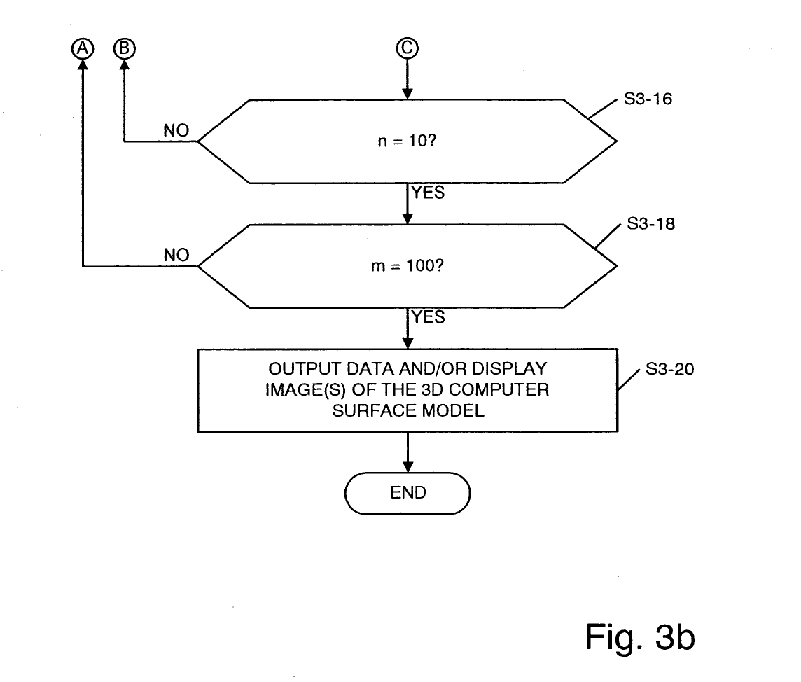

FIG. 3, comprising FIGS. 3a and 3b, shows the processing operations performed by the processing apparatus in FIG. 1 to process input data to generate a 3D computer surface model;

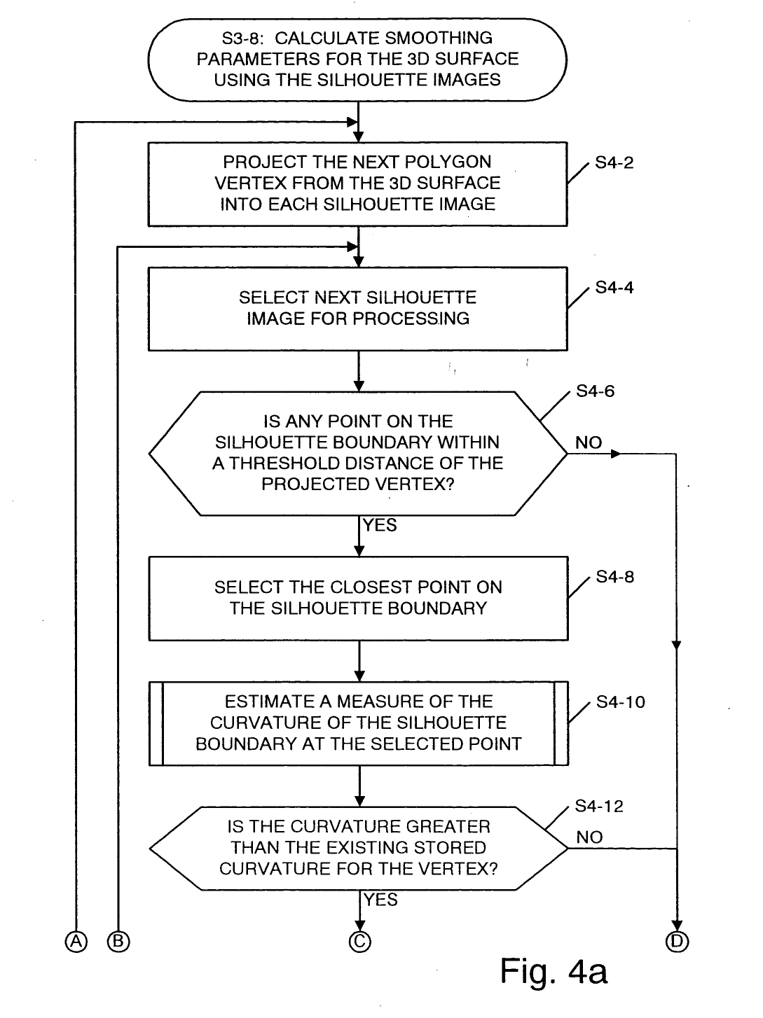

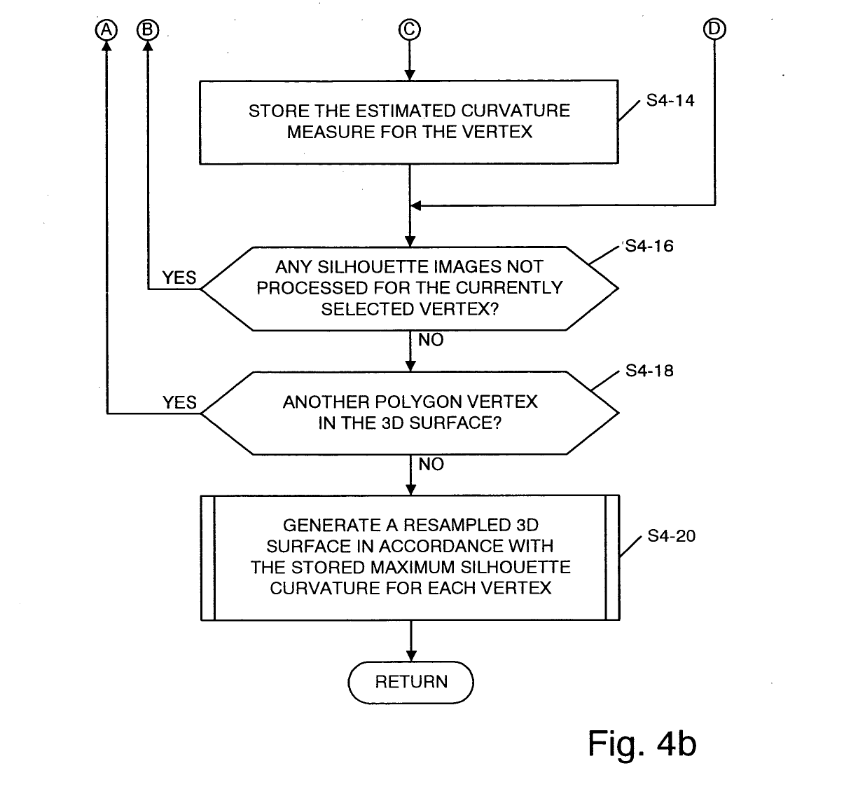

FIG. 4, comprising FIGS. 4a and 4b, shows the processing operations performed at step S3-8 in FIG. 3;

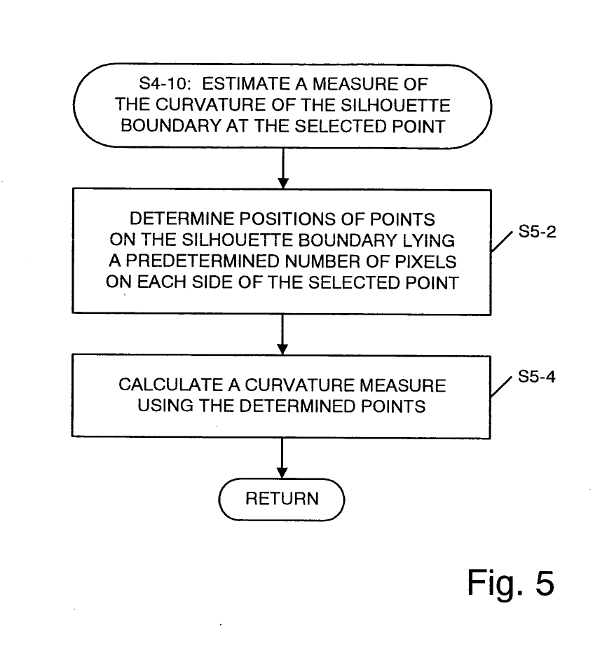

FIG. 5 shows the processing operations performed at step S4-10 in FIG. 4;

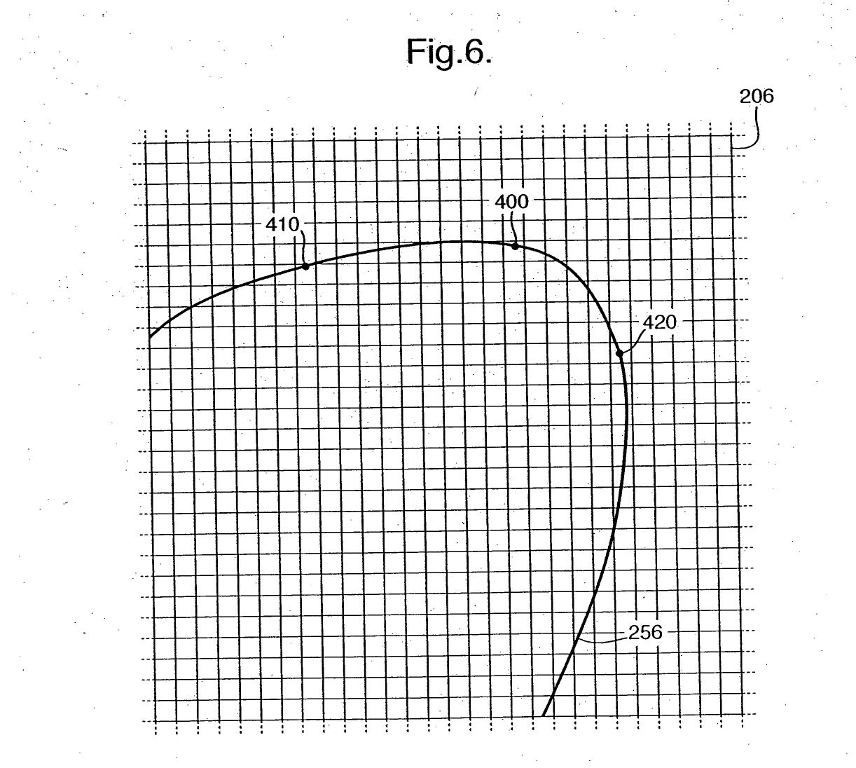

FIG. 6 shows an example to illustrate the processing performed at step S5-2 in FIG. 5;

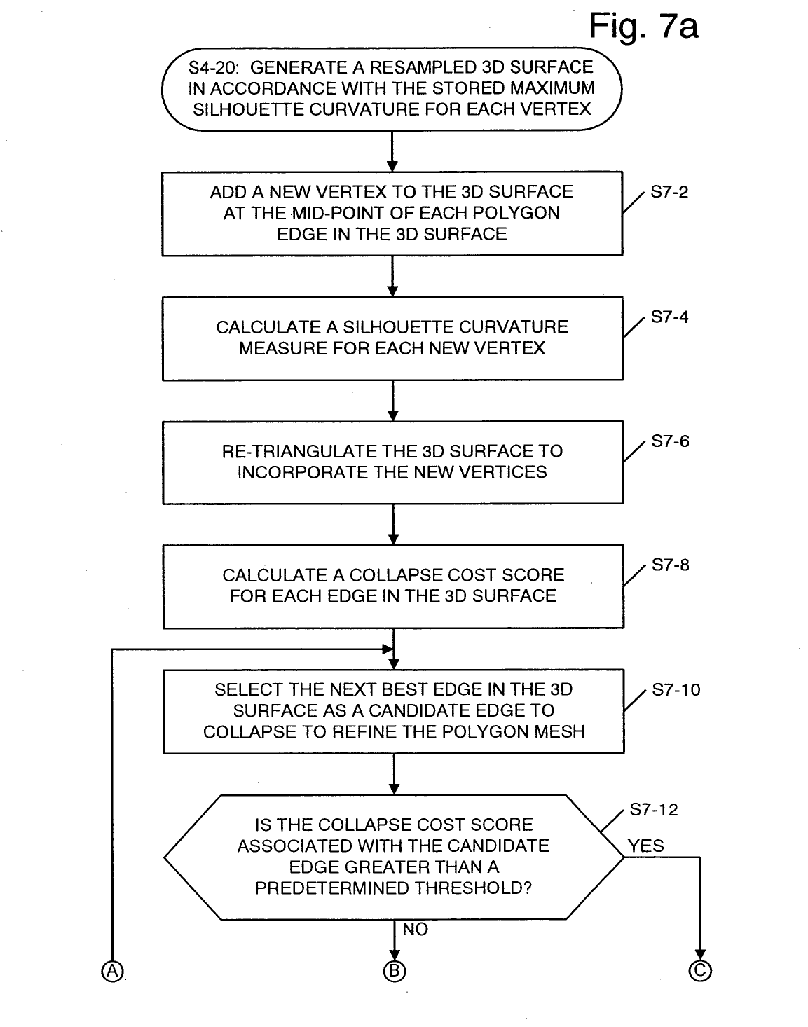

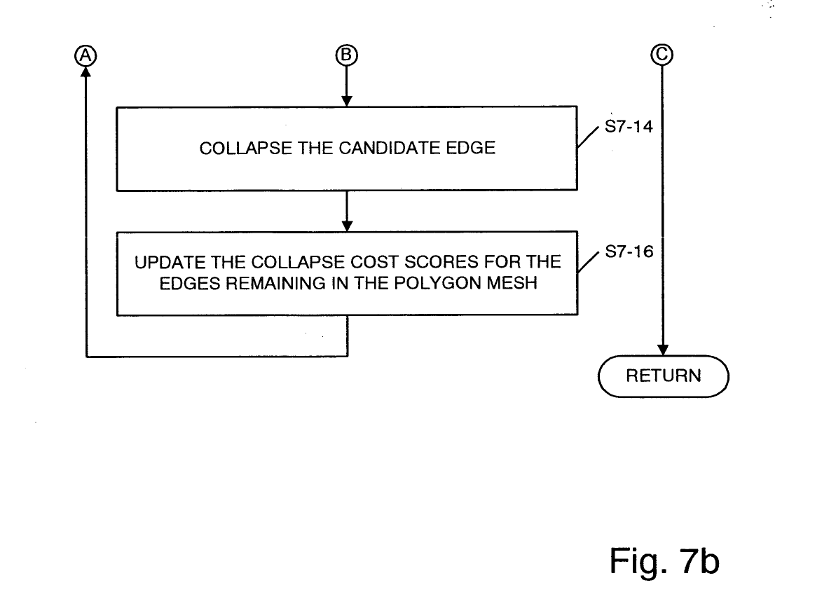

FIG. 7, comprising FIGS. 7a and 7b, shows the processing operations performed at step S4-20 in FIG. 4;

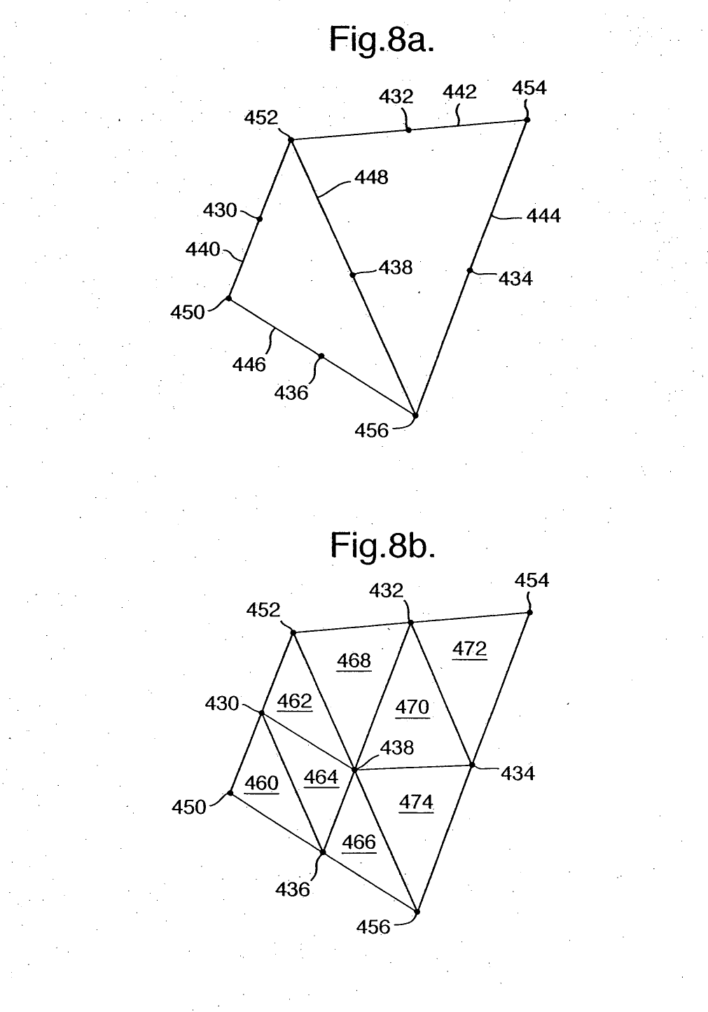

FIGS. 8a and 8b show an example to illustrate the processing performed at step S7-2 and step S7-6 in FIG. 7, respectively;

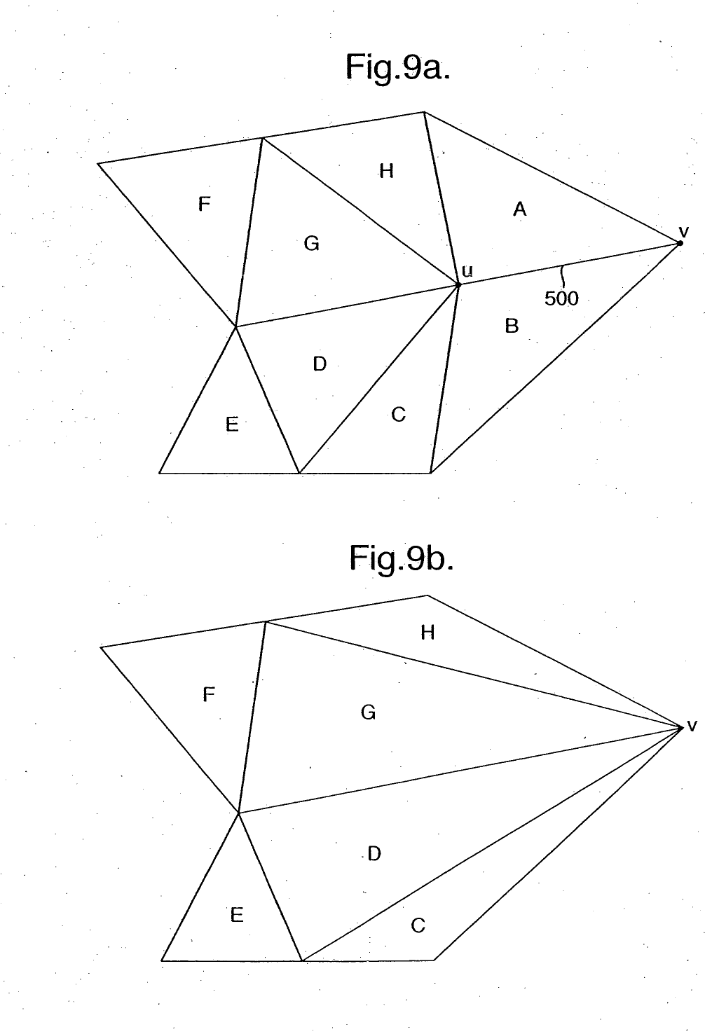

FIGS. 9a and 9b show an example to illustrate the processing performed at step S7-14 in FIG. 7;

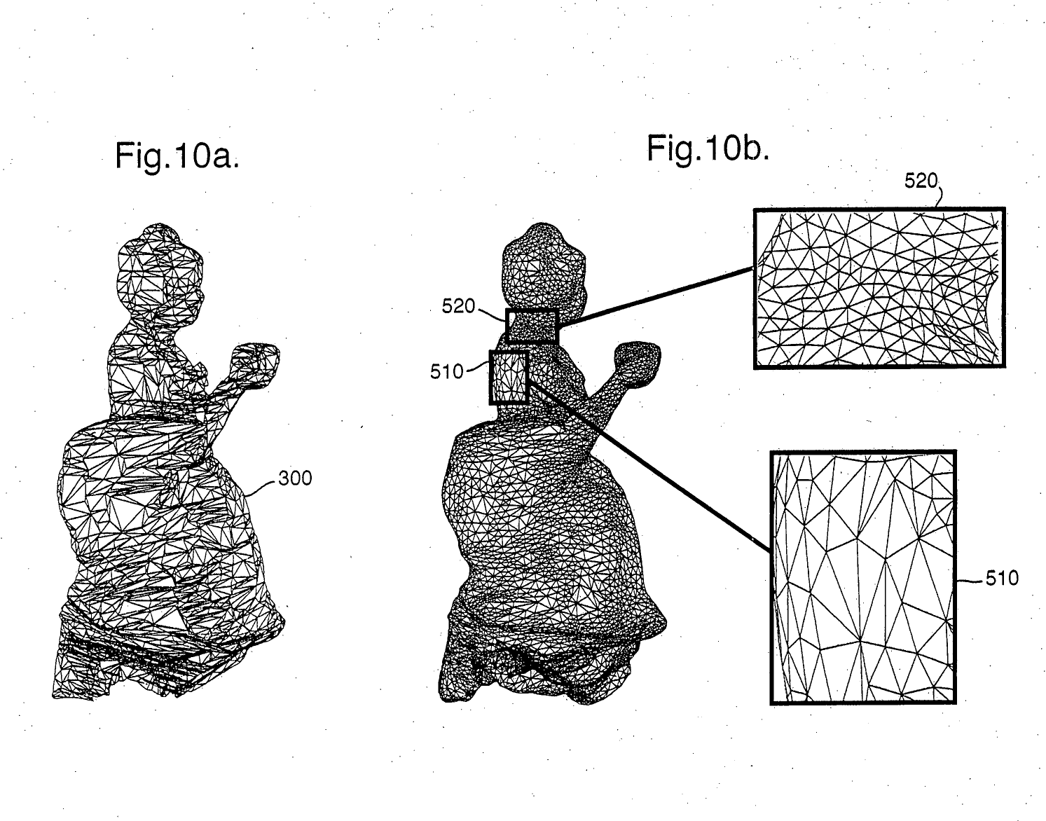

FIGS. 10a and 10b show an example to illustrate the result of the processing performed at step S4-20 in FIG. 4;

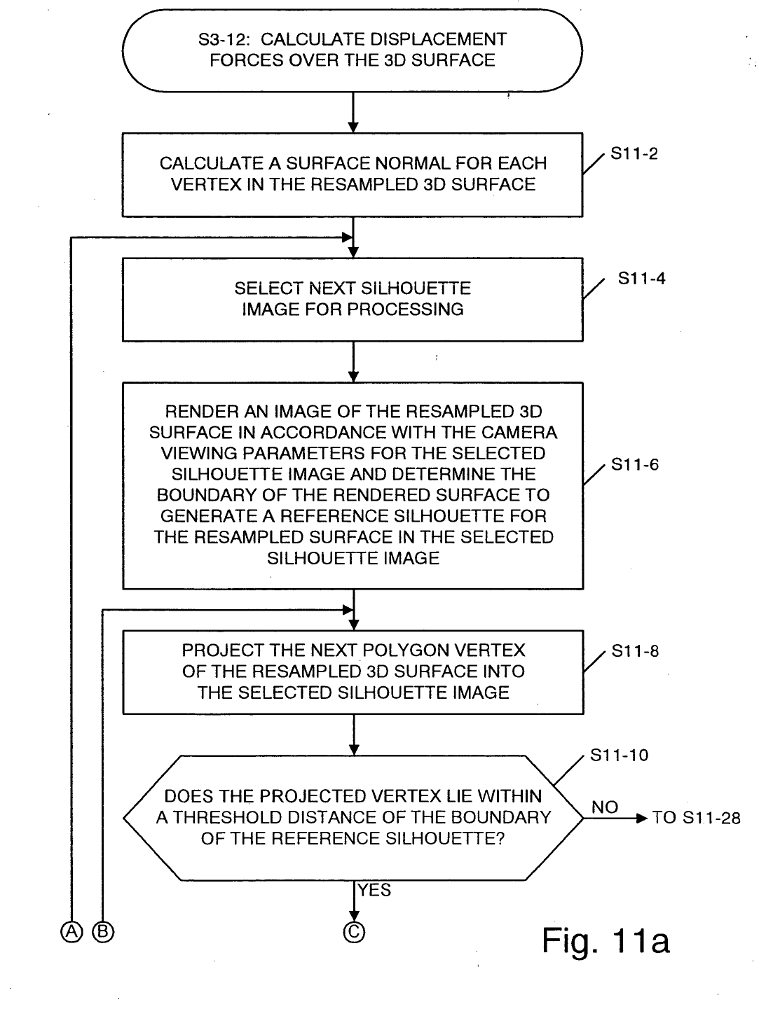

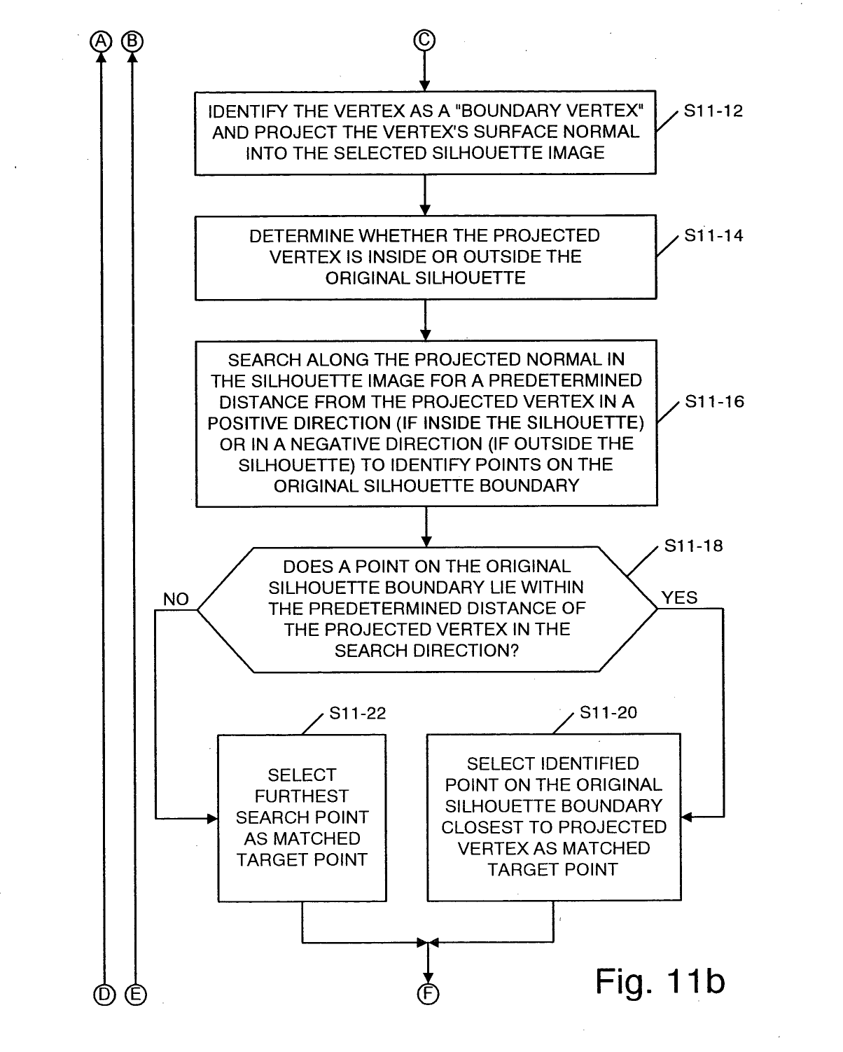

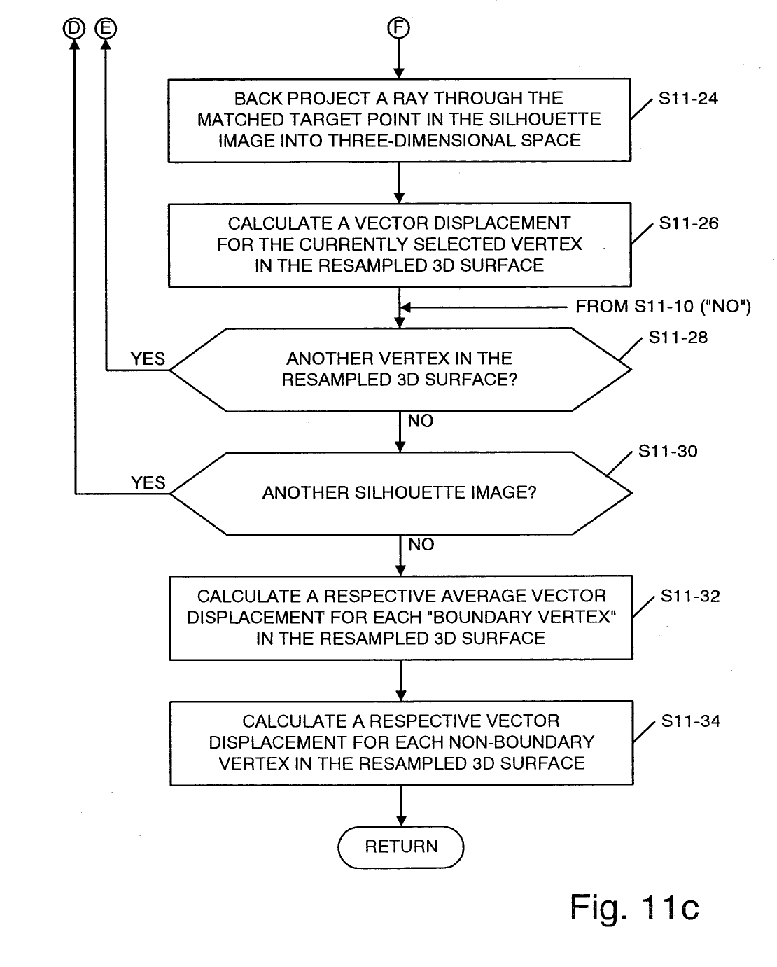

FIG. 11, comprising FIGS. 11a, 11b and 11c, shows the processing operations performed at step S3-12 in FIG. 3;

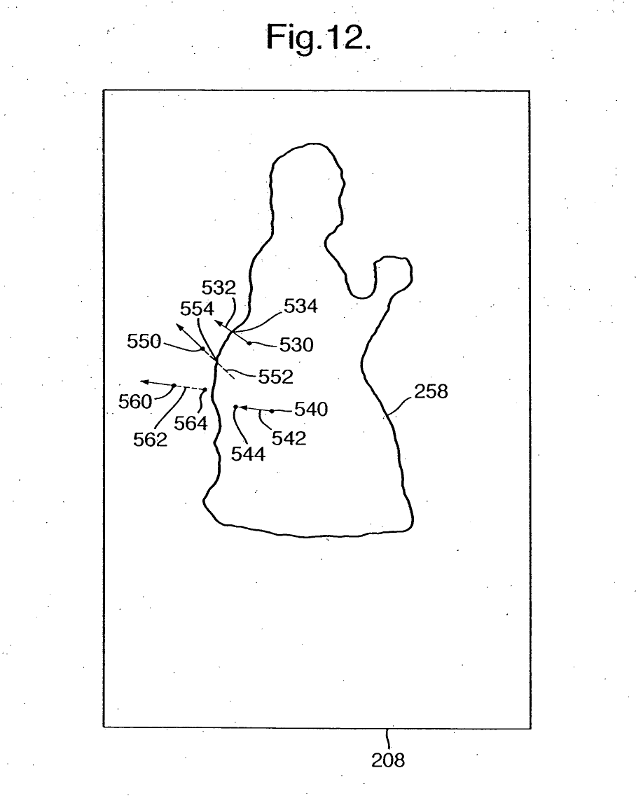

FIG. 12 shows an example to illustrate the processing performed at steps S11-14 to S11-22 in FIG. 11;

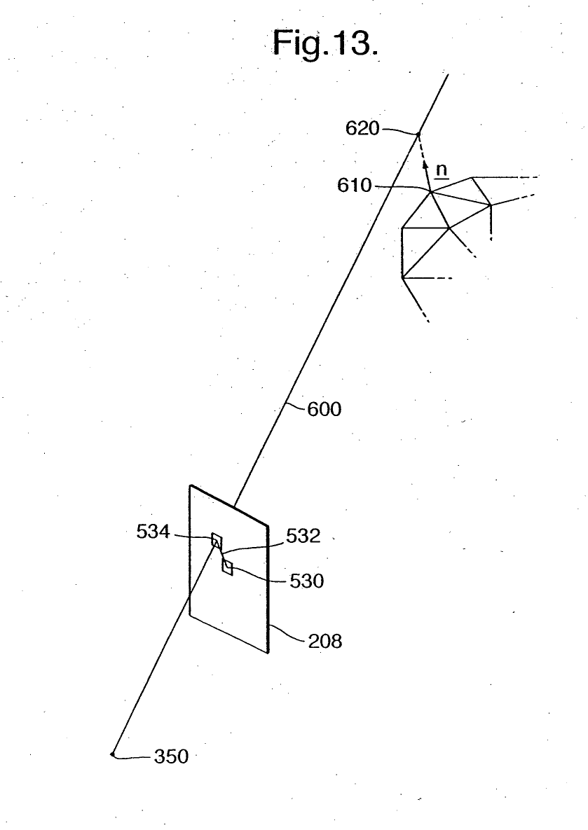

FIG. 13 shows an example to illustrate the processing performed at steps S11-24 and S11-26 in FIG. 11;

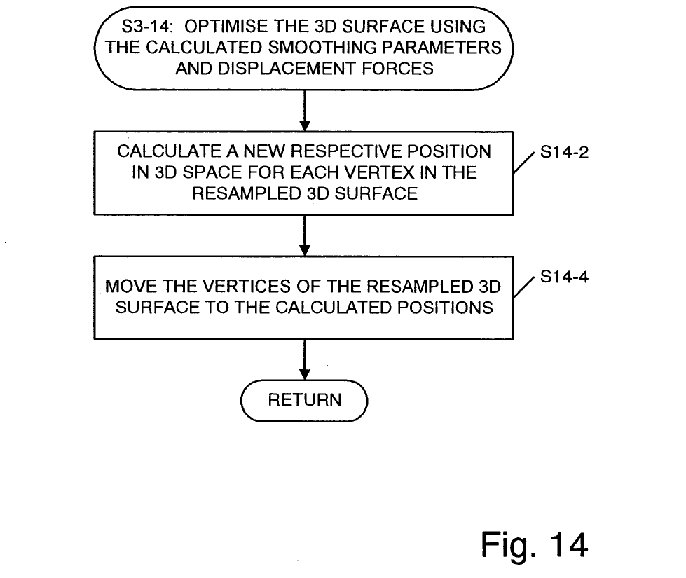

FIG. 14 shows the processing operations performed at step S3-14 in FIG. 3;

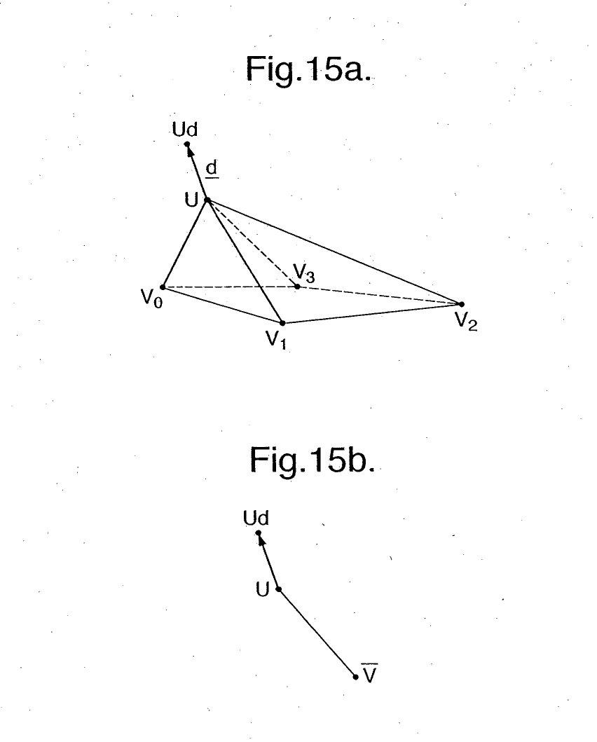

FIGS. 15a and 15b show an example to illustrate the processing performed at step S14-2 in FIG. 14;

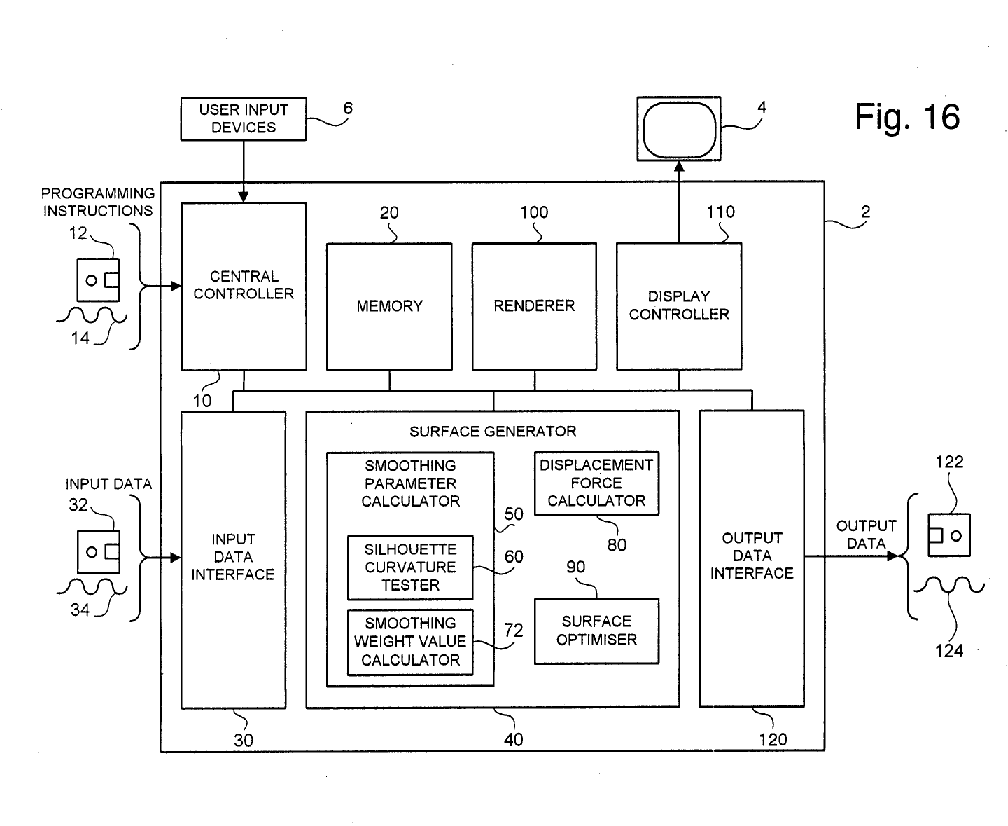

FIG. 16 schematically shows the components of a second embodiment of the invention, together with the notional functional processing units into which the processing apparatus component may be thought of as being configured when programmed by programming instructions;

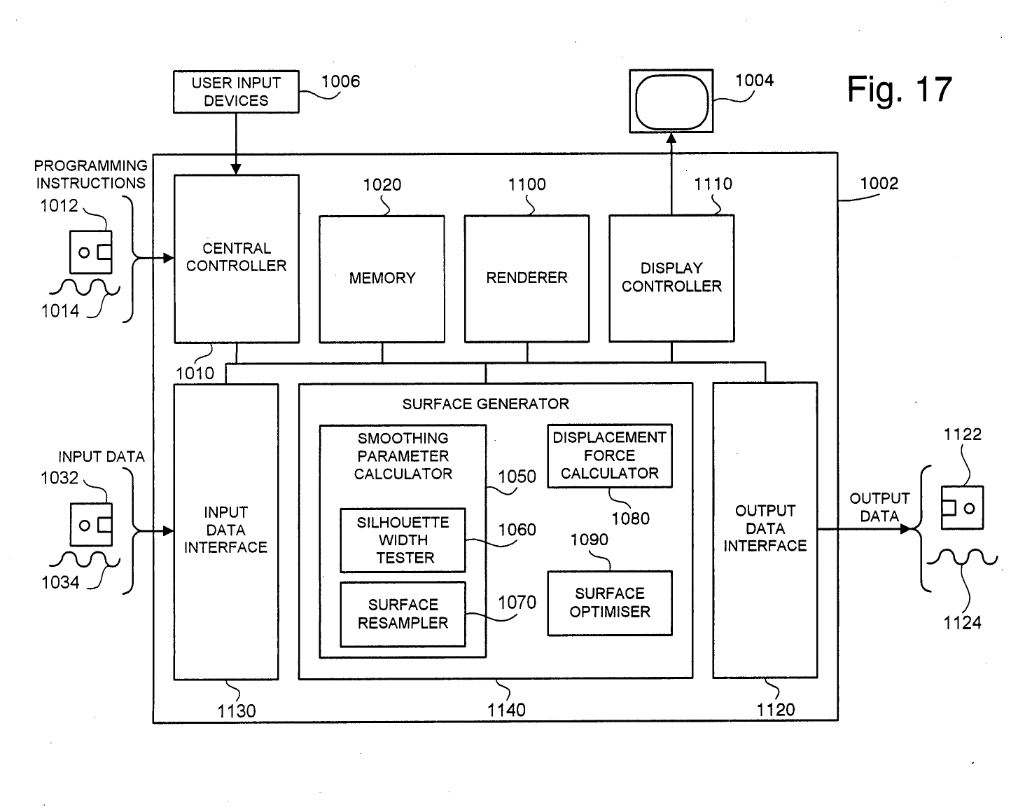

FIG. 17 schematically shows the components of a fourth embodiment of the invention, together with the notional functional processing units into which the processing apparatus component may be thought of as being configured when programmed by programming instructions;

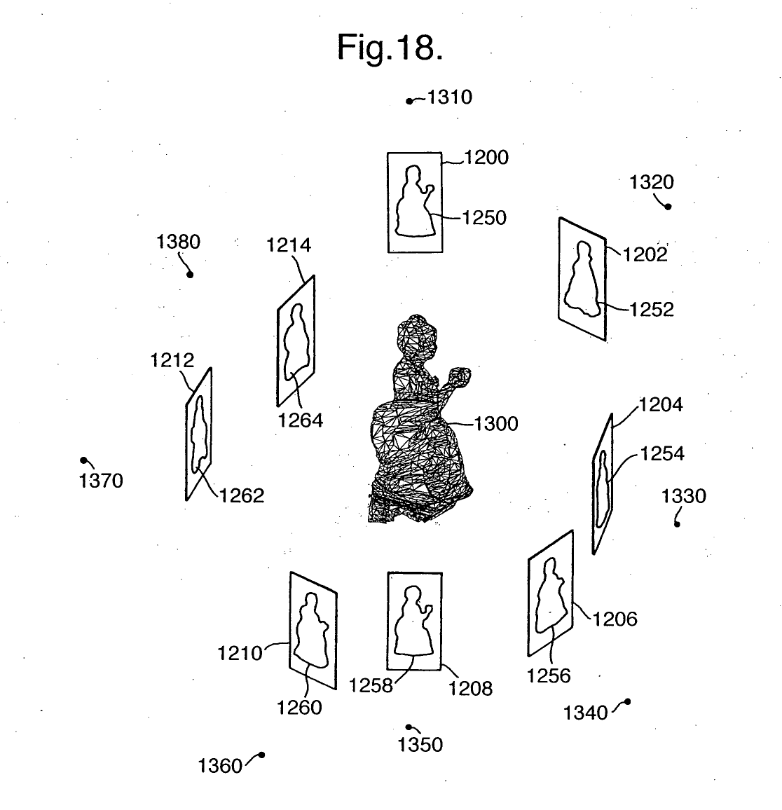

FIG. 18 shows an example to illustrate the data input to the processing apparatus in FIG. 17 to be processed to generate a 3D computer surface model;

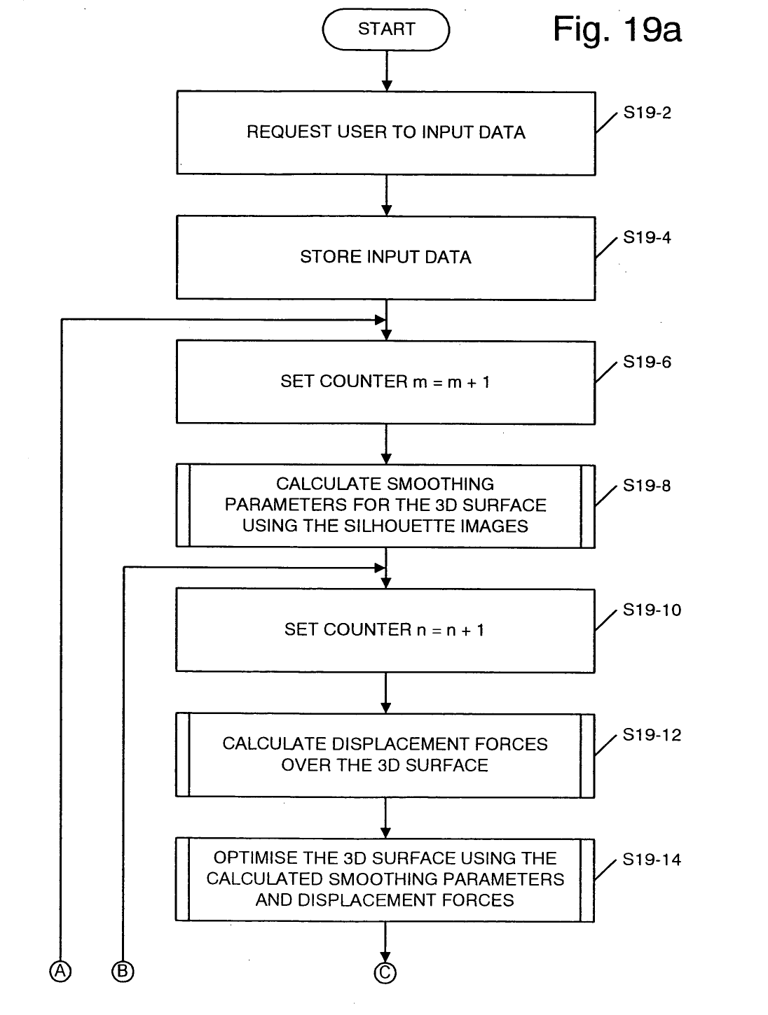

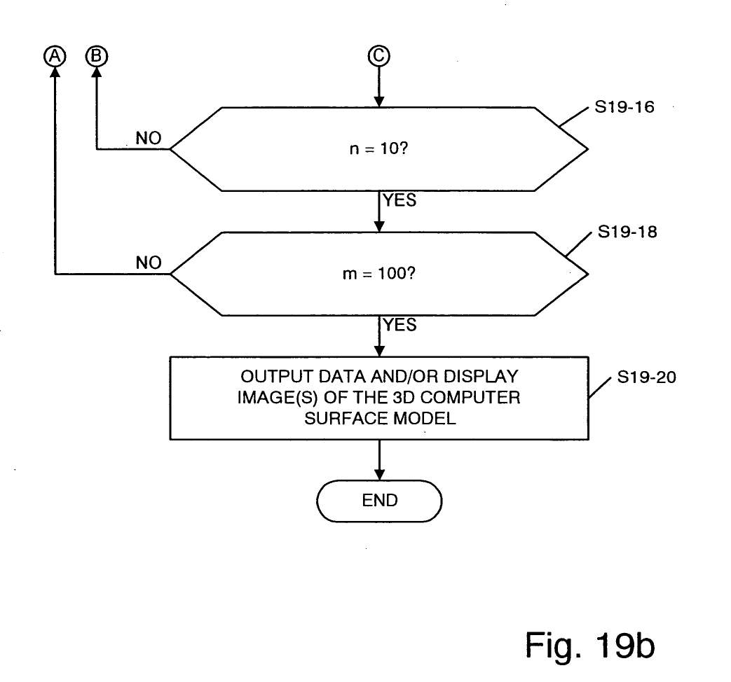

FIG. 19, comprising FIGS. 19a and 19b, shows the processing operations performed by the processing apparatus in FIG. 17 to process input data to generate a 3D computer surface model;

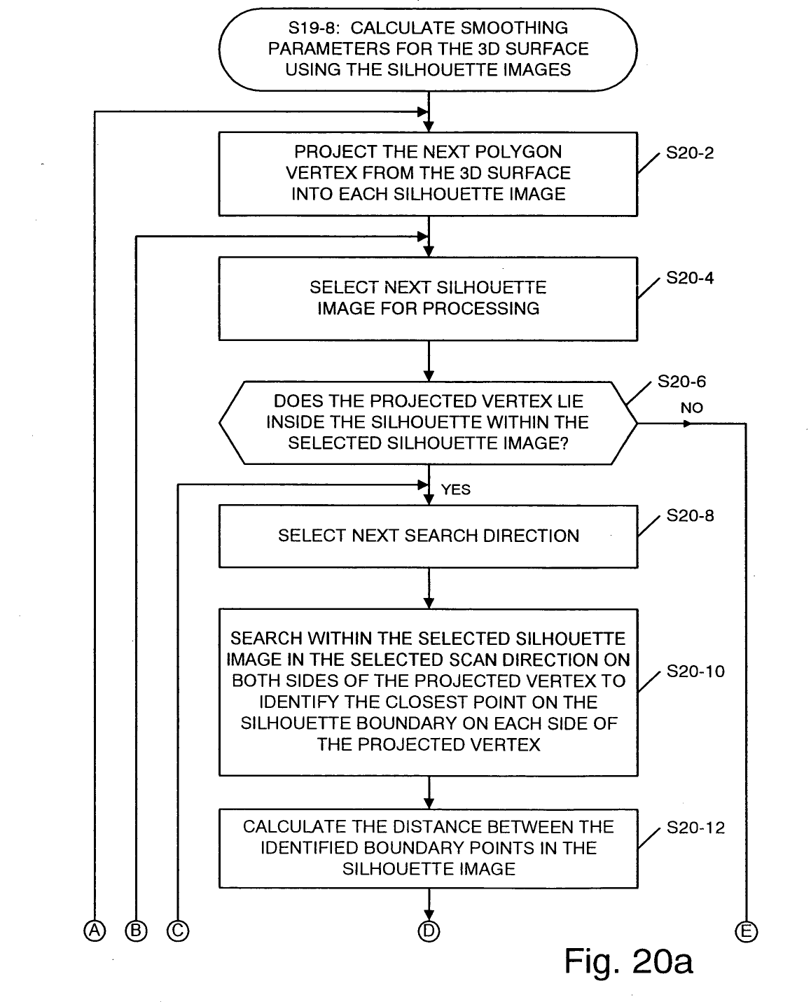

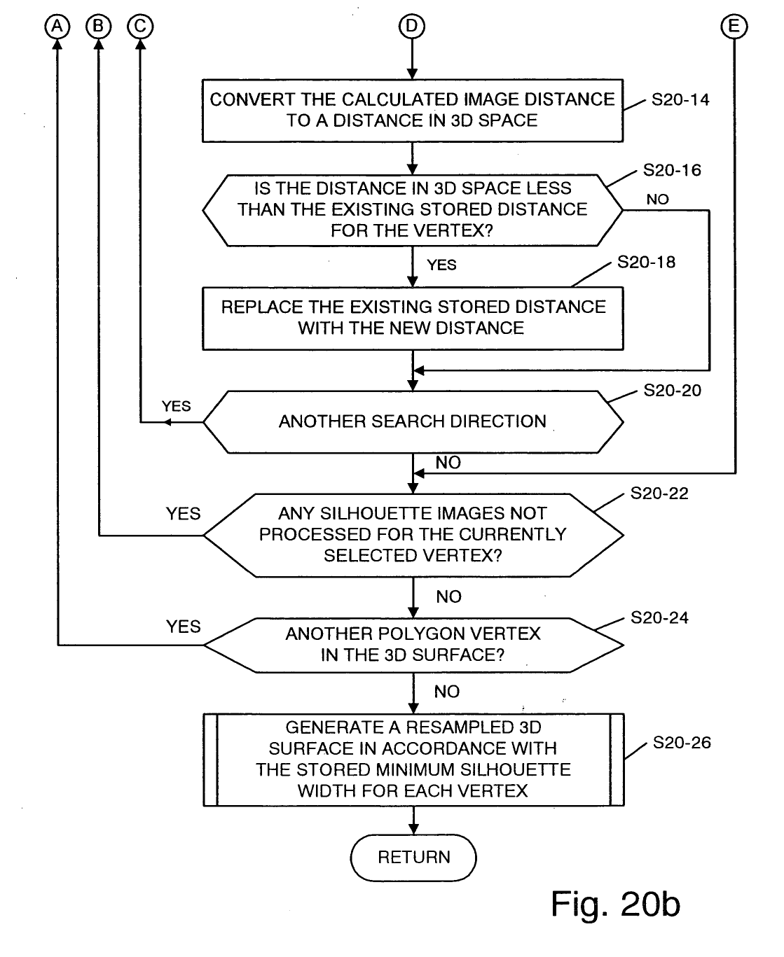

FIG. 20, comprising FIGS. 20a and 20b, shows the processing operations performed at step S19-8 in FIG. 19;

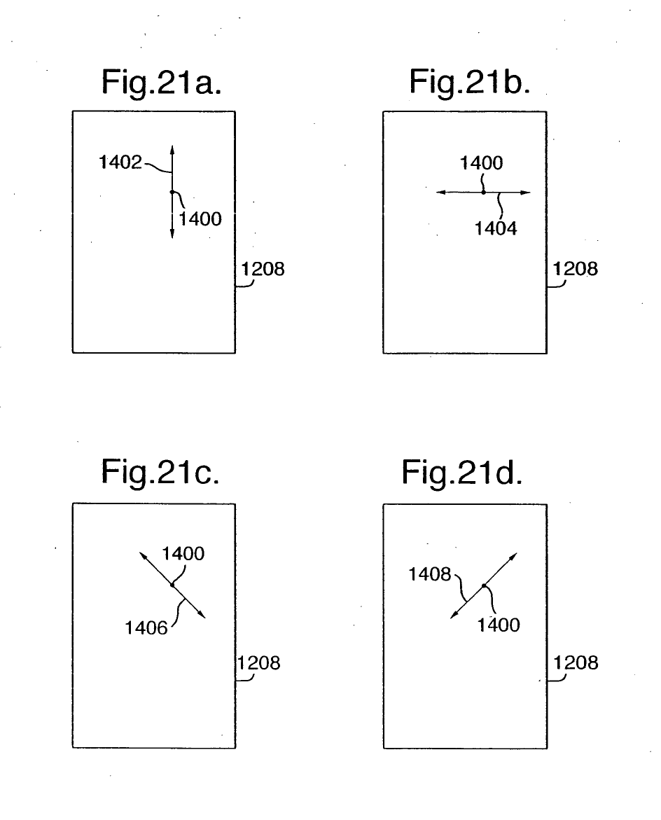

FIG. 21a to 21d show examples to illustrate the search directions available for selection at step S20-8 in the fourth embodiment;

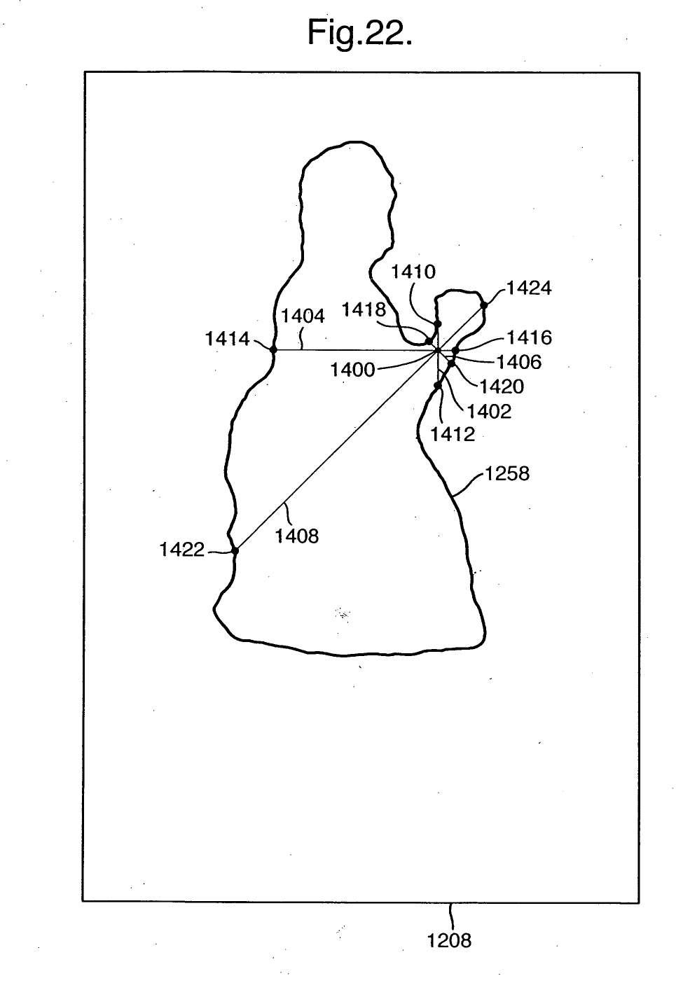

FIG. 22 shows an example to illustrate the processing performed at steps S20-10 and S20-12 in FIG. 20;

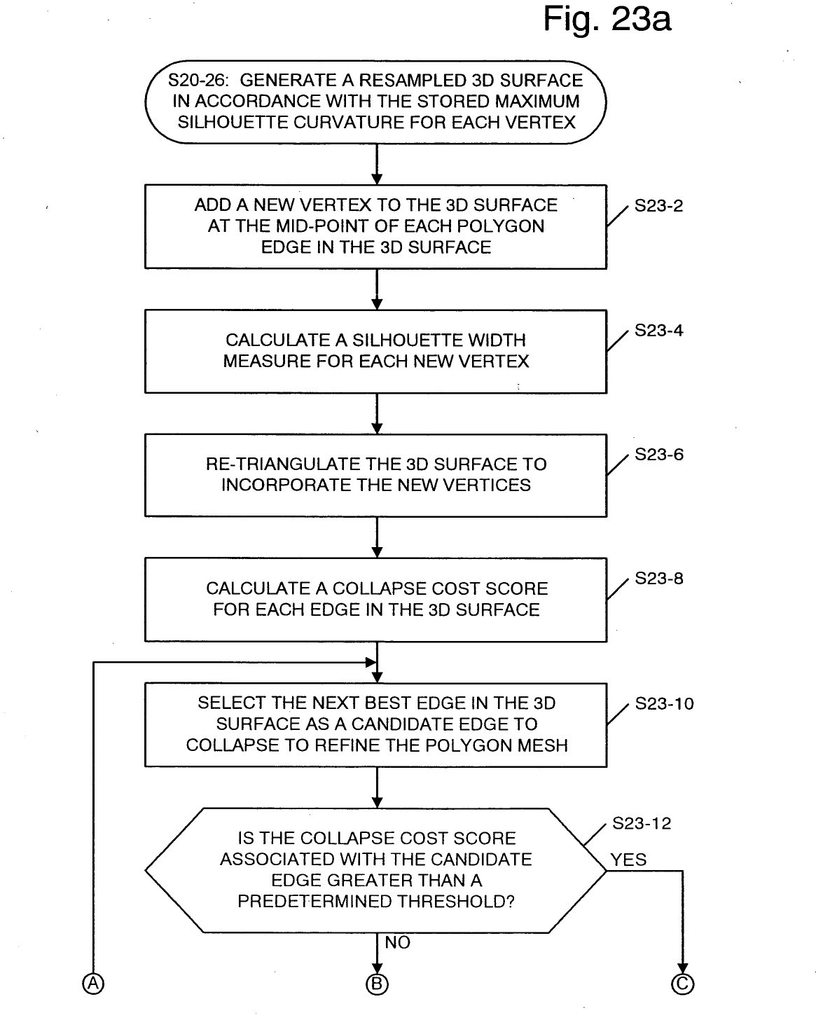

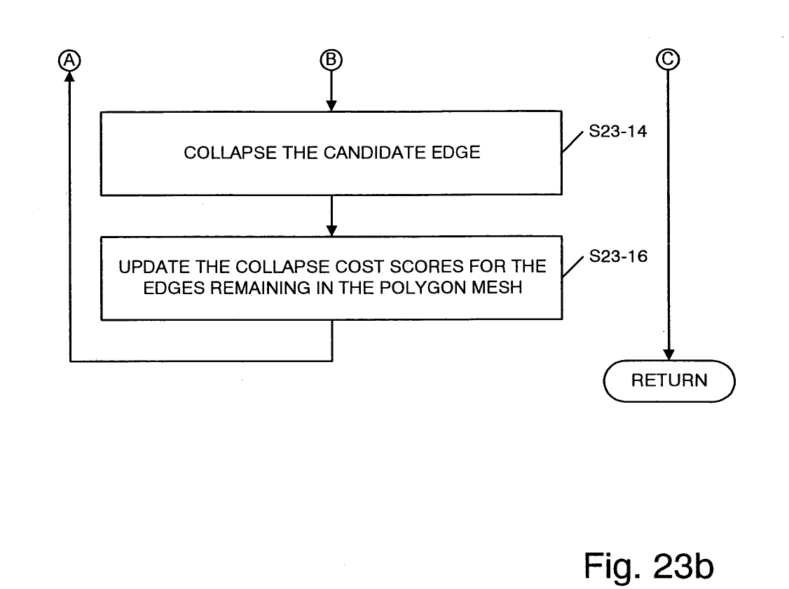

FIG. 23, comprising FIGS. 23a and 23b, shows the processing operations performed at step S20-26 in FIG. 20;

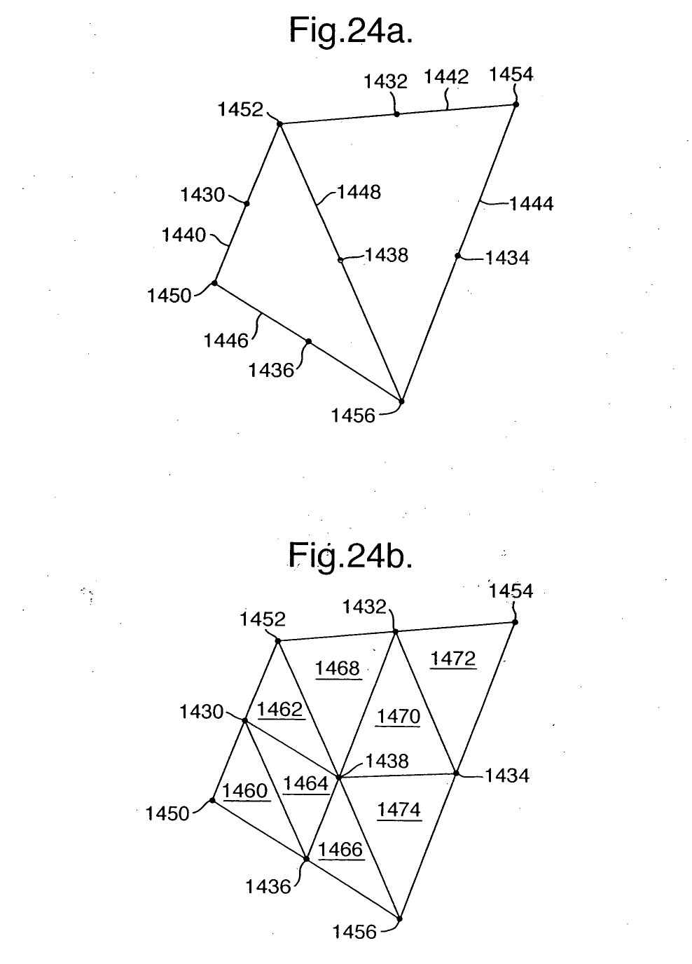

FIGS. 24a and 24b show an example to illustrate the processing performed at step S23-2 and step S23-6 in FIG. 23, respectively;

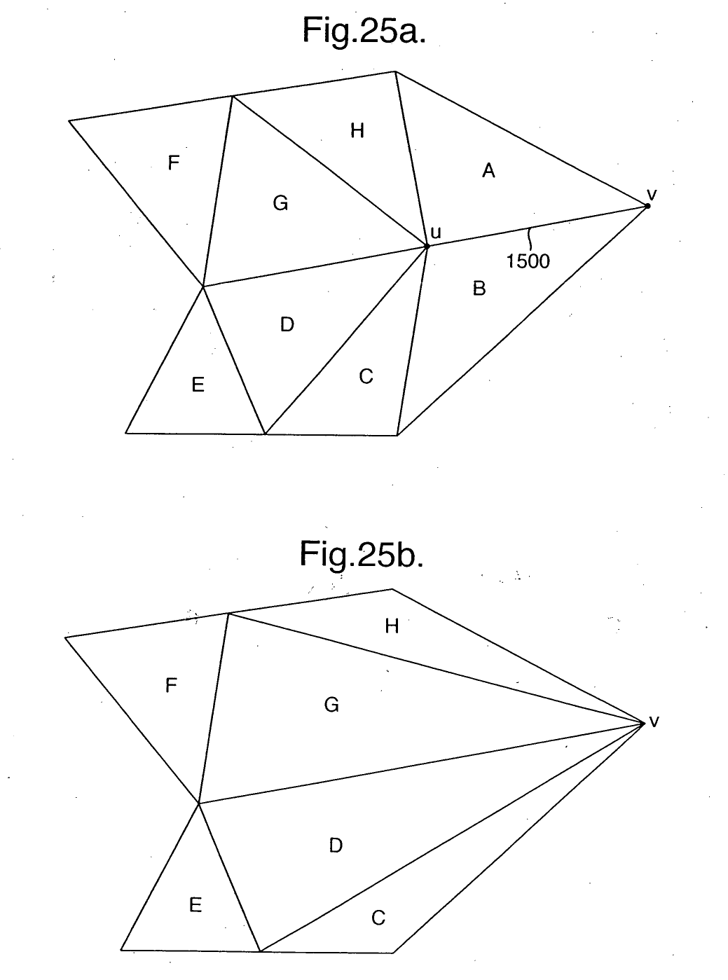

FIGS. 25a and 25b show an example to illustrate the processing performed at step S23-14 in FIG. 23;

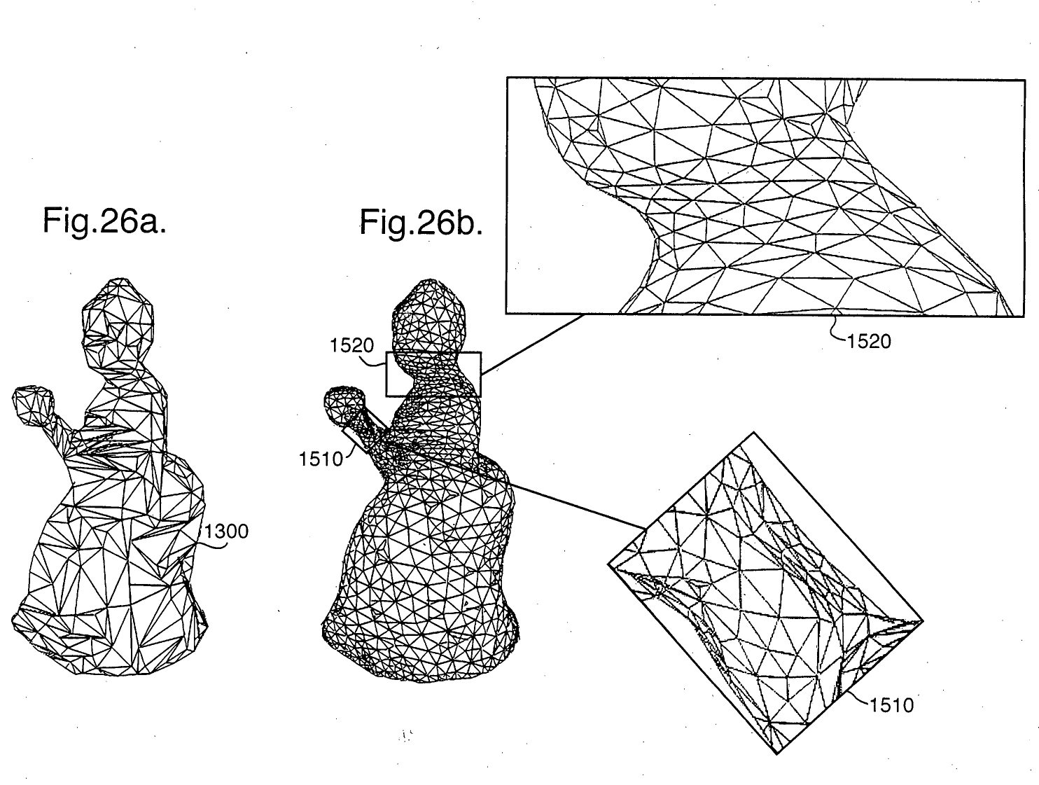

FIGS. 26a and 26b show an example to illustrate the result of the processing performed at step S20-20 in FIG. 20;

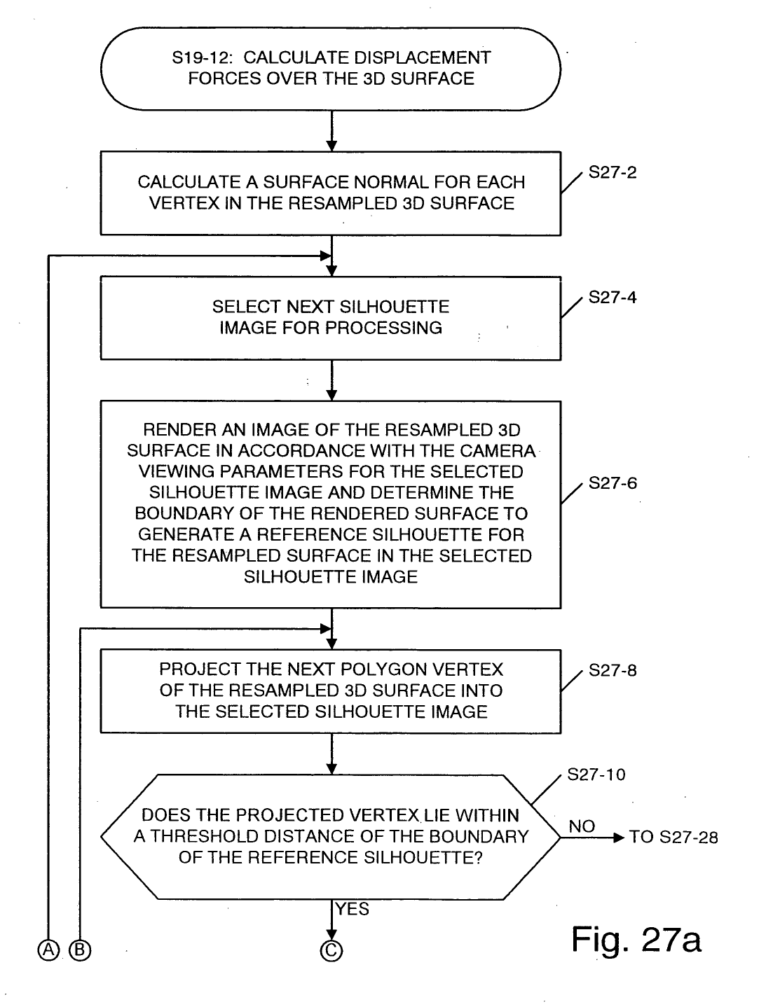

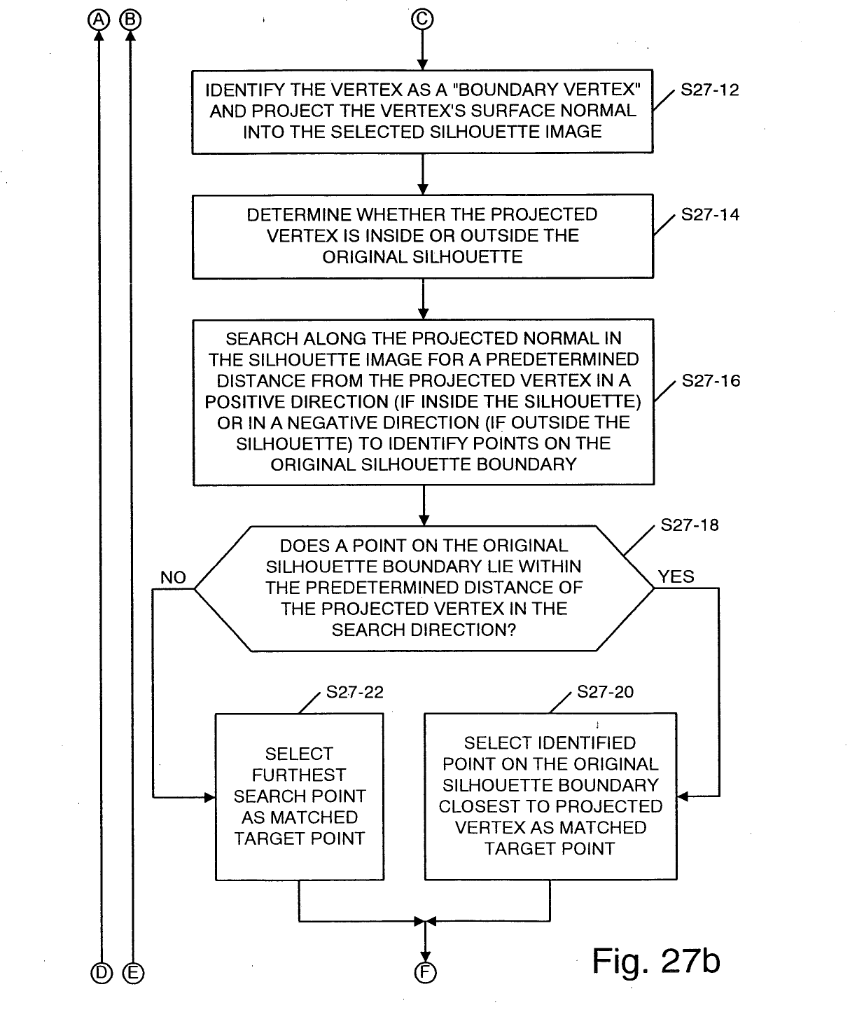

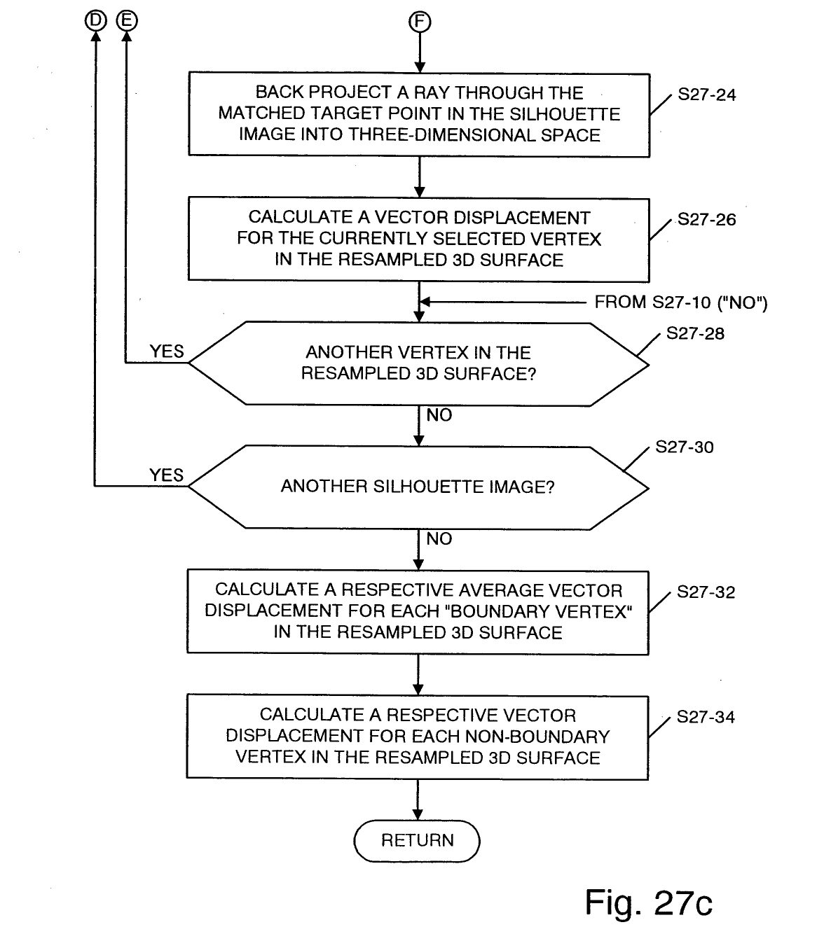

FIG. 27, comprising FIGS. 27a, 27b and 27c, shows the processing operations performed at step S19-12 in FIG. 19;

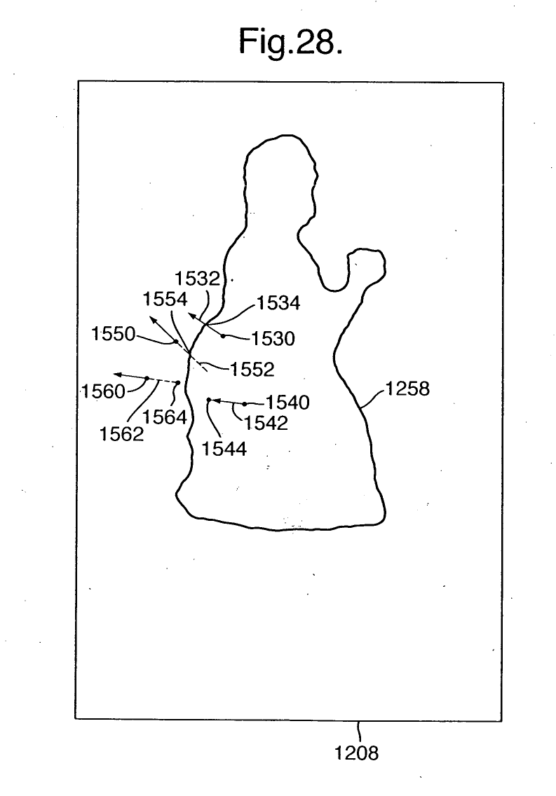

FIG. 28 shows an example to illustrate the processing performed at steps S27-14 to S27-22 in FIG. 27;

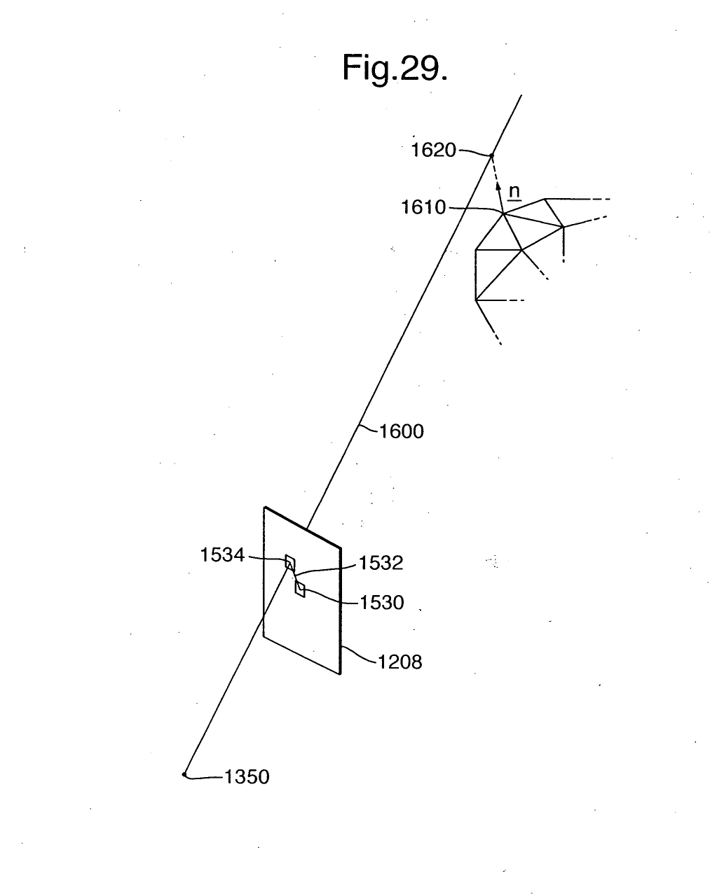

FIG. 29 shows an example to illustrate the processing performed at steps S27-24 and S27-26 in FIG. 27;

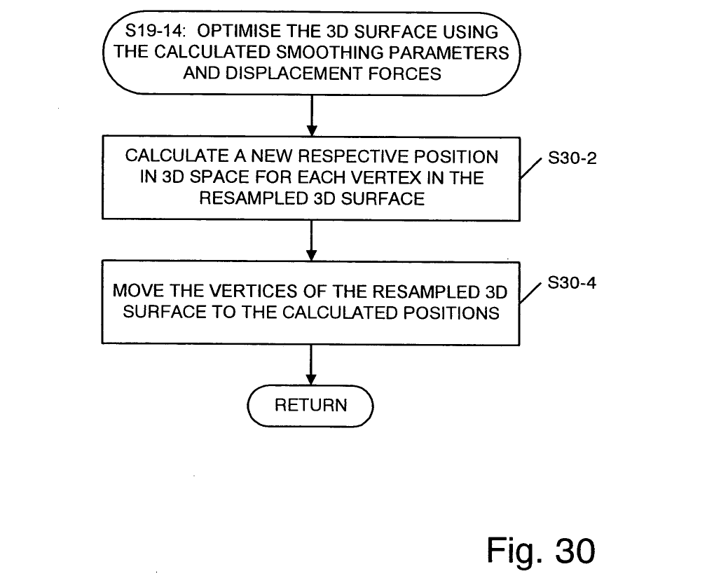

FIG. 30 shows the processing operations performed at step S19-14 in FIG. 19;

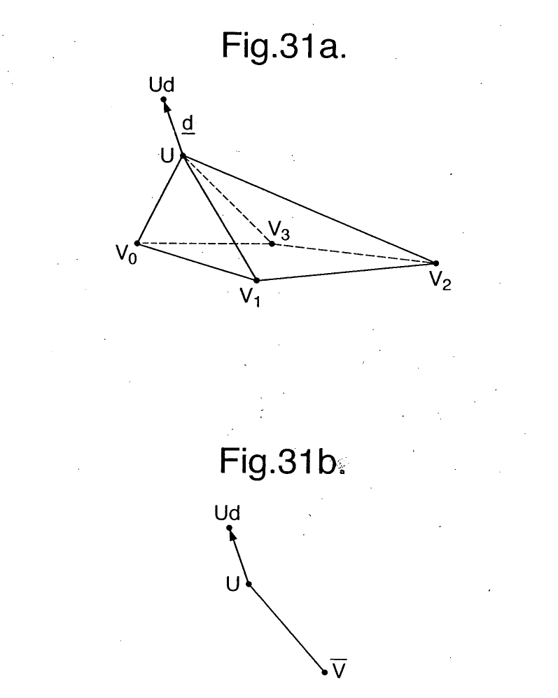

FIGS. 31a and 31b show an example to illustrate the processing performed at step S30-2 in FIG. 30; and

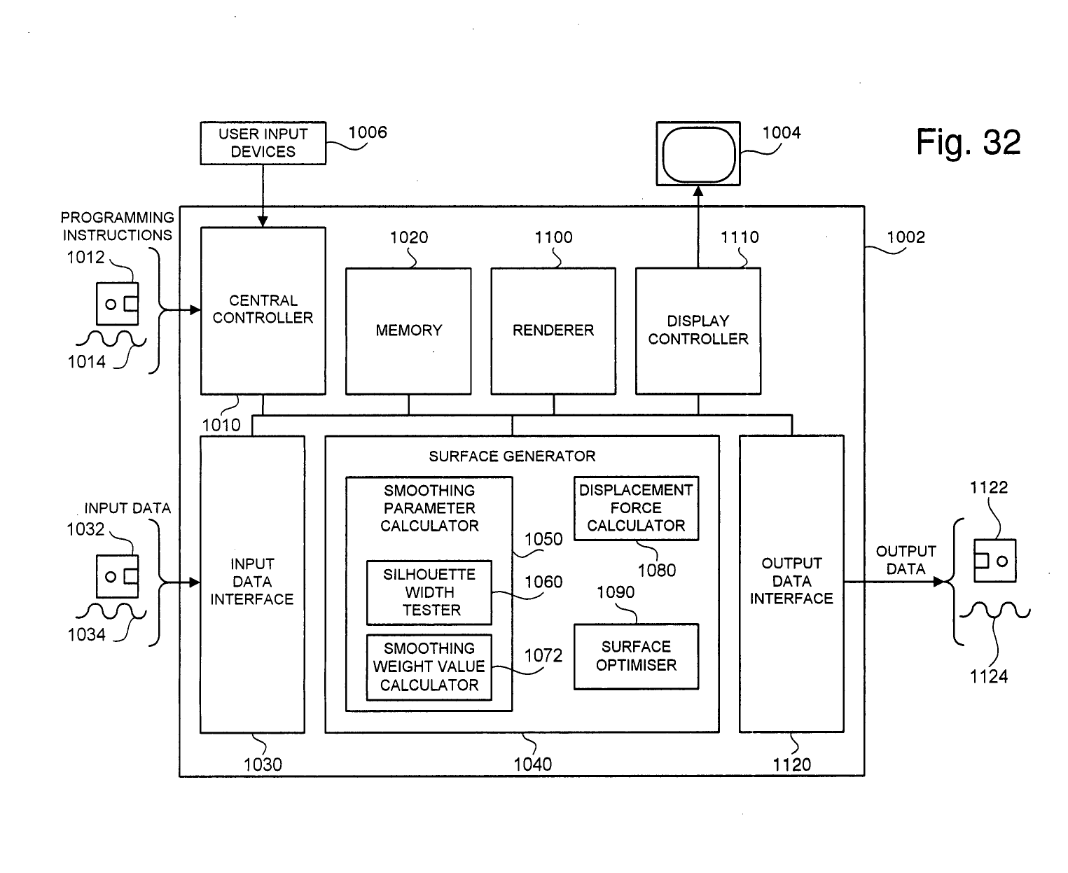

FIG. 32 schematically shows the components of a fifth embodiment of the invention, together with the notional functional processing units into which the processing apparatus component may be thought of as being configured when programmed by programming instructions.

### FIRST EMBODIMENT

Referring to FIG. 1, an embodiment of the invention comprises a programmable processing apparatus 2, such as a personal computer (PC), containing, in a conventional manner, one or more processors, memories, graphics cards etc, together with a display device 4, such as a conventional personal computer monitor, and user input devices 6, such as a keyboard, mouse etc.

The processing apparatus 2 is programmed to operate in accordance with programming instructions input, for example, as data stored on a data storage medium 12 (such as an optical CD ROM, semiconductor ROM, magnetic recording medium, etc), and/or as a signal 14 (for example an electrical or optical signal input to the processing apparatus 2, for example from a remote database, by transmission over a communication network (not shown) such as the Internet or by transmission through the atmosphere), and/or entered by a user via a user input device 6 such as a keyboard.

As will be described in more detail below, the programming instructions comprise instructions to program the processing apparatus 2 to become configured to generate data defining a three-dimensional computer model of a subject object by processing data defining the silhouette of the subject object in a plurality of images recorded at different relative positions and orientations, data defining a preliminary 3D computer model of the surface of the subject object (which may comprise a model of relatively low accuracy, such as a cuboid enclosing only a part of the subject object, or a relatively high accuracy model which has been generated, for example, using one of the techniques described in the introduction above but which requires refinement), and data defining the relative positions and orientations of the silhouettes and the preliminary 3D computer surface model.

The objective of this processing is to generate a final 3D computer surface model of the subject object that is locally smooth and which is also consistent with the starting silhouettes (such that points on the final 3D surface lie within or close to the boundary of each silhouette when projected into each image).

The processing essentially comprises three stages: a first stage in which smoothing parameters are calculated to be used to smooth the preliminary 3D computer surface model; a second stage in which displacements are calculated to move surface points in the preliminary 3D computer surface model to positions closer to the projection of the silhouette boundaries in the 3D space; and a third stage in which the surface points in the preliminary 3D computer surface model are moved in 3D space in accordance with the smoothing parameters and displacements calculated in the first and second stages in such a way that the smoothing parameters and displacements are offset against each other to determine the positions of surface points defining the 3D surface. The calculation of smoothing parameters and displacements and the movement of 3D surface points is performed in such a way that the preliminary 3D computer surface model is smoothed to different extents in different areas of the surface, resulting in a 3D surface in which unwanted artefacts are smoothed out but high curvature features representing features actual present on the subject object are not over-smoothed.

In particular, in the first stage of processing, smoothing parameters are calculated to vary the extent of smoothing over the preliminary 3D computer surface model, such that a relatively high amount of smoothing will be applied to regions of the surface having low curvature or curvature which is not confirmed by the silhouettes, and a relatively low amount of smoothing will be applied to regions which the silhouettes indicate should have a high amount of curvature. In this way, regions of high curvature in the preliminary 3D computer model are maintained if at least one silhouette indicates that the region does indeed have high curvature on the subject object. As a result, parts of the preliminary 3D computer surface model representing features such as sharp corners of the subject object will be maintained. On the other hand, regions of high curvature in the preliminary 3D computer surface model which do not project to a high curvature silhouette boundary will be highly smoothed, with the result that high curvature artefacts will be smoothed away, thereby generating a more accurate 3D computer surface model.

The actual processing operations performed in stage one will be described in detail below, as will those performed in stages two and three.

When programmed by the programming instructions, processing apparatus 2 can be thought of as being configured as a number of functional units for performing processing operations. Examples of such functional units and their interconnections are shown in FIG. 1. The units and interconnections illustrated in FIG. 1 are, however, notional, and are shown for illustration purposes only to assist understanding; they do not necessarily represent units and connections into which the processor, memory etc of the processing apparatus 2 actually become configured.

Referring to the functional units shown in FIG. 1, central controller 10 is operable to process inputs from the user input devices 6, and also to provide control and processing for the other functional units. Memory 20 is provided for use by central controller 10 and the other functional units.

Input data interface 30 is arranged to control the storage of input data within processing apparatus 2. The data may be input to processing apparatus 2 for example as data stored on a storage medium 32, as a signal 34 transmitted to the processing apparatus 2, or using a user input device 6.

In this embodiment, the input data comprises data defining a plurality of binary silhouette images of a subject object recorded at different relative positions and orientations (each silhouette image comprising an image of the subject object with pixels which are part of the subject object set to the value 1 and other pixels set to the value 0 to identify them as background pixels), data defining a preliminary 3D computer model of the surface of the subject object, and data defining the relative 3D positions and orientations of the silhouette images and the preliminary 3D computer surface model. In addition, in this embodiment, the input data also includes data defining the intrinsic parameters of each camera which recorded an image, that is, the aspect ratio, focal length, principal point (the point at which the optical axis intersects the imaging plane), first order radial distortion coefficient, and skew angle (the angle between the axes of the pixel grid; because the axes may not be exactly orthogonal).

Thus, referring to FIG. 2, the input data defines a plurality of silhouette images 200-214 and a 3D computer surface model 300 having positions and orientations defined in 3D space. In this embodiment, the 3D computer surface model 300 comprises a mesh of connected triangles but other forms of 3D computer surface model may be processed, as will be described later. For each silhouette image 200-214, the input data defines which pixels represent the subject object and which pixels are “background” pixels, thereby defining a respective silhouette 250-264 in each silhouette image 200-214. In addition, the input data defines the imaging parameters of the images 200-214, which includes, inter alia, the respective focal point position 310-380 of each silhouette image.

The input data defining the silhouette images 200-214 of the subject object, the data defining the preliminary 3D computer surface model 300, and the data defining the positions and orientations of the silhouette images and preliminary three-dimensional computer surface model may be generated in any of a number of different ways. For example, processing may be performed as described in WO-A-01/39124 or EP-A-1,267,309.

The input data defining the intrinsic camera parameters may be input, for example, by a user using a user input device 6.

Referring again to FIG. 1, surface generator 40 is operable to process the input data received by input data interface 30 to generate data defining a 3D computer model of the surface of the subject object, comprising a smoothed version of the input 3D computer surface model 300 which is consistent with the silhouettes 250-264 in the input silhouette images 200-214.

In this embodiment, surface generator 40 comprises smoothing parameter calculator 50, displacement force calculator 80 and surface optimiser 90.

Smoothing parameter calculator 50 is operable to calculate smoothing parameters defining different respective amounts of smoothing to be applied to a 3D computer surface model.

In this embodiment, smoothing parameter calculator 50 includes silhouette curvature tester 60 operable to calculate a measure of the curvature of the boundary of each silhouette 250-264 in a silhouette image 200-214, and surface resampler 70 operable to amend a 3D computer surface model to generate a resampled 3D computer surface model in which the density of triangle vertices varies over the surface in accordance with measurements of the curvature of the silhouette boundaries. More particularly, surface resampler 70 is operable to generate a resampled 3D computer surface model in which there are a relatively large number of closely spaced vertices in regions determined to have a high curvature through tests on the silhouettes, and there are a relatively small number of widely spaced apart vertices in other regions of the 3D surface.

Displacement force calculator 80 is operable to calculate a respective displacement for each vertex in the 3D computer surface model generated by surface resampler 70 to move (that is, in effect, pull) the vertex to a position in 3D space from which the vertex will project to a position in a silhouette image 200-214 which is closer to the boundary of the silhouette 250-264 therein. Accordingly, displacement force calculator 80 is operable to calculate displacement “forces” which will amend a 3D computer surface model to make it more consistent with the silhouettes 250-264 in the input silhouette images 200-214.

Surface optimiser 90 is operable to amend a 3D computer surface model in such a way that each vertex is moved to a new position in dependence upon the positions of connected vertices in the 3D surface model, which “pull” the vertex to be moved towards them to smooth the 3D surface, and also in dependence upon the displacement for the vertex calculated by displacement force calculator 80 which “pulls” the vertex towards the silhouette data and counter-balances the smoothing effect of the connected vertices.

Renderer 100 is operable to render an image of a 3D computer surface model from any defined viewing position and direction.

Display controller 110, under the control of central controller 10, is arranged to control display device 4 to display image data generated by renderer 100 and also to display instructions to the user.

Output data interface 120 is arranged to control the output of data from processing apparatus 2. In this embodiment, the output data defines the 3D computer surface model generated by surface generator 40. Output data interface 120 is operable to output the data for example as data on a storage medium 122 (such as an optical CD ROM, semiconductor ROM, magnetic recording medium, etc), and/or as a signal 124 (for example an electrical or optical signal transmitted over a communication network such as the Internet or through the atmosphere). A recording of the output data may be made by recording the output signal 124 either directly or indirectly (for example by making a first recording as a “master” and then making a subsequent recording from the master or from a descendent recording thereof) using a recording apparatus (not shown).

FIG. 3 shows the processing operations performed by processing apparatus 2 to process input data in this embodiment.

Referring to FIG. 3, at step S3-2, central controller 10 causes display controller 110 to display a message on display device 4 requesting the user to input data for processing.

At step S3-4, data as described above, input by the user in response to the request at step S3-2, is stored in memory 20.

At step S3-6, surface generator 40 increments the value of an internal counter “m” by 1 (the value of the counter being set to 1 the first time step S3-6 is performed).

At step S3-8, smoothing parameter calculator 50 calculates smoothing parameters for the 3D surface 300 stored at step S3-4 using the silhouettes 250-264 in the silhouette images 200-214 stored at step S3-4.

As outlined earlier, the purpose of the processing at step S3-8 is to define different respective smoothing parameters for different regions of the 3D surface 300, such that the parameters define a relatively high amount of smoothing for regions of the 3D surface having a low curvature and also for regions of the 3D surface having a relatively high curvature but for which no evidence of the high curvature exists in the silhouettes 250-264, and such that the parameters define a relatively low amount of smoothing for regions of the 3D surface which have a high curvature for which evidence exists in the silhouettes 250-264 (that is, regions of high curvature in the 3D surface which project to a part of at least one silhouette boundary having a high curvature). In this way, regions of high curvature in the 3D computer surface model 300 representing actual high curvature parts of the subject object will not be smoothed out in subsequent processing, but regions of high curvature in the 3D computer surface model 300 representing artefacts (that is, features not found on the actual subject object) will be smoothed and removed, and low curvature regions will also be smoothed.

FIG. 4 shows the processing operations performed at step S3-8 in this embodiment.

Before describing these processing operations in detail, an overview of the processing will be given.

In this embodiment, when the triangle vertices in the preliminary 3D computer surface model 300 are moved in subsequent processing to generate a refined 3D surface model, movements to smooth the preliminary 3D surface model are controlled in dependence upon the distances between the vertices. More particularly, in regions of the 3D surface where the connected vertices are spaced relatively far apart, the smoothing is essentially at a relatively large scale, that is the smoothing is relatively high. On the other hand, in regions of the 3D surface where the connected vertices are spaced relatively close together, the smoothing is essentially at a relatively small scale, that is a relatively small amount of smoothing is applied. Consequently, the purpose of the processing at step S3-8 is to define different respective spacings of vertices for different regions of the 3D surface.

This processing comprises testing vertices in the preliminary 3D computer model 300 to identify vertices which lie close to the boundary of at least one silhouette 250-264 when projected into the silhouette images 200-214. For each of these identified “boundary” vertices, the silhouettes 250-264 are used to set the number of vertices in the 3D computer model in the vicinity of the boundary vertex. More particularly, the curvature of the boundary of each silhouette 250-264 in the vicinity of a projected “boundary” vertex is measured and the curvature is used to define a relatively high number of vertices in the preliminary 3D computer surface model 300 in the vicinity of the boundary vertex if at least one silhouette has a relatively high curvature, and to define a relatively low number of vertices in the preliminary 3D computer surface model 300 in the vicinity of the boundary vertex if no silhouette indicates that the 3D surface should have a relatively high curvature in that region.

The processing operations performed by smoothing parameter calculator 50 will now be described in detail.

Referring to FIG. 4, at step S4-2, smoothing parameter calculator 50 selects the next vertex from the preliminary 3D computer surface model 300 stored at step S3-4 (this being the first vertex the first time step S4-2 is performed) and projects the selected vertex into each silhouette image 200-214. Each projection into an image is performed in a conventional way in dependence upon the position and orientation of the image relative to the 3D computer surface model 300 (and hence the vertex being projected) and in dependence upon the intrinsic parameters of the camera which recorded the image.

At step S4-4, smoothing parameter calculator 50 selects the next silhouette image 200-214 into which the selected vertex was projected at step S4-2 (this being the first silhouette image 200-214 the first time step S4-4 is performed).

At step S4-6, smoothing parameter calculator 50 determines whether any point on the boundary of the silhouette 250-264 in the silhouette image 200-214 selected at step S4-4 is within a threshold distance of the position of the projected vertex (this position being defined by the projection performed at step S4-2). In this embodiment, the threshold distance is set to a predetermined number of pixels based upon the number of pixels in the silhouette images 200-214. For example, a threshold distance of fifteen pixels is used for an image size of 512×512 pixels.

If it is determined at step S4-6 that the projected vertex does not lie within a predetermined distance of a point on the silhouette boundary, then processing proceeds to step S4-16 to determine whether any silhouette images remain to be processed for the currently selected vertex. If at least one silhouette image remains, then the processing returns to step S4-4 to select the next silhouette image.

On the other hand, if it is determined at step S4-6 that the projected vertex does lie within the threshold distance of the silhouette boundary, then processing proceeds to step S4-8 at which smoothing parameter calculator 50 selects the closest point on the silhouette boundary for further processing.

At step S4-10, silhouette curvature tester 60 calculates an estimated measure of the curvature of the boundary of the silhouette at the point selected at step S4-8.

FIG. 5 shows the processing operations performed by silhouette curvature tester 60 at step S4-10.

Referring to FIG. 5, at step S5-2, silhouette curvature tester 60 calculates the positions of points on the silhouette boundary which lie a predetermined number of pixels on each respective side of the point selected at step S4-8.

FIG. 6 shows an example to illustrate the processing at step S5-2.

Referring to FIG. 6, part of the boundary of silhouette 256 in silhouette image 206 is illustrated, and point 400 on the boundary of the silhouette 256 is the point selected at step S4-8. In the processing at step S5-2, silhouette curvature tester 60 identifies a point 410 lying on the silhouette boundary to a first side of point 400 and a point 420 lying on the silhouette boundary on the other side of point 400. Each point 410 and 420 has a position such that the point lies a predetermined number of pixels (ten pixels in this embodiment) from the pixel containing point 400. More particularly, following the boundary of the silhouette 256 from the point 400 to point 410, the silhouette boundary passes through ten pixel boundaries. Similarly, following the silhouette boundary from point 400 to point 420, the silhouette boundary also passes through ten pixel boundaries.

Referring again to FIG. 5, at step S5-4, silhouette curvature tester 60 calculates a measure of the silhouette boundary at point 400 using the positions of the points 410 and 420 calculated at step S5-2. More particularly, in this embodiment, silhouette curvature tester 60 calculates a curvature measure, C, in accordance with the following equation:

$$C = \frac{1}{2} [ 1 - \frac{( P - {P}^{-} ) \cdot ( {P}^{+} - P )}{\vert P - {P}^{-} \vert \vert {P}^{+} - P \vert} ] \qquad ( 1 )$$

where:
P is the (x, y) position of point 400 within the silhouette image;
P⁺ is the (x, y) position of point 420 within the silhouette image;
P⁻ is the (x, y) position of point 410 within the silhouette image;
“•” indicates a dot product operation.

By calculating the curvature in this way, a scaled curvature measure, C, is obtained having a value lying between 0 (where the silhouette boundary is flat) and 1 (where the curvature of the silhouette boundary is infinite).

Referring again to FIG. 4, at step S4-12, smoothing parameter calculator 50 determines whether the curvature calculated at step S4-10 is greater than the existing curvature already stored for the vertex selected at step S4-2. The first time step S4-12 is performed for a particular vertex, no curvature will already be stored. However, on the second and each subsequent iteration for a particular vertex, a curvature will be stored, and smoothing parameter calculator 50 compares the stored curvature with the curvature calculated at step S4-10 to determine which is the greater.

If it is determined at step S4-12 that the curvature calculated at step S4-10 is greater than the stored curvature, then, at step S4-14, smoothing parameter calculator 50 stores the curvature calculated at step S4-10 and discards the existing stored curvature (if any). On the other hand, if it is determined at step S4-12 that the curvature calculated at step S4-10 is not greater than the stored curvature, then step S4-14 is omitted, so that the previously stored curvature remains.

At step S4-16, smoothing parameter calculator 50 determines whether any silhouette images remain to be processed for the vertex selected at step S4-2. Steps S4-4 to S4-16 are repeated until each silhouette image has been processed for the vertex selected at step S4-2 in the way described above.

At step S4-18, smoothing parameter calculator 50 determines whether any polygon vertices in the 3D computer surface model remain to be processed. Steps S4-2 to S4-18 are repeated until each polygon vertex in the 3D computer surface model has been processed in the way described above.

At step S4-20, surface resampler 70 generates a resampled 3D computer surface model in accordance with the maximum silhouette curvature stored at step S4-14 for each vertex in the starting 3D computer surface model 300.

FIG. 7 shows the processing operations performed by surface resampler 70 at step S4-20.

Referring to FIG. 7, at step S7-2, surface resampler 70 adds a new triangle vertex at the midpoint of each triangle edge in the 3D computer surface model 300. Thus, referring to the example shown in FIG. 8a by way of example, new vertices 430-438 are added at the midpoints of edges 440-448 defined by vertices 450-456 already existing in the 3D computer surface model 300.

Referring again to FIG. 7, at step S7-4, surface resampler 70 calculates a respective silhouette boundary curvature measure for each new vertex added at step S7-2. More particularly, in this embodiment, surface resampler 70 calculates a curvature measure for a new vertex by calculating the average of the silhouette boundary curvature measures previously stored at step S4-14 for the vertices in the 3D computer surface model 300 defining the ends of the edge on which the new vertex lies.

At step S7-6, surface resampler 70 retriangulates the 3D computer surface model by connecting the new vertices added at step S7-2. More particularly, referring to FIG. 8b, surface resampler 70 connects the new vertices 430-438 to divide each triangle in the preliminary 3D computer surface model 300 into four triangles lying within the plane of the original triangle. Thus, by way of example, the triangle defined by original vertices 450, 452, 456 is divided into four triangles 460-466, and the triangle defined by original vertices 452, 454, 456 is divided into four triangles 468-474.

Referring again to FIG. 7, at step S7-8, surface resampler 70 calculates a respective collapse cost score for each edge in the retriangulated polygon mesh generated at step S7-6, defining a measure of the effect that the edge's removal will have on the overall retriangulated polygon mesh—the higher the score, the greater the effect the removal of the edge will have on the retriangulated polygon mesh. In this embodiment, this collapse cost score is calculated in accordance with the following equation:
Cost=|u−v|{max(Cᵤ, Cᵥ)+K} (2)
where:
u is the 3D position of vertex u at the end of the edge;
v is the 3D position of vertex v at the end of the edge;
Cu is the curvature calculated for the vertex u at steps S4-10 to S4-14 or S7-4;
Cv is the curvature calculated for the vertex v at steps S4-10 to S4-14 or S7-4;
max(Cu, Cv) is Cu or Cv, whichever is greater;
K is a constant which, in this embodiment, is set to 0.1.

At step S7-10, surface resampler 70 selects the next “best” edge UV in the polygon mesh as a candidate edge to collapse (this being the first “best” edge the first time step S7-10 is performed). More particularly, surface resampler 70 selects the edge having the lowest calculated collapse cost score as a candidate edge to collapse (since the removal of this edge should have the least effect on the polygon mesh).

At step S7-12, surface resampler 70 determines whether the collapse cost score associated with the candidate edge selected at step S7-10 is greater than a predetermined threshold value (which, in this embodiment, is set to 5% of the maximum dimension of the 3D computer surface model 300). The first time step S7-12 is performed, the collapse cost score associated with the candidate edge will be less than the predetermined threshold value. However, as will be explained below, when an edge is collapsed, the collapse cost scores of the remaining edges are updated. Accordingly, when it is determined at step S7-12 on a subsequent iteration that the collapse cost score associated with the candidate edge is greater than the predetermined threshold, the processing has reached a stage where no further edges should be removed. This is because the edge selected at step S7-10 as the candidate edge is the edge with the lowest collapse cost score, and accordingly if the collapse cost score is determined to be greater than the predetermined threshold at step S7-12, then the collapse cost score associated with all remaining edges will be greater than the predetermined threshold. In this case, the resampling of the 3D computer surface model is complete, and processing returns to step S3-10 in FIG. 3.

On the other hand, when it is determined at step S7-12 that the collapse cost score associated with the candidate edge is not greater than the predetermined threshold, processing proceeds to step S7-14, at which surface resampler 70 collapses the candidate edge selected at step S7-10 within the polygon mesh. In this embodiment, the edge collapse is carried out in a conventional way, for example as described in the article “A Simple Fast and Effective Polygon Reduction Algorithm” published at pages 44-49 of the November 1998 issue of Game Developer Magazine (publisher CMP Media, Inc) or as described in “Progressive Meshes” by Hoppe, Proceedings SIGGRAPH 96, pages 99-108. The edge collapse results in the removal of two triangular polygons, one edge and one vertex from the polygon mesh.

FIGS. 9a and 9b show an example to illustrate the processing performed at step S7-14.

Referring to FIG. 9a, part of the 3D computer surface model is shown comprising triangles A-H, with two vertices U and V defining an edge 500 of triangles A and B.

In the processing at step S7-14, surface resampler 70 moves the position of vertex U so that it is at the same position as vertex V.

Referring to FIG. 9b, as a result of this processing, vertex U, edge 500 and triangles A and B are removed from the 3D computer surface model. In addition, the shapes of triangles C, D, G and H which share vertex U are changed. On the other hand, the shapes of triangles E and F which do not contain either vertex U or vertex V, are unchanged.

Referring again to FIG. 7, at step S7-16, surface resampler 70 performs processing to update the collapse cost scores for the edges remaining in the polygon mesh in accordance with the equation used at step S7-8.

Steps S7-10 to S7-16 are repeated to select edges in the polygon mesh and test them to determine whether they can be removed, until it is determined at step S7-12 that every edge remaining in the polygon mesh has a collapse cost score greater than the predetermined threshold. When this situation is reached, the resampling processing ends, and processing returns to step S3-10 in FIG. 3.

FIGS. 10a and 10b show an example to illustrate the result of the processing performed by smoothing parameter calculator 50 at step S3-8. FIG. 10a shows a view of a preliminary 3D computer surface model 300 stored at step S3-4 showing the distribution and size of triangles within the polygon mesh making up the 3D surface. FIG. 10b shows the same view of the polygon mesh making up the 3D surface after the processing at step S3-8 has been performed.

FIG. 10b illustrates how the processing at step S3-8 generates a 3D computer surface model in which the triangle vertices are distributed such that there are a relatively low number of widely spaced apart vertices in regions which are to undergo relatively high smoothing, such as region 510, and there are a relatively large number of closely spaced together vertices in regions which are to undergo relatively little smoothing, such as region 520.

As will be explained below, when the triangle vertices are moved in subsequent processing to generate a refined 3D surface model, the movements are controlled in dependence upon the distance between the vertices. Accordingly, the relative distribution of vertices generated by the processing at step S3-8 controls the subsequent refinement of the 3D surface, and in particular determines the relative amounts of smoothing to be applied to different regions of the 3D surface.

Referring again to FIG. 3, at step S3-10 surface generator 40 increments the value of an internal counter “n” by 1 (the value of the counter being set to 1 the first time step S3-10 is performed).

At step S3-12, displacement force calculator 80 calculates a respective displacement force for each vertex in the 3D computer surface model generated at step S3-8.

FIG. 11 shows the processing operations performed by displacement force calculator 80 at step S3-12.

Before describing these processing operations in detail, an overview of the processing will be given.

The objective of the processing at step S3-12 is to calculate displacements for the vertices in the 3D computer surface model that would move the vertices towards the surfaces defined by the back-projection of the silhouettes 250-264 into 3D space. In other words, the displacements “pull” the vertices of the 3D surface towards the silhouette data.

However, the 3D computer surface model can only be compared against the silhouettes 250-264 for points in the 3D surface which project close to the boundary of a silhouette 250-264 in at least one input image 200-214.

Accordingly, the processing at step S3-12 identifies vertices within the 3D computer surface model which project to a point in at least one input image 200-214 lying close to the boundary of a silhouette 250-264 therein, and calculates a respective displacement for each identified point which would move the point to a position in 3D space from which it would project to a point closer to the identified silhouette boundary. For each remaining vertex in the 3D computer surface model, a respective displacement is calculated using the displacements calculated for points which project from 3D space close to a silhouette boundary.

The processing operations performed at step S3-12 will now be described in detail.

Referring to FIG. 11, at step S11-2, displacement force calculator 80 calculates a respective surface normal vector for each vertex in the resampled 3D surface generated at step S3-8. More particularly, in this embodiment, a surface normal vector for each vertex is calculated by calculating the average of the normal vectors of the triangles which meet at the vertex, in a conventional way.

At step S11-4, displacement force calculator 80 selects the next silhouette image 200-214 for processing (this being the first silhouette image the first time step S11-4 is performed).

At step S11-6, renderer 100 renders an image of the resampled 3D surface generated at step S3-8 in accordance with the camera viewing parameters for the selected silhouette image (that is, in accordance with the position and orientation of the silhouette image relative to the resampled 3D surface and in accordance with the intrinsic camera parameters stored at step S3-4). In addition, displacement force calculator 80 determines the boundary of the projected surface in the rendered image to generate a reference silhouette for the resampled 3D surface in the silhouette image selected at step S11-4.

At step S11-8, displacement force calculator 80 projects the next vertex from the resampled 3D surface into the selected silhouette image (this being the first vertex the first time step S11-8 is performed).

At step S11-10, displacement force calculator 80 determines whether the projected vertex lies within a threshold distance of the boundary of the reference silhouette generated at step S11-6. In this embodiment, the threshold distance used at step S11-10 is set in dependence upon the number of pixels in the image generated at step S11-6. For example, for an image of 512 by 512 pixels, a threshold distance of ten pixels is used.

If it is determined at step S11-10 that the projected vertex does not lie within the threshold distance of the boundary of the reference silhouette, then processing proceeds to step S11-28 to determine whether any polygon vertex in the resampled 3D surface remains to be processed. If at least one polygon vertex has not been processed, then processing returns to step S11-8 to project the next vertex from the resampled 3D surface into the selected silhouette image.

On the other hand, if it is determined at step S11-10 that the projected vertex does lie within the threshold distance of the boundary of the reference silhouette, then processing proceeds to step S11-12, at which surface optimiser 90 labels the vertex selected at step S11-8 as a “boundary vertex” and projects the vertex's surface normal calculated at step S11-2 from 3D space into the silhouette image selected at step S11-4 to generate a two-dimensional projected normal.

At step S11-14, displacement force calculator 80 determines whether the vertex projected at step S11-8 is inside or outside the original silhouette 250-264 existing in the silhouette image (that is, the silhouette defined by the input data stored at step S3-4 and not the reference silhouette generated at step S11-6).

At step S11-16, displacement force calculator 80 searches along the projected normal in the silhouette image from the vertex projected at step S11-12 towards the boundary of the original silhouette 250-264 (that is, the silhouette defined by the input data stored at step S3-4) to detect points on the silhouette boundary lying within a predetermined distance of the projected vertex along the projected normal.

More particularly, to ensure that the search is carried out in a direction towards the silhouette boundary, displacement force calculator 80 searches along the projected normal in a positive direction if it was determined at step S11-14 that the projected vertex lies inside the silhouette, and searches along the projected normal in a negative direction if it was determined at step S11-14 that the projected vertex is outside the silhouette. Thus, referring to the examples shown in FIG. 12, projected vertices 530 and 540 lie within the boundary of silhouette 258, and accordingly a search is carried out in the positive direction along the projected normals 532 and 542 (that is, the direction indicated by the arrowhead on the normals shown in FIG. 12). On the hand, projected vertices 550 and 560 lie outside the silhouette 258, and accordingly displacement force calculator 80 carries out the search at step S11-16 in a negative direction along the projected normal for each vertex—that is, along the dotted lines labelled 552 and 562 in FIG. 12.

Referring again to FIG. 11, at step 11-18, displacement force calculator 80 determines whether a point on the silhouette boundary was detected at step S11-16 within a predetermined distance of the projected vertex. In this embodiment, the predetermined distance is set to 10 pixels for a silhouette image size of 512 by 512 pixels.

If it is determined at step S11-18 that a point on the silhouette boundary does lie within the predetermined distance of the projected vertex in the search direction, then processing proceeds to step S11-20 at which the identified point on the silhouette boundary closest to the projected vertex is selected as a matched target point for the vertex. Thus, referring to the examples shown in FIG. 12, for the case of projected vertex 530, the point 534 on the silhouette boundary would be selected at step S11-20. Similarly, in the case of projected vertex 550, the point 554 on the silhouette boundary would be selected at step S11-20.

On the hand, if it is determined at step S11-18 that a point on the silhouette boundary does not lie within the predetermined distance of the projected vertex in the search direction, then processing proceeds to step S11-22 at which the point lying the predetermined distance from the projected vertex in the search direction is selected as a matched target point for the vertex. Thus, referring again to the examples shown in FIG. 12, in the case of projected vertex 540, point 544 would be selected at step S11-22 because this point lies at the predetermined distance from the projected vertex in the positive direction of the projected normal vector. Similarly, in the case of projected vertex 560, the point 564 would be selected at step S11-22 because this point lies the predetermined distance away from the projected vertex 560 in the negative direction 562 of the projected normal vector.

Following the processing at step S11-20 or step S11-22, the processing proceeds to step S11-24, at which displacement force calculator 80 back projects a ray through the matched target point in the silhouette image into 3-dimensional space. This processing is illustrated by the example shown in FIG. 13.

Referring to FIG. 13, a ray 600 is projected from the focal point position 350 (defined in the input data stored at step S3-4) for the camera which recorded the selected silhouette image 208 through the matched target point selected at step S11-20 or S11-22 (this target point being point 534 from the example shown in FIG. 12 for the purpose of the example in FIG. 13).

At step S11-26, displacement force calculator 80 calculates a 3D vector displacement for the currently selected vertex in the resampled 3D surface.

More particularly, referring again to the example shown in FIG. 13, displacement force calculator 80 calculates a vector displacement for the selected vertex 610 in the resampled 3D surface which comprises the displacement of the vertex 610 in the direction of the surface normal vector n (calculated at step S11-2 for the vertex) to the point 620 which lies upon the ray 600 projected at step S11-24. The surface normal vector n will intersect the ray 600 (so that the point 620 lies on the ray 600) because the target matched point 534 lies along the projected normal vector 532 from the projected vertex 530 in the silhouette image 208.

As a result of this processing, a displacement has been calculated to move the selected vertex (vertex 610 in the example of FIG. 13) to a new (point 620 in the example of FIG. 13) from which the vertex projects to a position in the selected silhouette image (silhouette image 208 in the example of FIG. 13) which is closer to the boundary of the silhouette therein than if the vertex was projected from its original position in the resampled 3D surface.

At step S11-28, displacement force calculator 80 determines whether there is another vertex to be processed in the resampled 3D surface, and steps S11-8 to S11-28 are repeated until each vertex in the resampled 3D surface has been processed in the way described above.

At step S11-30, displacement force calculator 80 determines whether any silhouette image remains to be processed, and steps S11-4 to S11-30 are repeated until each silhouette image has been processed in the way described above.

As a result of this processing, at least one displacement vector has been calculated for each “boundary” vertex in the resampled 3D computer surface model (that is, each vertex which projects to within the threshold distance of the boundary of the reference silhouette—determined at step S11-10). If a given vertex in the resampled 3D surface projects to within the threshold distance of the boundary of the reference silhouette in more than one reference image, then a plurality of respective displacements will have been calculated for that vertex.

At step S11-32, displacement force calculator 80 calculates a respective average 3D vector displacement for each boundary vertex in the resampled 3D surface. More particularly, if a plurality of vector displacements have been calculated for a boundary vertex (that is, one respective displacement for each silhouette image for which the vertex is a boundary vertex), displacement force calculator 80 calculates the average of the vector displacements. For a boundary vertex for which only one vector displacement has been calculated, then processing at step S11-32 is omitted so that the single calculated vector displacement is maintained.

At step S11-34, displacement force calculator 80 calculates a respective vector displacement for each non-boundary vertex in the resampled 3D surface. More particularly, for each vertex for which no vector displacement was calculated in the processing at S11-4 to S11-30, displacement force calculator 80 uses the average of the vector displacements calculated for neighbouring vertices, and this processing is applied iteratively so that the calculated displacement vectors propagate across the resampled 3D surface until each vertex in the resampled 3D surface has a vector displacement associated with it.

Referring again to FIG. 3, at step S3-14, surface optimiser 90 performs processing to optimise the 3D surface using the smoothing parameters calculated at step S3-8 and the displacement forces calculated at step S3-14.

More particularly, the processing at step 3-8 generated a resampled 3D surface in which the vertices are relatively closely spaced together in regions determined from the input silhouettes 250-264 to have a relatively high curvature, and in which the vertices are relatively widely spaced apart in other regions. The processing at step S3-12 calculated a respective displacement for each vertex in the resampled 3D surface to move the vertex to a position from which it would project to a position in each input silhouette image 200-214 closer to the boundary of the silhouette therein than if it was projected from its position in the original input 3D computer surface model 300 stored at step S3-4.

The processing performed at step S3-14 comprises moving each vertex in the resampled 3D surface generated at step S3-8 in dependence upon the positions of the neighbouring vertices (which will tend to pull the vertex towards them to smooth the 3D surface) and in dependence upon the displacement force calculated for the vertex at step S3-12 (which will tend to pull the vertex towards a position which is more consistent with the silhouettes 250-264 in the input silhouette images 200-214).

FIG. 14 shows the processing operations performed by surface optimiser 90 at step S3-14.

Referring to FIG. 14, at step S14-2, surface optimiser 90 calculates a new respective position in a 3D space for each vertex in the resampled 3D surface.

In this embodiment, a new position is calculated at step S14-2 for each vertex in accordance with the following equation:
u′=u+ε{d+λ(\overline{v}−u)} (3)
where
u′ is the new 3D position of the vertex
u is the current 3D position of the vertex
ε is a constant (set to 0.1 in this embodiment)
d is the displacement vector calculated for the vertex at step S3-12
λ is a constant (set to 1.0 in this embodiment)
\overline{v} is the average position of the vertices connected to the vertex in the resampled 3D surface, and is given by:

$$\overline{𝓋} = \frac{1}{n} {\sum }_{i}^{n} {𝓋}_{i} \qquad ( 4 )$$
where vᵢ is the 3D position of a connected vertex.

It will be seen from equation (3) that the new 3D position u′ of each vertex is dependent upon the displacement vector calculated at step S3-12 as well as the positions of the vertices connected to the vertex in the resampled 3D mesh generated at step S3-8.

Referring again to FIG. 14, at step S14-4, surface optimiser 90 moves the vertices of the resampled 3D surface to the new positions calculated at step S14-2.

The processing performed at steps S14-2 and S14-4 is illustrated in the example shown in FIGS. 15a and 15b. In the example shown, vertex U is connected to vertices v0, v1, v2 and v3. Consequently, the average position \overline{v} of the vertices v0, v1, v2 and v3 is calculated. The displacement force d for the vertex U and the average position \overline{v} are then used to calculate the new position for vertex U in accordance with equation (3).

Consequently, if the connected vertices v0-v3 are spaced relatively far away from the vertex U, then the average position \overline{v} will be relatively far away from the current position of vertex u. As a result, the connected vertices v0-v3 influence (that is, pull) the position of the vertex U more than the vector displacement d influences (that is, pulls) the position of the vertex U. Consequently, the 3D surface at vertex U undergoes a relatively high amount of smoothing because vertex U is pulled towards the connected vertices v0-v3. In this way, artifacts in the 3D computer surface model stored at step S3-4 are removed and low curvature regions are smoothed.

On the other hand, if the vertices v0-v3 connected to the vertex U are spaced relatively close together and close to vertex U, then the average position \overline{v} will also be relatively close to the current position of vertex U, with the result that the vertices v0-v3 influence (that is, pull) the position of the vertex U less than the displacement d. As a result, the 3D surface in the region of vertex U undergoes relatively little smoothing, and sharp features are preserved because over-smoothing is prevented.

Referring again to FIG. 3, at step S3-16, surface generator 40 determines whether the value of the counter n has reached ten, and steps S3-10 to S3-16 are repeated until the counter n indicates that these steps have been performed ten times. Consequently, for a respective resampled 3D surface generated at step S3-8, the processing at step S3-12 to calculate displacement forces and the processing at step S3-14 to optimise the resampled surface are iteratively performed.

At step S3-18, surface generator 40 determines whether the value of the counter m has yet reached 100. Steps S3-6 to S3-18 are repeated until the counter m indicates that the steps have been performed one hundred times. As a result, the processing to generate a resampled 3D surface at step S3-8 and subsequent processing is iteratively performed. When it is determined at step S3-18 that the value of the counter m is equal to one hundred, then the generation of the 3D computer surface model is complete.

At step S3-20, output data interface 120 outputs data defining the generated 3D computer surface model. The data is output from processing apparatus 2 for example as data stored on a storage medium 122 or as signal 124 (as described above with reference to FIG. 1). In addition, or instead, renderer 100 may generate image data defining images of the generated 3D computer surface model in accordance with a virtual camera controlled by the user. The images may then be displayed on display device 4.

As will be understood by the skilled person from the description of the processing given above, the preliminary 3D computer surface model stored at step S3-4 need only be very approximate. Indeed, the preliminary 3D computer surface model may define a volume which encloses only a part (and not all) of the subject object 300 because the displacement forces calculated at step S3-12 allow the 3D surface to be “pulled” in any direction to match the silhouettes 250-264 in the silhouette images 200-214. Accordingly, a preliminary volume enclosing only a part of the subject object will be modified so that it expands to enclose all of the subject object while at the same time it is smoothed, so that the final model accurately represents the surface of the subject object while remaining consistent with the silhouettes 250-264 in the input silhouette images 200-214.

Second Embodiment

A second embodiment of the present invention will now be described.

Referring to FIG. 16 the functional components of the second embodiment and the processing operations performed thereby are the same as those in the first embodiment, with the exception that surface resampler 70 in the first embodiment is replaced by smoothing weight value calculator 72 in the second embodiment, and the processing operations performed at step 4-20 are different in the second embodiment to those in the first embodiment.

Because the other functional components and the processing operations performed thereby are the same as those in the first embodiment, they will not be described again here. Instead, only the differences between the first embodiment and the second embodiment will be described.

In the second embodiment, instead of generating a resampled 3D surface at step S4-20, smoothing weight value calculator 72 performs processing to calculate a respective weighting value λ for each vertex in the 3D computer surface model 300. More particularly, for each vertex in the 3D surface for which a curvature measure was calculated at step S4-10, smoothing weight value calculator 72 calculates a weighting value λ in accordance with the following equation:
λ=1−C (5)
where C is the scaled curvature calculated in accordance with equation (1) for the vertex at step S4-10.

As noted previously in the description of the first embodiment, the value of the scaled curvature C lies between 0 (in a case where the silhouette boundary is flat) and 1 (in a case where the silhouette boundary has maximum measured curvature). Accordingly, the weighting value λ calculated in accordance with equation (5) will also have a value between 0 and 1, with the value being relatively low in a case where the silhouette boundary has relatively high curvature and the value being relatively high in a case where the silhouette boundary has relatively low curvature.

For each vertex in the 3D surface for which a curvature measure C was not calculated at step S4-10, smoothing weight value calculator 72 sets the value of λ for the vertex to a constant value, which, in this embodiment, is 0.1.

It will be appreciated, however, that the value of λ may be set in different ways for each vertex for which a curvature measure C was not calculated at step S4-10. For example, a respective value of λ may be calculated for each such vertex by extrapolation of the λ values calculated in accordance with equation (5) for each vertex for which a curvature measure C was calculated at step S4-10.

In the second embodiment, each value of λ calculated at step S4-20 is subsequently used by surface optimiser 90 at step S14-2 to calculate a new respective position in 3D space for each vertex of the 3D computer surface model 300. More particularly, to calculate the new position of each vertex, the value of λ calculated at step S4-20 for the vertex is used in equation (3) above in place of the constant value of λ used in the first embodiment.

As a result of this processing, when the value of λ is relatively high (that is, in regions of relatively low curvature), the new 3D position u′ of a vertex calculated in accordance with equation (3) will be pulled towards the average position \overline{v} of the connected vertices to cause relatively high smoothing in this region. On the other hand, when the value of λ is relatively low (that is, in a region corresponding to relatively high silhouette boundary curvature), then the new 3D position u′ of a vertex calculated in accordance with equation (3) will be influenced to a greater extent by the value of the displacement vector d than by the average position \overline{v} of the connected vertices. As a result, this region of the 3D surface will undergo relatively little smoothing.

In summary, the processing at step S3-8 in the first embodiment to calculate smoothing parameters results in a resampled 3D surface—that is, a 3d surface having vertices in different positions compared to the positions of the vertices in the starting 3D computer surface model 300. On the other hand, in the second embodiment, the original positions of the vertices in the 3D computer surface model 300 are maintained in the processing at step S3-8, and the calculation of smoothing parameters results in a respective weighting value λ for each vertex.

It will be understood that, because the number and positions of the vertices in the starting 3D surface do not change in the second embodiment, then the processing to calculate displacement forces over the 3D surface at step S3-12 may be performed before the processing to calculated smoothing parameters for the 3D surface using the silhouette images at step S3-8.

Third Embodiment

A third embodiment of the present invention will now be described.

In the first and second embodiments, displacement force calculator 80 performs processing at step S3-12 to calculate displacement forces over the 3D surface, and surface optimiser 90 performs processing at step S3-14 to optimise the 3D surface using the smoothing parameters calculated by smoothing parameter calculator 50 at step S3-8 and also the displacement forces calculated by displacement force calculator 80 at step S3-12. In the third embodiment, however, displacement force calculator 80 and the processing at step S3-12 are omitted.

More particularly, the functional components of the third embodiment and the processing operations performed thereby are the same as those in the second embodiment, with the exception that displacement force calculator 80 and the processing operations performed thereby at step S3-12 are omitted, and the processing operations performed by surface optimiser 90 at step S3-14 are different.

Because the other functional components and the processing operations performed thereby are the same as those in the second embodiment, they will not be described again here. Instead, only the differences in the processing performed by surface optimiser 90 at step S3-14 will be described.

In the third embodiment, surface optimiser 90 performs processing at step S3-14 in accordance with the processing operations set out in FIG. 14, but calculates a new position at step S14-2 for each vertex in the 3D computer surface model in accordance with the following equation, which is a modified version of equation (3) used in the second embodiment:
u′=u+ε{uₒ−u+λ(\overline{v}−u)} (6)
where
u′ is the new 3D position of the vertex
u is the current 3D position of the vertex
uₒ is the original 3D position of the vertex (that is, the position of the vertex in the 3D computer surface model 300 stored at step S3-4)
ε is a constant (set to 0.1 in this embodiment)
λ is the weighting value calculated in accordance with equation (5)
\overline{v} is the average position of the vertices connected to the vertex, calculated in accordance with equation (4).

As a result of this processing, instead of calculating a displacement force as in the first and second embodiments (performed by displacement force calculator 80 at step S3-12), to pull each vertex towards a position which is more consistent with the silhouettes 250-264 in the input silhouette images 200-214, each vertex is pulled towards its original position in the input 3D computer surface model 300 stored at step S3-4. This counteracts the smoothing by the smoothing parameters calculated at step S3-8 and prevents over-smoothing of the 3D computer surface model 300.

In order to produce accurate results with the third embodiment, however, the 3D computer surface model 300 stored at step S3-4 needs to be relatively accurate, such as a visual hull 3D computer surface model, rather than a relatively inaccurate model such as a cuboid containing some or all of the subject object.

Fourth Embodiment

Referring to FIG. 17, a fourth embodiment of the invention comprises a programmable processing apparatus 1002, such as a personal computer (PC), containing, in a conventional manner, one or more processors, memories, graphics cards etc, together with a display device 1004, such as a conventional personal computer monitor, and user input devices 1006, such as a keyboard, mouse etc.

The processing apparatus 1002 is programmed to operate in accordance with programming instructions input, for example, as data stored on a data storage medium 1012 (such as an optical CD ROM, semiconductor ROM, magnetic recording medium, etc), and/or as a signal 1014 (for example an electrical or optical signal input to the processing apparatus 1002, for example from a remote database, by transmission over a communication network (not shown) such as the Internet or by transmission through the atmosphere), and/or entered by a user via a user input device 1006 such as a keyboard.

As will be described in more detail below, the programming instructions comprise instructions to program the processing apparatus 1002 to become configured to generate data defining a three-dimensional computer model of a subject object by processing data defining the silhouette of the subject object in a plurality of images recorded at different relative positions and orientations, data defining a preliminary 3D computer model of the surface of the subject object (which may comprise a model of relatively low accuracy, such as a cuboid enclosing only a part of the subject object, or a relatively high accuracy model which has been generated, for example, using one of the techniques described in the introduction above but which requires refinement), and data defining the relative positions and orientations of the silhouettes and the preliminary 3D computer surface model.

The objective of this processing is to generate a final 3D computer surface model of the subject object that is locally smooth and which is also consistent with the starting silhouettes (such that points on the final 3D surface lie within or close to the boundary of each silhouette when projected into each image).

The processing essentially comprises three stages: a first stage in which smoothing parameters are calculated to be used to smooth the preliminary 3D computer surface model; a second stage in which displacements are calculated to move surface points in the preliminary 3D computer surface model to positions closer to the projection of the silhouette boundaries in the 3D space; and a third stage in which the surface points in the preliminary 3D computer surface model are moved in 3D space in accordance with the smoothing parameters and displacements calculated in the first and second stages in such a way that the smoothing parameters and displacements are offset against each other to determine the positions of surface points defining the 3D surface. The calculation of smoothing parameters and displacements and the movement of 3D surface points is performed in such a way that the preliminary 3D computer surface model is smoothed to different extents in different areas of the surface, resulting in a 3D surface in which unwanted artefacts are smoothed out but relatively thin features representing thin features actual present on the subject object are not over-smoothed.

In particular, in the first stage of processing, smoothing parameters are calculated to vary the extent of smoothing over the preliminary 3D computer surface model, such that a relatively low amount of smoothing will be applied to regions which the silhouettes indicate represent relatively thin features on the subject object, and a relatively high amount of smoothing will be applied to other regions. In this way, regions in the preliminary 3D computer model are maintained if at least one silhouette indicates that the region represents a relatively thin feature of the subject object. On the other hand, regions of the preliminary 3D computer surface model which do not represent a thin feature of the subject object will be highly smoothed, with the result that artefacts will be smoothed away, thereby generating a more accurate 3D computer surface model.

The actual processing operations performed in stage one will be described in detail below, as will those performed in stages two and three.

When programmed by the programming instructions, processing apparatus 1002 can be thought of as being configured as a number of functional units for performing processing operations. Examples of such functional units and their interconnections are shown in FIG. 17. The units and interconnections illustrated in FIG. 17 are, however, notional, and are shown for illustration purposes only to assist understanding; they do not necessarily represent units and connections into which the processor, memory etc of the processing apparatus 1002 actually become configured.

Referring to the functional units shown in FIG. 17, central controller 1010 is operable to process inputs from the user input devices 1006, and also to provide control and processing for the other functional units. Memory 1020 is provided for use by central controller 1010 and the other functional units.

Input data interface 1030 is arranged to control the storage of input data within processing apparatus 1002. The data may be input to processing apparatus 1002 for example as data stored on a storage medium 1032, as a signal 1034 transmitted to the processing apparatus 1002, or using a user input device 1006.

In this embodiment, the input data comprises data defining a plurality of binary silhouette images of a subject object recorded at different relative positions and orientations (each silhouette image comprising an image of the subject object with pixels which are part of the subject object set to the value 1 and other pixels set to the value 0 to identify them as background pixels), data defining a preliminary 3D computer model of the surface of the subject object, and data defining the relative 3D positions and orientations of the silhouette images and the preliminary 3D computer surface model. In addition, in this embodiment, the input data also includes data defining the intrinsic parameters of each camera which recorded an image, that is, the aspect ratio, focal length, principal point (the point at which the optical axis intersects the imaging plane), first order radial distortion coefficient, and skew angle (the angle between the axes of the pixel grid; because the axes may not be exactly orthogonal).

Thus, referring to FIG. 18, the input data defines a plurality of silhouette images 1200-1214 and a 3D computer surface model 1300 having positions and orientations defined in 3D space. In this embodiment, the 3D computer surface model 1300 comprises a mesh of connected triangles but other forms of 3D computer surface model may be processed, as will be described later. For each silhouette image 1200-1214, the input data defines which pixels represent the subject object and which pixels are “background” pixels, thereby defining a respective silhouette 1250-1264 in each silhouette image 1200-1214. In addition, the input data defines the imaging parameters of the images 1200-1214, which includes, inter alia, the respective focal point position 1310-1380 of each silhouette image.

The input data defining the silhouette images 1200-1214 of the subject object, the data defining the preliminary 3D computer surface model 1300, and the data defining the positions and orientations of the silhouette images and preliminary three-dimensional computer surface model may be generated in any of a number of different ways. For example, processing may be performed as described in WO-A-01/39124 or EP-A-1,267,309.

The input data defining the intrinsic camera parameters may be input, for example, by a user using a user input device 1006.

Referring again to FIG. 17, surface generator 1040 is operable to process the input data received by input data interface 1030 to generate data defining a 3D computer model of the surface of the subject object, comprising a smoothed version of the input 3D computer surface model 1300 which is consistent with the silhouettes 1250-1264 in the input silhouette images 1200-1214.

In this embodiment, surface generator 1040 comprises smoothing parameter calculator 1050, displacement force calculator 1080 and surface optimiser 1090.

Smoothing parameter calculator 1050 is operable to calculate smoothing parameters defining different respective amounts of smoothing to be applied to a 3D computer surface model.

In this embodiment, smoothing parameter calculator 1050 includes silhouette width tester 1060 operable to calculate a measure of the width of the boundary of each silhouette 1250-1264 in a silhouette image 1200-1214, and surface resampler 1070 operable to amend a 3D computer surface model to generate a resampled 3D computer surface model in which the density of triangle vertices varies over the surface in accordance with measurements of the width of the silhouette boundaries. More particularly, surface resampler 1070 is operable to generate a resampled 3D computer surface model in which there are a relatively large number of closely spaced vertices in regions determined to represent relatively thin features of the subject object through tests on the silhouettes, and there are a relatively small number of widely spaced apart vertices in other regions of the 3D surface.

Displacement force calculator 1080 is operable to calculate a respective displacement for each vertex in the 3D computer surface model generated by surface resampler 1070 to move (that is, in effect, pull) the vertex to a position in 3D space from which the vertex will project to a position in a silhouette image 1200-1214 which is closer to the boundary of the silhouette 1250-1264 therein. Accordingly, displacement force calculator 1080 is operable to calculate displacement “forces” which will amend a 3D computer surface model to make it more consistent with the silhouettes 1250-1264 in the input silhouette images 1200-1214.

Surface optimiser 1090 is operable to amend a 3D computer surface model in such a way that each vertex is moved to a new position in dependence upon the positions of connected vertices in the 3D surface model, which “pull” the vertex to be moved towards them to smooth the 3D surface, and also in dependence upon the displacement for the vertex calculated by displacement force calculator 1080 which “pulls” the vertex towards the silhouette data and counter-balances the smoothing effect of the connected vertices.

Renderer 1100 is operable to render an image of a 3D computer surface model from any defined viewing position and direction.

Display controller 1110, under the control of central controller 1010, is arranged to control display device 1004 to display image data generated by renderer 1100 and also to display instructions to the user.

Output data interface 1120 is arranged to control the output of data from processing apparatus 1002. In this embodiment, the output data defines the 3D computer surface model generated by surface generator 1040. Output data interface 1120 is operable to output the data for example as data on a storage medium 1122 (such as an optical CD ROM, semiconductor ROM, magnetic recording medium, etc), and/or as a signal 1124 (for example an electrical or optical signal transmitted over a communication network such as the Internet or through the atmosphere). A recording of the output data may be made by recording the output signal 1124 either directly or indirectly (for example by making a first recording as a “master” and then making a subsequent recording from the master or from a descendent recording thereof) using a recording apparatus (not shown).

FIG. 19 shows the processing operations performed by processing apparatus 1002 to process input data in this embodiment.

Referring to FIG. 19, at step S19-2, central controller 1010 causes display controller 1110 to display a message on display device 1004 requesting the user to input data for processing.

At step S19-4, data as described above, input by the user in response to the request at step S19-2, is stored in memory 1020.

At step S19-6, surface generator 1040 increments the value of an internal counter “m” by 1 (the value of the counter being set to 1 the first time step S19-6 is performed).

At step S19-8, smoothing parameter calculator 1050 calculates smoothing parameters for the 3D surface 1300 stored at step S19-4 using the silhouettes 1250-1264 in the silhouette images 1200-1214 stored at step S19-4.

As outlined earlier, the purpose of the processing at step. S19-8 is to define different respective smoothing parameters for different regions of the 3D surface 1300, such that the parameters define a relatively low amount of smoothing for regions of the 3D surface representing relatively thin features of the subject object, and such that the parameters define a relatively high amount of smoothing for other regions of the 3D surface. In this way, thin features in the 3D computer surface model 1300 representing actual thin parts of the subject object will not be smoothed out in subsequent processing, but regions in the 3D computer surface model 1300 representing artefacts (that is, features not found on the actual subject object) will be smoothed and removed.

FIG. 20 shows the processing operations performed at step S19-8 in this embodiment.

Before describing these processing operations in detail, an overview of the processing will be given.

In this embodiment, when the triangle vertices in the preliminary 3D computer surface model 1300 are moved in subsequent processing to generate a refined 3D surface model, movements to smooth the preliminary 3D surface model are controlled in dependence upon the distances between the vertices. More particularly, in regions of the 3D surface where the connected vertices are spaced relatively far apart, the smoothing is essentially at a relatively large scale, that is the smoothing is relatively high. On the other hand, in regions of the 3D surface where the connected vertices are spaced relatively close together, the smoothing is essentially at a relatively small scale, that is a relatively small amount of smoothing is applied. Consequently, the purpose of the processing at step S19-8 is to define different respective spacings of vertices for different regions of the 3D surface.

This processing comprises projecting vertices from the preliminary 3D computer model 1300 into the silhouette images 1200-1214, measuring the width of the silhouette 1250-1264 in different directions from each projected vertex and using the widths to define a relatively high number of vertices in the preliminary 3D computer surface model 1300 in the vicinity of a vertex if at least one silhouette has a relatively low width for that vertex, and to define a relatively low number of vertices in the preliminary 3D computer surface model 1300 in the vicinity of a vertex if no silhouette has a relatively low width for that vertex.

The processing operations performed by smoothing parameter calculator 1050 will now be described in detail.

Referring to FIG. 20, at step S20-2, smoothing parameter calculator 1050 selects the next vertex from the preliminary 3D computer surface model 1300 stored at step S19-4 (this being the first vertex the first time step S20-2 is performed) and projects the selected vertex into each silhouette image 1200-1214. Each projection into an image is performed in a conventional way in dependence upon the position and orientation of the image relative to the 3D computer surface model 1300 (and hence the vertex being projected) and in dependence upon the intrinsic parameters of the camera which recorded the image.

At step S20-4, smoothing parameter calculator 1050 selects the next silhouette image 1200-1214 into which the selected vertex was projected at step S20-2 (this being the first silhouette image 1200-1214 the first time step S20-4 is performed).

At step S20-6, smoothing parameter calculator 1050 determines whether the projected vertex (generated at step S20-2) lies inside the silhouette 1250-1264 within the silhouette image 1200-1214 selected at step S20-4.

If it is determined at step S20-6 that the projected vertex lies outside the silhouette within the selected silhouette image, then processing proceeds to step S20-22 to process the next silhouette image.

On the other hand, if it is determined at step S20-6 that the projected vertex lies inside the silhouette within the selected silhouette image, then processing proceeds to step S20-8, at which smoothing parameter calculator 1050 selects the next search direction in the selected silhouette image (this being the first search direction the first time step S20-8 is performed).

FIGS. 21a to 21d show examples to illustrate the search directions available for selection at step S20-8. By way of example, the directions illustrated in FIGS. 21a to 21d comprise directions through a projected vertex 1400 in silhouette image 1208.

Referring to FIGS. 21a to 21d, a first search direction 1402 comprises a direction through projected vertex 1400 parallel to a first two sides of silhouette image 1208, a second search direction 1404 comprises a direction through projected vertex 1400 parallel to the other two sides of silhouette image 1208 (that is, at 90° to the first search direction), a third search direction 1406 comprises a direction through projected vertex 1400 at 45° to the first search direction 1402 on a first side thereof, and a fourth search direction 1408 comprises a direction through projected vertex 1400 at 45° to the first search direction 1402 on the other side thereof (that is, at 90° to the third search direction).

In this embodiment, four search directions 1402-1408 are employed, but other numbers of search directions may be used instead.

Referring again to FIG. 20, at step S20-10, silhouette width tester 1060 searches within the selected silhouette image in the search direction selected at step S20-8 on both sides of the projected vertex to identify the closest point on the silhouette boundary on each side of the projected vertex in the search direction.

Thus, referring to the example shown in FIG. 22, if the search direction selected at step S20-8 is search direction 1402, then silhouette width tester 1060 searches in this direction in the silhouette image 1208 to identify the points 1410 and 1412 lying on the boundary of silhouette 1258 on different respective sides of the projected vertex 1400 in the direction 1402.

Similarly, if the search direction selected at step S20-8 is search direction 1404, silhouette width tester 1060 searches in this direction to identify the points 1414 and 1416 on the silhouette boundary. If the search direction selected at step S20-8 is direction 1406, then silhouette width tester 1060 searches in this direction to identify the points 1418 and 1420 on the silhouette boundary, while if the search direction selected at step S20-8 is direction 1408, then silhouette width tester 1060 searches in this direction to identify the points 1422 and 1424 on the silhouette boundary.

Referring again to FIG. 20, at step S20-12, silhouette width tester 1060 calculates the distance between the two points on the boundary of the silhouette image identified at step S20-10. This distance represents the width of the silhouette in the selected search direction.

At step S20-14, the silhouette width tester 1060 converts the silhouette width calculated at step S20-12 to a width in 3D space. This processing is performed to enable widths from different silhouette images 1200-1214 to be compared (because different silhouette images 1200-1214 may not have been recorded under the same viewing conditions), and is carried out in accordance with the following equation:

$${W}_{3 D} = {W}_{i} \times \frac{\vert \underline{x} - \underline{o} \vert}{{f}^{*}} \qquad ( 7 )$$

where:
W_{3D} is the width in 3D space
Wᵢ is the width in the silhouette image
f* is the focal length of the camera which recorded the selected silhouette image measured in mm divided by the width of a pixel in mm in the image recorded by the camera (the value of f* being calculated from the intrinsic camera parameters stored at step S19-4).
x is the 3D position of the vertex selected at step S20-2
o is the 3D position of the optical centre of the camera which recorded the selected silhouette image (defined by the intrinsic camera parameters stored at step S19-4).

At step S20-16, silhouette width tester 1060 determines whether the distance in 3D space calculated at step S20-14 is less than the existing stored distance for the selected vertex.

If it is determined at step S20-16 that the distance calculated at step S20-14 is less than the existing stored distance, then processing proceeds to step S20-18, at which silhouette width tester 1060 replaces the existing stored distance with the distance calculated at step S20-14. (It should be noted that, the first time step S20-16 is performed, there will be no existing stored distance for the selected vertex, with the result that the processing proceeds from step S20-16 to step S20-18 to store the distance calculated at step S20-14.)
On the other hand, if it is determined at step S20-16 that the existing stored distance is less than or equal to the distance calculated at step S20-14, then the processing at step S20-18 is omitted, so that the existing stored distance is retained.

An step S20-20, smoothing parameter calculator 1050 determines whether any search directions 1402-1408 remain to be processed, and steps S20-8 to S20-20 are repeated until each search direction has been processed in the way described above.

Referring again to FIG. 22, as a result of the processing at steps S20-8 to S20-20, the distance is calculated between points 1410 and 1412, between points 1414 and 1416, between points 1418 and 1420, and between points 1422 and 1424. Each of these distances is converted to a distance in 3D space at step S20-16 and the smallest distance (in this case the distance between points 1418 and 1420) is retained at step S20-18.

At step S20-22, smoothing parameter calculator 1050 determines whether any silhouette images remain to be processed for the vertex selected at step S20-2. Steps S20-4 to S20-22 are repeated until each silhouette image has been processed for the vertex selected at step S20-2 in the way described above.

As a result of this processing, the width of the silhouette is calculated in each silhouette image 1200-1214 in which the projected vertex lies inside the silhouette therein. For each silhouette, the width is calculated in each of the search directions. All of the calculated widths for a given silhouette and for different silhouettes are compared by the processing at steps S20-16 and S20-18, and the width remaining stored at step S20-18 represents the smallest width in a search direction through the projected vertex in any of the silhouette images 1200-1214.

At step S20-24, smoothing parameter calculator 1050 determines whether any polygon vertices in the 3D computer surface model remain to be processed. Steps S20-2 to S20-24 are repeated until each polygon vertex in the 3D computer surface model has been processed in the way described above.

At step S20-26, surface resampler 1070 generates a resampled 3D computer surface model in accordance with the minimum silhouette width stored at step S20-18 for each vertex in the starting 3D computer surface model 1300.

FIG. 23 shows the processing operations performed by surface resampler 1070 at step S20-26.

Referring to FIG. 23, at step S23-2, surface resampler 1070 adds a new triangle vertex at the midpoint of each triangle edge in the 3D computer surface model 1300.

Thus, referring to the example shown in FIG. 24a by way of example, new vertices 1430-1438 are added at the midpoints of edges 1440-1448 defined by vertices 1450-1456 already existing in the 3D computer surface model 1300.

Referring again to FIG. 23, at step S23-4, surface resampler 1070 calculates a respective silhouette 3D width measure for each new vertex added at step S23-2. More particularly, in this embodiment, surface resampler 1070 calculates a 3D width measure for a new vertex by calculating the average of the silhouette widths in 3D space previously stored at step S20-18 for the vertices in the 3D computer surface model 1300 defining the ends of the edge on which the new vertex lies.

At step S23-6, surface resampler 1070 retriangulates the 3D computer surface model by connecting the new vertices added at step S23-2. More particularly, referring to FIG. 24b, surface resampler 1070 connects the new vertices 1430-1438 to divide each triangle in the preliminary 3D computer surface model 1300 into four triangles lying within the plane of the original triangle. Thus, by way of example, the triangle defined by original vertices 1450, 1452, 1456 is divided into four triangles 1460-1466, and the triangle defined by original vertices 1452, 1454, 1456 is divided into four triangles 1468-1474.

Referring again to FIG. 23, at step S23-8, surface resampler 1070 calculates a respective collapse cost score for each edge in the retriangulated polygon mesh generated at step S23-6, defining a measure of the effect that the edge's removal will have on the overall retriangulated polygon mesh—the higher the score, the greater the effect the removal of the edge will have on the retriangulated polygon mesh. In this embodiment, this collapse cost score is calculated in accordance with the following equation:

$$Cost = \frac{\vert \underline{u} - \underline{v} \vert}{min ( {Wu}_{3 D} , {Wv}_{3 D} )} \qquad ( 8 )$$

where:
u is the 3D position of vertex u at the end of the edge;
v is the 3D position of vertex v at the end of the edge;
Wu_{3D} is the width in 3D space calculated for the vertex u at steps S20-2 to S20-22 or S23-4;
Wv_{3D} is the width in 3D space calculated for the vertex v at steps S20-2 to S20-22 or S23-4;
min (Wu_{3D}, Wv_{3D}) is Wu_{3D} or Wv_{3D}, whichever is the smaller.

At step S23-10, surface resampler 1070 selects the next “best” edge UV in the polygon mesh as a candidate edge to collapse (this being the first “best” edge the first time step S23-10 is performed). More particularly, surface resampler 1070 selects the edge having the lowest calculated collapse cost score as a candidate edge to collapse (since the removal of this edge should have the least effect on the polygon mesh).

At step S23-12, surface resampler 1070 determines whether the collapse cost score associated with the candidate edge selected at step S23-10 is greater than a predetermined threshold value (which, in this embodiment, is set to 0.1). The first time step S23-12 is performed, the collapse cost score associated with the candidate edge will be less than the predetermined threshold value. However, as will be explained below, when an edge is collapsed, the collapse cost scores of the remaining edges are updated. Accordingly, when it is determined at step S23-12 on a subsequent iteration that the collapse cost score associated with the candidate edge is greater than the predetermined threshold, the processing has reached a stage where no further edges should be removed. This is because the edge selected at step S23-10 as the candidate edge is the edge with the lowest collapse cost score, and accordingly if the collapse cost score is determined to be greater than the predetermined threshold at step S23-12, then the collapse cost score associated with all remaining edges will be greater than the predetermined threshold. In this case, the resampling of the 3D computer surface model is complete, and processing returns to step S19-10 in FIG. 19.

On the other hand, when it is determined at step S23-12 that the collapse cost score associated with the candidate edge is not greater than the predetermined threshold, processing proceeds to step S23-14, at which surface resampler 1070 collapses the candidate edge selected at step S23-10 within the polygon mesh. In this embodiment, the edge collapse is carried out in a conventional way, for example as described in the article “A Simple Fast and Effective Polygon Reduction Algorithm” published at pages 44-49 of the November 1998 issue of Game Developer Magazine (publisher CMP Media, Inc) or as described in “Progressive Meshes” by Hoppe, Proceedings SIGGRAPH 96, pages 99-108. The edge collapse results in the removal of two triangular polygons, one edge and one vertex from the polygon mesh.

FIGS. 25a and 25b show an example to illustrate the processing performed at step S23-14.

Referring to FIG. 25a, part of the 3D computer surface model is shown comprising triangles A-H, with two vertices U and V defining an edge 1500 of triangles A and B.

In the processing at step S23-14, surface resampler 1070 moves the position of vertex U so that it is at the same position as vertex V.

Referring to FIG. 25b, as a result of this processing, vertex U, edge 1500 and triangles A and B are removed from the 3D computer surface model. In addition, the shapes of triangles C, D, G and H which share vertex U are changed. On the other hand, the shapes of triangles E and F which do not contain either vertex U or vertex V, are unchanged.

Referring again to FIG. 23, at step S23-16, surface resampler 1070 performs processing to update the collapse cost scores for the edges remaining in the polygon mesh in accordance with the equation used at step S23-8.

Steps S23-10 to S23-16 are repeated to select edges in the polygon mesh and test them to determine whether they can be removed, until it is determined at step S23-12 that every edge remaining in the polygon mesh has a collapse cost score greater than the predetermined threshold. When this situation is reached, the resampling processing ends, and processing returns to step S19-10 in FIG. 19.

FIGS. 26a and 26b show an example to illustrate the result of the processing performed by smoothing parameter calculator 1050 at step S19-8. FIG. 26a shows a view of a preliminary 3D computer surface model 1300 stored at step S19-4 showing the distribution and size of triangles within the polygon mesh making up the 3D surface. FIG. 26b shows the same view of the polygon mesh making up the 3D surface after the processing at step S19-8 has been performed.

FIG. 26b illustrates how the processing at step S19-8 generates a 3D computer surface model in which the triangle vertices are distributed such that there are a relatively low number of widely spaced apart vertices in regions which are to undergo relatively high smoothing, such as region 1510 (that is, regions representing relatively wide features, and there are a relatively large number of closely spaced together vertices in regions which are to undergo relatively little smoothing, such as region 1520 (that is, regions representing relatively narrow features).

As will be explained below, when the triangle vertices are moved in subsequent processing to generate a refined 3D surface model, the movements are controlled in dependence upon the distance between the vertices. Accordingly, the relative distribution of vertices generated by the processing at step S19-8 controls the subsequent refinement of the 3D surface, and in particular determines the relative amounts of smoothing to be applied to different regions of the 3D surface.

Referring again to FIG. 19, at step S19-10 surface generator 1040 increments the value of an internal counter “n” by 1 (the value of the counter being set to 1 the first time step S19-10 is performed).

At step S19-12, displacement force calculator 1080 calculates a respective displacement force for each vertex in the 3D computer surface model generated at step S19-8.

FIG. 27 shows the processing operations performed by displacement force calculator 1080 at step S19-12.

Before describing these processing operations in detail, an overview of the processing will be given.

The objective of the processing at step S19-12 is to calculate displacements for the vertices in the 3D computer surface model that would move the vertices towards the surfaces defined by the back-projection of the silhouettes 1250-1264 into 3D space. In other words, the displacements “pull” the vertices of the 3D surface towards the silhouette data.

However, the 3D computer surface model can only be compared against the silhouettes 1250-1264 for points in the 3D surface which project close to the boundary of a silhouette 1250-1264 in at least one input image 1200-1214.

Accordingly, the processing at step S19-12 identifies vertices within the 3D computer surface model which project to a point in at least one input image 1200-1214 lying close to the boundary of a silhouette 1250-1264 therein, and calculates a respective displacement for each identified point which would move the point to a position in 3D space from which it would project to a point closer to the identified silhouette boundary. For each remaining vertex in the 3D computer surface model, a respective displacement is calculated using the displacements calculated for points which project from 3D space close to a silhouette boundary.

The processing operations performed at step S19-12 will now be described in detail.

Referring to FIG. 27, at step S27-2, displacement force calculator 1080 calculates a respective surface normal vector for each vertex in the resampled 3D surface generated at step S19-8. More particularly, in this embodiment, a surface normal vector for each vertex is calculated by calculating the average of the normal vectors of the triangles which meet at the vertex, in a conventional way.

At step S27-4, displacement force calculator 1080 selects the next silhouette image 1200-1214 for processing (this being the first silhouette image the first time step S27-4 is performed).

At step S27-6, renderer 1100 renders an image of the resampled 3D surface generated at step S19-8 in accordance with the camera viewing parameters for the selected silhouette image (that is, in accordance with the position and orientation of the silhouette image relative to the resampled 3D surface and in accordance with the intrinsic camera parameters stored at step S19-4). In addition, displacement force calculator 1080 determines the boundary of the projected surface in the rendered image to generate a reference silhouette for the resampled 3D surface in the silhouette image selected at step S27-4.

At step S27-8, displacement force calculator 1080 projects the next vertex from the resampled 3D surface into the selected silhouette image (this being the first vertex the first time step S27-8 is performed).

At step S27-10, displacement force calculator 1080 determines whether the projected vertex lies within a threshold distance of the boundary of the reference silhouette generated at step S27-6. In this embodiment, the threshold distance used at step S27-10 is set in dependence upon the number of pixels in the image generated at step S27-6. For example, for an image of 512 by 512 pixels, a threshold distance of ten pixels is used.

If it is determined at step S27-10 that the projected vertex does not lie within the threshold distance of the boundary of the reference silhouette, then processing proceeds to step S27-28 to determine whether any polygon vertex in the resampled 3D surface remains to be processed. If at least one polygon vertex has not been processed, then processing returns to step S27-8 to project the next vertex from the resampled 3D surface into the selected silhouette image.

On the other hand, if it is determined at step S27-10 that the projected vertex does lie within the threshold distance of the boundary of the reference silhouette, then processing proceeds to step S27-12, at which surface optimiser 1090 labels the vertex selected at step S27-8 as a “boundary vertex” and projects the vertex's surface normal calculated at step S27-2 from 3D space into the silhouette image selected at step S27-4 to generate a two-dimensional projected normal.

At step S27-14, displacement force calculator 1080 determines whether the vertex projected at step S27-8 is inside or outside the original silhouette 1250-1264 existing in the silhouette image (that is, the silhouette defined by the input data stored at step S19-4 and not the reference silhouette generated at step S27-6).

At step S27-16, displacement force calculator 1080 searches along the projected normal in the silhouette image from the vertex projected at step S27-12 towards the boundary of the original silhouette 1250-1264 (that is, the silhouette defined by the input data stored at step S19-4) to detect points on the silhouette boundary lying within a predetermined distance of the projected vertex along the projected normal.

More particularly, to ensure that the search is carried out in a direction towards the silhouette boundary, displacement force calculator 1080 searches along the projected normal in a positive direction if it was determined at step S27-14 that the projected vertex lies inside the silhouette, and searches along the projected normal in a negative direction if it was determined at step S27-14 that the projected vertex is outside the silhouette. Thus, referring to the examples shown in FIG. 28, projected vertices 1530 and 1540 lie within the boundary of silhouette 1258, and accordingly a search is carried out in the positive direction along the projected normals 1532 and 1542 (that is, the direction indicated by the arrowhead on the normals shown in FIG. 28). On the hand, projected vertices 1550 and 1560 lie outside the silhouette 1258, and accordingly displacement force calculator 1080 carries out the search at step S27-16 in a negative direction along the projected normal for each vertex—that is, along the dotted lines labelled 1552 and 1562 in FIG. 28.

Referring again to FIG. 27, at step S27-18, displacement force calculator 1080 determines whether a point on the silhouette boundary was detected at step S27-16 within a predetermined distance of the projected vertex. In this embodiment, the predetermined distance is set to 10 pixels for a silhouette image size of 512 by 512 pixels.

If it is determined at step S27-18 that a point on the silhouette boundary does lie within the predetermined distance of the projected vertex in the search direction, then processing proceeds to step S27-20 at which the identified point on the silhouette boundary closest to the projected vertex is selected as a matched target point for the vertex. Thus, referring to the examples shown in FIG. 28, for the case of projected vertex 1530, the point 1534 on the silhouette boundary would be selected at step S27-20. Similarly, in the case of projected vertex 1550, the point 1554 on the silhouette boundary would be selected at step S27-20.

On the hand, if it is determined at step S27-18 that a point on the silhouette boundary does not lie within the predetermined distance of the projected vertex in the search direction, then processing proceeds to step S27-22 at which the point lying the predetermined distance from the projected vertex in the search direction is selected as a matched target point for the vertex. Thus, referring again to the examples shown in FIG. 28, in the case of projected vertex 1540, point 1544 would be selected at step S27-22 because this point lies at the predetermined distance from the projected vertex in the positive direction of the projected normal vector. Similarly, in the case of projected vertex 1560, the point 1564 would be selected at step S27-22 because this point lies the predetermined distance away from the projected vertex 1560 in the negative direction 1562 of the projected normal vector.

Following the processing at step S27-20 or step S27-22, the processing proceeds to step S27-24, at which displacement force calculator 1080 back projects a ray through the matched target point in the silhouette image into 3-dimensional space. This processing is illustrated by the example shown in FIG. 29.

Referring to FIG. 29, a ray 1600 is projected from the focal point position 1350 (defined in the input data stored at step S19-4) for the camera which recorded the selected silhouette image 1208 through the matched target point selected at step S27-20 or S27-22 (this target point being point 1534 from the example shown in FIG. 28 for the purpose of the example in FIG. 29).

At step S27-26, displacement force calculator 1080 calculates a 3D vector displacement for the currently selected vertex in the resampled 3D surface.

More particularly, referring again to the example shown in FIG. 29, displacement force calculator 1080 calculates a vector displacement for the selected vertex 1610 in the resampled 3D surface which comprises the displacement of the vertex 1610 in the direction of the surface normal vector n (calculated at step S27-2 for the vertex) to the point 1620 which lies upon the ray 1600 projected at step S27-24. The surface normal vector n will intersect the ray 1600 (so that the point 1620 lies on the ray 1600) because the target matched point 1534 lies along the projected normal vector 1532 from the projected vertex 1530 in the silhouette image 1208.

As a result of this processing, a displacement has been calculated to move the selected vertex (vertex 1610 in the example of FIG. 29) to a new (point 1620 in the example of FIG. 29) from which the vertex projects to a position in the selected silhouette image (silhouette image 1208 in the example of FIG. 29) which is closer to the boundary of the silhouette therein than if the vertex was projected from its original position in the resampled 3D surface.

At step S27-28, displacement force calculator 1080 determines whether there is another vertex to be processed in the resampled 3D surface, and steps S27-8 to S27-28 are repeated until each vertex in the resampled 3D surface has been processed in the way described above.

At step S27-30, displacement force calculator 1080 determines whether any silhouette image remains to be processed, and steps S27-4 to S27-30 are repeated until each silhouette image has been processed in the way described above.

As a result of this processing, at least one displacement vector has been calculated for each “boundary” vertex in the resampled 3D computer surface model (that is, each vertex which projects to within the threshold distance of the boundary of the reference silhouette—determined at step S27-10). If a given vertex in the resampled 3D surface projects to within the threshold distance of the boundary of the reference silhouette in more than one reference image, then a plurality of respective displacements will have been calculated for that vertex.

At step S27-32, displacement force calculator 1080 calculates a respective average 3D vector displacement for each boundary vertex in the resampled 3D surface.

More particularly, if a plurality of vector displacements have been calculated for a boundary vertex (that is, one respective displacement for each silhouette image for which the vertex is a boundary vertex), displacement force calculator 1080 calculates the average of the vector displacements. For a boundary vertex for which only one vector displacement has been calculated, then processing at step S27-32 is omitted so that the single calculated vector displacement is maintained.

At step S27-34, displacement force calculator 1080 calculates a respective vector displacement for each non-boundary vertex in the resampled 3D surface. More particularly, for each vertex for which no vector displacement was calculated in the processing at S27-4 to S27-30, displacement force calculator 1080 uses the average of the vector displacements calculated for neighbouring vertices, and this processing is applied iteratively so that the calculated displacement vectors propagate across the resampled 3D surface until each vertex in the resampled 3D surface has a vector displacement associated with it.

Referring again to FIG. 19, at step S19-14, surface optimiser 1090 performs processing to optimise the 3D surface using the smoothing parameters calculated at step S19-8 and the displacement forces calculated at step S19-14.

More particularly, the processing at step S19-8 generated a resampled 3D surface in which the vertices are relatively closely spaced together in regions determined from the input silhouettes 1250-1264 to represent relatively thin features, and in which the vertices are relatively widely spaced apart in other regions. The processing at step S19-12 calculated a respective displacement for each vertex in the resampled 3D surface to move the vertex to a position from which it would project to a position in each input silhouette image 1200-1214 closer to the boundary of the silhouette therein than if it was projected from its position in the original input 3D computer surface model 1300 stored at step S19-4.

The processing performed at step S19-14 comprises moving each vertex in the resampled 3D surface generated at step S19-8 in dependence upon the positions of the neighbouring vertices (which will tend to pull the vertex towards them to smooth the 3D surface) and in dependence upon the displacement force calculated for the vertex at step S19-12 (which will tend to pull the vertex towards a position which is more consistent with the silhouettes 1250-1264 in the input silhouette images 1200-1214).

FIG. 30 shows the processing operations performed by surface optimiser 1090 at step S19-14.

Referring to FIG. 30, at step S30-2, surface optimiser 1090 calculates a new respective position in a 3D space for each vertex in the resampled 3D surface.

In this embodiment, a new position is calculated at step S30-2 for each vertex in accordance with the following equation:
u′=u+ε{d+λ(\overline{v}−u)} (9)
where
u′ is the new 3D position of the vertex
u is the current 3D position of the vertex
ε is a constant (set to 0.1 in this embodiment)
d is the displacement vector calculated for the vertex at step S19-12
λ is a constant (set to 1.0 in this embodiment)
\overline{v} is the average position of the vertices connected to the vertex in the resampled 3D surface, and is given by:

$$\overline{𝓋} = \frac{1}{n} {\sum }_{i}^{n} {𝓋}_{i} \qquad ( 10 )$$

where vᵢ is the 3D position of a connected vertex.

It will be seen from equation (9) that the new 3D position u′ of each vertex is dependent upon the displacement vector calculated at step S19-12 as well as the positions of the vertices connected to the vertex in the resampled 3D mesh generated at step S19-8.

Referring again to FIG. 30, at step S30-4, surface optimiser 1090 moves the vertices of the resampled 3D surface to the new positions calculated at step S30-2.

The processing performed at steps S30-2 and S30-4 is illustrated in the example shown in FIGS. 31a and 31b.

In the example shown, vertex U is connected to vertices v0, v1, v2 and v3. Consequently, the average position \overline{v} of the vertices v0, v1, v2 and v3 is calculated. The displacement force d for the vertex U and the average position \overline{v} are then used to calculate the new position for vertex U in accordance with equation (9).

Consequently, if the connected vertices v0-v3 are spaced relatively far away from the vertex U, then the average position \overline{v} will be relatively far away from the current position of vertex u. As a result, the connected vertices v0-v3 influence (that is, pull) the position of the vertex U more than the vector displacement d influences (that is, pulls) the position of the vertex U. Consequently, the 3D surface at vertex U undergoes a relatively high amount of smoothing because vertex U is pulled towards the connected vertices v0-v3. In this way, artifacts in the 3D computer surface model stored at step S19-4 are removed.

On the other hand, if the vertices v0-v3 connected to the vertex U are spaced relatively close together and close to vertex U, then the average position \overline{v} will also be relatively close to the current position of vertex U, with the result that the vertices v0-v3 influence (that is, pull) the position of the vertex U less than the displacement d. As a result, the 3D surface in the region of vertex U undergoes relatively little smoothing, and thin features are preserved because over-smoothing is prevented.

Referring again to FIG. 19, at step S19-16, surface generator 1040 determines whether the value of the counter n has reached ten, and steps S19-10 to S19-16 are repeated until the counter n indicates that these steps have been performed ten times. Consequently, for a respective resampled 3D surface generated at step S19-8, the processing at step S19-12 to calculate displacement forces and the processing at step S19-14 to optimise the resampled surface are iteratively performed.

At step S19-18, surface generator 1040 determines whether the value of the counter m has yet reached 100. Steps S19-6 to S19-18 are repeated until the counter m indicates that the steps have been performed one hundred times. As a result, the processing to generate a resampled 3D surface at step S19-8 and subsequent processing is iteratively performed. When it is determined at step S19-18 that the value of the counter m is equal to one hundred, then the generation of the 3D computer surface model is complete.

At step S19-20, output data interface 1120 outputs data defining the generated 3D computer surface model. The data is output from processing apparatus 1002 for example as data stored on a storage medium 1122 or as signal 1124 (as described above with reference to FIG. 17). In addition, or instead, renderer 1100 may generate image data defining images of the generated 3D computer surface model in accordance with a virtual camera controlled by the user. The images may then be displayed on display device 1004.

As will be understood by the skilled person from the description of the processing given above, the preliminary 3D computer surface model stored at step S19-4 need only be very approximate. Indeed, the preliminary 3D computer surface model may define a volume which encloses only a part (and not all) of the subject object 1300 because the displacement forces calculated at step S19-12 allow the 3D surface to be “pulled” in any direction to match the silhouettes 1250-1264 in the silhouette images 1200-1214. Accordingly, a preliminary volume enclosing only a part of the subject object will be modified so that it expands to enclose all of the subject object while at the same time it is smoothed, so that the final model accurately represents the surface of the subject object while remaining consistent with the silhouettes 1250-1264 in the input silhouette images 1200-1214.

Fifth Embodiment

A fifth embodiment of the present invention will now be described.

Referring to FIG. 32 the functional components of the fifth embodiment and the processing operations performed thereby are the same as those in the fourth embodiment, with the exception that surface resampler 1070 in the fourth embodiment is replaced by smoothing weight value calculator 1072 in the fifth embodiment, and the processing operations performed at step S20-26 are different in the fifth embodiment to those in the fourth embodiment.

Because the other functional components and the processing operations performed thereby are the same as those in the fourth embodiment, they will not be described again here. Instead, only the differences between the fourth embodiment and the fifth embodiment will be described.

In the fifth embodiment, instead of generating a resampled 3D surface at step S20-26, smoothing weight value calculator 1072 performs processing to calculate a respective weighting value λ for each vertex in the 3D computer surface model 1300. More particularly, for each vertex in the 3D surface for which a width W_{3D} was calculated at step S19-8 (that is, each vertex that projects to a position inside at least one silhouette 1250-1264), smoothing weight value calculator 1072 calculates a weighting value λ in accordance with the following equation:

$$λ = 1 - \frac{k}{{W}_{3 D}} \text{if the calculated value is greater than 0} \\ \text{otherwise} λ = 0 \qquad ( 11 )$$

where:
W_{3D} is the smallest width in 3D space stored for the vertex at step S20-18 (measured in the units of the 3D space);
k is a value between 0 and the maximum dimension of the 3D computer surface model measured in units of the 3D space. The value of k is set in dependence upon the smallest relative width to be represented in the 3D computer surface model. More particularly, k is set to a value corresponding to a fraction of the maximum dimension of the 3D computer surface model, thereby defining the smallest width to be represented relative to the maximum dimension. In this embodiment, k is set to 0.001 of the maximum dimension.

It will be seen from equation (11) that the weighting value λ will always have a value between 0 and 1, with the value being relatively low in a case where the silhouette width W_{3D} is relatively low (corresponding to relatively thin features) and the value being relatively high in a case where the silhouette width W₃D is relatively high.

For each vertex in the 3D surface for which a width W_{3D} was not calculated at step S19-8, smoothing weight value calculator 1072 sets the value of λ for the vertex to a constant value, which, in this embodiment, is 0.1.

It will be appreciated, however, that the value of λ may be set in different ways for each vertex for which a width W_{3D} was not calculated at step S19-8. For example, a respective value of λ may be calculated for each such vertex by extrapolation of the λ values calculated in accordance with equation (11) for each vertex for which a width W₃D was calculated at step S19-8.

In the fifth embodiment, each value of λ calculated at step S20-26 is subsequently used by surface optimiser 1090 at step S30-2 to calculate a new respective position in 3D space for each vertex of the 3D computer surface model 1300. More particularly, to calculate the new position of each vertex, the value of λ calculated at step S20-26 for the vertex is used in equation (9) above in place of the constant value of λ used in the fourth embodiment.

As a result of this processing, when the value of λ is relatively high (that is, in regions representing relatively wide features), the new 3D position u′ of a vertex calculated in accordance with equation (9) will be pulled towards the average position \overline{v} of the connected vertices to cause relatively high smoothing in this region. On the other hand, when the value of λ is relatively low (that is, in a region representing a relatively thin feature), then the new 3D position u′ of a vertex calculated in accordance with equation (9) will be influenced to a greater extent by the value of the displacement vector d than by the average position \overline{v} of the connected vertices. As a result, this region of the 3D surface will undergo relatively little smoothing, with the result that the thin feature is preserved.

In summary, the processing at step S19-8 in the fourth embodiment to calculate smoothing parameters results in a resampled 3D surface—that is, a 3d surface having vertices in different positions compared to the positions of the vertices in the starting 3D computer surface model 1300. On the other hand, in the fifth embodiment, the original positions of the vertices in the 3D computer surface model 1300 are maintained in the processing at step S19-8, and the calculation of smoothing parameters results in a respective weighting value λ for each vertex.

It will be understood that, because the number and positions of the vertices in the starting 3D surface do not change in the fifth embodiment, then the processing to calculate displacement forces over the 3D surface at step S19-12 may be performed before the processing to calculated smoothing parameters for the 3D surface using the silhouette images at step S19-8.

Sixth Embodiment

A sixth embodiment of the present invention will now be described.

In the fourth and fifth embodiments, displacement force calculator 1080 performs processing at step S19-12 to calculate displacement forces over the 3D surface, and surface optimiser 1090 performs processing at step S19-14 to optimise the 3D surface using the smoothing parameters calculated by smoothing parameter calculator 1050 at step S19-8 and also the displacement forces calculated by displacement force calculator 1080 at step S19-12. In the sixth embodiment, however, displacement force calculator 1080 and the processing at step S19-12 are omitted.

More particularly, the functional components of the sixth embodiment and the processing operations performed thereby are the same as those in the fifth embodiment, with the exception that displacement force calculator 1080 and the processing operations performed thereby at step S19-12 are omitted, and the processing operations performed by surface optimiser 1090 at step S19-14 are different.

Because the other functional components and the processing operations performed thereby are the same as those in the fifth embodiment, they will not be described again here. Instead, only the differences in the processing performed by surface optimiser 1090 at step S19-14 will be described.

In the sixth embodiment, surface optimiser 1090 performs processing at step S19-14 in accordance with the processing operations set out in FIG. 30, but calculates a new position at step S30-2 for each vertex in the 3D computer surface model in accordance with the following equation, which is a modified version of equation (9) used in the fourth embodiment:
u′=u+ε{u_{c}−u+λ(\overline{v}−u)} (12)
where
u′ is the new 3D position of the vertex
u is the current 3D position of the vertex
uₒ is the original 3D position of the vertex (that is, the position of the vertex in the 3D computer surface model 1300 stored at step S19-4)
ε is a constant (set to 0.1 in this embodiment)
λ is the weighting value calculated in accordance with equation (11)
\overline{v} is the average position of the vertices connected to the vertex, calculated in accordance with equation (10).

As a result of this processing, instead of calculating a displacement force as in the fourth and fifth embodiments (performed by displacement force calculator 1080 at step S19-12), to pull each vertex towards a position which is more consistent with the silhouettes 1250-1264 in the input silhouette images 1200-1214, each vertex is pulled towards its original position in the input 3D computer surface model 1300 stored at step S19-4. This counteracts the smoothing by the smoothing parameters calculated at step S19-8 and prevents over-smoothing of relatively thin features in the 3D computer surface model 1300.

In order to produce accurate results with the sixth embodiment, however, the 3D computer surface model 1300 stored at step S19-4 needs to be relatively accurate, such as a visual hull 3D computer surface model, rather than a relatively inaccurate model such as a cuboid containing some or all of the subject object.

Seventh Embodiment

A seventh embodiment of the present invention will now be described.

In the fourth, fifth and sixth embodiments, displacement force calculator 1080 performs processing at step S19-12 to calculate displacement forces over the 3D surface, and surface optimiser 1090 performs processing at step S19-14 to optimise the 3D surface using the smoothing parameters calculated by smoothing parameter calculator 1050 at step S19-8 and the displacement forces calculated by displacement force calculator 1080 at step S19-12. In the seventh embodiment, however, displacement force calculator 1080, surface optimiser 1090, and the processing operations at steps S19-10 to S19-16 are omitted.

More particularly, the functional components of the seventh embodiment and the processing operations performed thereby are the same as those in the fourth embodiment, with the exception that displacement force calculator 1080, surface optimiser 1090 and the processing operations performed at steps S19-8 to S19-16 are omitted.

Consequently, in the seventh embodiment, surface generator 1040 comprises only smoothing calculator 1050, with the result that the processing performed thereby results in a resampled 3D surface (generated at step S20-26) in which the number of surface points defining the 3D surface is increased in regions representing relatively thin features of the subject object.

As a result, these relatively thin features are more accurately modelled.

Modifications and Variations

Many modifications and variations can be made to the embodiments described above within the scope of the claims.

For example, in the embodiments described above, the 3D computer surface model 300 stored at step S3-4 comprises a plurality of vertices in 3D space connected to form a polygon mesh. However, different forms of 3D computer surface model may be processed. For example, a 3D surface defined by a plurality of voxels, a “level set” representation (that is, a signed distance function defining the position of the surface relative to grid is points in 3D space such as the centres of voxels), or a “point cloud” representation (comprising unconnected points in 3D space representing points on the object surface) may be processed. In this case, the processing performed on vertices in the embodiments is replaced with corresponding processing performed on points in the voxels (such as the centre or a defined corner) of a voxel representation, grid points in a level set representation defining the 3D surface, or the points in a point cloud representation. Consequently, the term “surface point” will be used to refer to a point in any form of 3D computer surface model used to define the 3D surface, such as a vertex in a polygon mesh, a point on or within a voxel, point at which a surface function in a level set representation is evaluated, a point in a point cloud representation, etc.

In the embodiments described above, at step S3-4, data input by a user defining the intrinsic parameters of the camera is stored. However, instead, default values may be assumed for some, or all, of the intrinsic camera parameters, or processing may be performed to calculate the intrinsic parameter values in a conventional manner, for example as described in “Euclidean Reconstruction From Uncalibrated Views” by Hartley in Applications of Invariance in Computer Vision, Mundy, Zisserman and Forsyth eds, pages 237-256, Azores 1993.

In the embodiments described above, processing is performed by a programmable computer using processing routines defined by programming instructions. However, some, or all, of the processing could, of course, be performed using hardware.

Other modifications are, of course, possible.

1. A method of processing data defining a first three-dimensional computer model of the surface of an object, and data defining a respective silhouette of the object in each of a plurality of images, to generate a second three-dimensional computer model representing the surface of the object, the method comprising:
determining different respective smoothing parameters for different respective parts of the first three-dimensional computer model in dependence upon at least one geometric property of parts of the silhouettes corresponding to the surface parts; and
changing the first three-dimensional computer model in dependence upon the determined smoothing parameters, to generate a second three-dimensional computer model of the object surface.

2. A method according to claim 1, wherein the process of changing the first three-dimensional computer model comprises changing different respective parts of the first three-dimensional computer model by different amounts using the different respective smoothing parameters.

3. A method according to claim 1, wherein the process of determining different respective smoothing parameters for different respective parts of the first three-dimensional computer model comprises determining the different respective smoothing parameters in dependence upon a curvature of parts of the silhouettes corresponding to the surface parts.

4. A method according to claim 3, wherein the process of determining different respective smoothing parameters for different respective parts of the first three-dimensional computer model comprises calculating a measure of the curvature of different parts of the silhouettes and setting smoothing parameters to give relatively low smoothing for each surface part of the first three-dimensional computer model corresponding to a part of at least one silhouette determined to have a relatively high curvature.

5. A method according to claim 4, wherein smoothing parameters to give relatively high smoothing are set for each surface part of the first three-dimensional computer model which does not correspond to a silhouette part determined to have a relatively high curvature.

6. A method according to claim 1, wherein the process of determining different respective smoothing parameters for different respective parts of the first three-dimensional computer model comprises determining the different respective smoothing parameters in dependence upon a width of parts of the silhouettes corresponding to the surface parts.

7. A method according to claim 6, wherein the process of determining different respective smoothing parameters for different respective parts of the first three-dimensional computer model comprises calculating a respective width of different parts of the silhouettes and setting smoothing parameters to give relatively low smoothing for each surface part of the first three-dimensional computer model corresponding to a part of at least one silhouette determined to have a relatively low width.

8. A method according to claim 7, wherein smoothing parameters to give relatively high smoothing are set for each surface part of the first three-dimensional computer model which does not correspond to a silhouette part determined to have a relatively low width.

9. A method according to claim 1, wherein:
the process of determining the different respective smoothing parameters comprises changing the relative spacing of surface points in the first three-dimensional computer model defining the object surface to provide a re-sampled first three-dimensional computer model; and
the process of changing the first three-dimensional computer model comprises moving at least some of the surface points in the re-sampled three-dimensional computer model to different positions in the three-dimensional space in dependence upon the spacing between the surface points in the re-sampled three-dimensional computer model.

10. A method according to claim 9, wherein the process of changing the relative spacing of surface points in the first three-dimensional computer model comprises inserting surface points into the first three-dimensional computer model defining the object surface and removing surface points from the first three-dimensional computer model defining the object surface to provide a re-sampled first three-dimensional computer model.

11. A method according to claim 9, wherein the process of determining different respective smoothing parameters for different respective parts of the first three-dimensional computer model comprises:
calculating a measure of the curvature of different parts of the silhouettes; and
changing the relative spacing of surface points in the first three-dimensional computer model to generate a re-sampled three-dimensional computer model having surface points spaced relatively close together in parts corresponding to silhouette parts determined to have a relatively high curvature and surface points spaced relative far apart in other parts.

12. A method according to claim 9, wherein the process of determining different respective smoothing parameters for different respective parts of the first three-dimensional computer model comprises:
calculating a respective width of different parts of the silhouettes; and
changing the relative spacing of surface points in the first three-dimensional computer model to generate a re-sampled three-dimensional computer model having surface points spaced relatively close together in parts corresponding to silhouette parts determined to have a relatively low width and surface points spaced relative far apart in other parts.

13. A method according to claim 1, wherein:
the process of determining the different respective smoothing parameters comprises calculating a respective smoothing weight value for each of a plurality of surface points in the first three-dimensional computer model defining the object surface; and
the process of changing the first three-dimensional computer model comprises moving each of at least some of the surface points to different positions in the three-dimensional space by a distance dependent upon the calculated smoothing weight value for the surface point.

14. A method according to claim 1, wherein, in the process of determining different respective smoothing parameters, surface points in the first three-dimensional computer model defining the object surface are projected into the silhouette images, and measures of the geometric property of the silhouette boundaries are calculated in dependence upon the projected points.

15. A method according to claim 1, further comprising calculating different respective displacements for different respective parts of the first three-dimensional computer model in dependence upon the silhouettes, and wherein the second three-dimensional computer model is generated by changing the first three-dimensional computer model in dependence upon the determined smoothing parameters and also in dependence upon the calculated displacements.

16. A method according to claim 15, wherein a respective displacement is calculated for each of at least some of the surface points in the three-dimensional computer model defining the object surface.

17. A method according to claim 16, wherein the displacement calculated for each of the at least some surface points comprises a displacement to move the surface point to a position in three-dimensional space from which it projects to a position in at least one of the images closer to the silhouette boundary therein.

18. A method according to claim 16, wherein:
each surface point in the three-dimensional computer model defining the object surface is projected into at least one of the images;
a respective displacement is calculated for each surface point in the three-dimensional computer model defining the object surface which projects to a point within a predetermined distance of the silhouette boundary in at least one image; and
the calculated displacements are used to calculate a respective displacement for each surface point in the three-dimensional computer model defining the object surface which does not project to within the predetermined distance of the silhouette boundary in at least one image.

19. A method according to claim 1, wherein the first three-dimensional computer model comprises a mesh of connected polygons having surface points comprising vertices of the polygons.

20. A method according to claim 1, wherein the first three-dimensional computer model comprises a plurality of voxels having surface points comprising points on or within the voxels.

21. A method according to claim 1, wherein the first three-dimensional computer model comprises data defining surface points in a three-dimensional space and a surface relative to the surface points.

22. A method according to claim 1, wherein the first three-dimensional computer model defines a three-dimensional surface enclosing only part of the object.

23. A method of generating a three-dimensional computer model of an object, comprising processing data defining surface points in three-dimensional space defining a surface enclosing at least part of the object and data defining an outline of the object in the three-dimensional space from a plurality of different directions relative thereto, to:
select a plurality of parts of the silhouettes in dependence upon the relative positions of the surface points and the silhouettes in three-dimensional space;
measure at least one geometric property of the selected silhouette parts;
determine a different respective smoothing parameter for each of at least some parts of the surface defined by the surface points in dependence upon the geometric property measurements;
calculate a respective displacement for each of at least some of the surface points to change the position of the surface point in three-dimensional space relative to the silhouettes; and
generate the three-dimensional computer model of the object in dependence upon the smoothing parameters and displacements.

24. A method according to claim 23, wherein the process of measuring at least one geometric property of the selected silhouette parts comprises calculating curvatures of the selected silhouette parts.

25. A method according to claim 23, wherein the process of measuring at least one geometric property of the selected silhouette parts comprises calculating at least one width for each of the selected silhouette parts.

26. A method of processing data defining a first three-dimensional computer model of the surface of an object, and data defining a respective silhouette of the object in each a plurality of images, to generate a second three-dimensional computer model representing the surface of the object, the method comprising:
projecting surface points in the first three-dimensional computer model from three-dimensional space into at least some of the images;
calculating at least one geometric property for each of a plurality of different parts of the silhouettes in dependence upon the projected surface points; and
changing the number of surface points in the first three-dimensional computer model to generate the second three-dimensional computer model in dependence upon the at least one calculated geometric property.

27. A method according to claim 26, wherein the process of calculating at least one geometric property for each of a plurality of different parts of the silhouettes comprises calculating at least one respective curvature for each of the plurality of different parts.

28. A method according to claim 26, wherein the process of calculating at least one geometric property for each of a plurality of different parts of the silhouettes comprises calculating at least one respective width for each of the plurality of different parts.

29. A method accnNoneXto claim 28, wherein the number of surface points in the first three-dimensional computer model is changed to increase the number of surface points in regions from which surface points project to a silhouette part determined to have a relatively narrow width.

30. A method according to any one of claims 1, 23 and 26, further comprising generating a signal carrying data defining the generated three-dimensional computer model.

31. A method according to any one of claims 1, 23 and 26, further comprising making a recording, either directly or indirectly, of data defining the generated three-dimensional computer model.

32. Apparatus operable to process data defining a first three-dimensional computer model of the surface of an object, and data defining a respective silhouette of the object in each of a plurality of images, to generate a second three-dimensional computer model representing the surface of the object, the apparatus comprising:
a smoothing parameter calculator operable to determine different respective smoothing parameters for different respective parts of the first three-dimensional computer model in dependence upon at least one geometric property of parts of the silhouettes corresponding to the surface parts; and
a three-dimensional computer model smoother operable to change the first three-dimensional computer model in dependence upon the determined smoothing parameters, to generate a second three-dimensional computer model of the object surface.

33. Apparatus according to claim 32, wherein the three-dimensional computer model smoother is operable to change different respective parts of the first three-dimensional computer model by different amounts using the different respective smoothing parameters.

34. Apparatus according to claim 32, wherein the smoothing parameter calculator is operable to determine different respective smoothing parameters for different respective parts of the first three-dimensional computer model in dependence upon a curvature of parts of the silhouettes corresponding to the surface parts.

35. Apparatus according to claim 34, wherein the smoothing parameter calculator comprises:
a curvature calculator operable to calculate a measure of the curvature of different parts of the silhouettes; and
a smoothing parameter controller operable to set smoothing parameters to give relatively low smoothing for each surface part of the first three-dimensional computer model corresponding to a part of at least one silhouette determined to have a relatively high curvature.

36. Apparatus according to claim 35, wherein the smoothing parameter controller is operable to set smoothing parameters to give relatively high smoothing for each surface part of the first three-dimensional computer model which does not correspond to a silhouette part determined to have a relatively high curvature.

37. Apparatus according to claim 32, wherein the smoothing parameter calculator is operable to determine different respective smoothing parameters for different respective parts of the first three-dimensional computer model in dependence upon a width of parts of the silhouettes corresponding to the surface parts.

38. Apparatus according to claim 37, wherein the smoothing parameter calculator comprises:
a width calculator operable to calculate a respective width of different parts of the silhouettes; and
a smoothing parameter controller operable to set smoothing parameters to give relatively low smoothing for each surface part of the first three-dimensional computer model corresponding to a part of at least one silhouette determined to have a relatively low width.

39. Apparatus according to claim 38, wherein the smoothing parameter controller is operable to set smoothing parameters to give relatively high smoothing for each surface part of the first three-dimensional computer model which does not correspond to a silhouette part determined to have a relatively low width.

40. Apparatus according to claim 32, wherein:
the smoothing parameter calculator is operable to change the relative spacing of surface points in the first three-dimensional computer model defining the object surface to provide a re-sampled first three-dimensional computer model; and
the three-dimensional computer model editor is operable to move at least some of the surface points in the re-sampled three-dimensional computer model to different positions in the three-dimensional space in dependence upon the spacing between the surface points in the re-sampled three-dimensional computer model.

41. Apparatus according to claim 40, wherein the smoothing parameter calculator is operable to change the relative spacing of surface points in the first three-dimensional computer model by inserting surface points into the first three-dimensional computer model defining the object surface and removing surface points from the first three-dimensional computer model defining the object surface to provide a re-sampled first three-dimensional computer model.

42. Apparatus according to claim 40, wherein the smoothing parameter calculator is operable to:
calculate a measure of the curvature of different parts of the silhouettes; and
change the relative spacing of surface points in the first three-dimensional computer model to generate a re-sampled three-dimensional computer model having surface points spaced relatively close together in parts corresponding to silhouette parts determined to have a relatively high curvature and surface points spaced relative far apart in other parts.

43. Apparatus according to claim 40, wherein the smoothing parameter calculator is operable to:
calculate a respective width of different parts of the silhouettes; and
change the relative spacing of surface points in the first three-dimensional computer model to generate a re-sampled three-dimensional computer model having surface points spaced relatively close together in parts corresponding to silhouette parts determined to have a relatively low width and surface points spaced relative far apart in other parts.

44. Apparatus according to claim 32, wherein:
the smoothing parameter calculator is operable to calculate a respective smoothing weight value for each of a plurality of surface points in the first three-dimensional computer model defining the object surface; and
the three-dimensional computer model editor is operable to move each of at least some of the surface points to different positions in the three-dimensional space by a distance dependent upon the calculated smoothing weight value for the surface point.

45. Apparatus according to claim 32, wherein the smoothing parameter calculator is operable to project surface points in the first three-dimensional computer model defining the object surface into the silhouette images, and to calculate a measure at least one geometric property of the silhouette boundaries in dependence upon the projected points.

46. Apparatus according to claim 32, further comprising a displacement calculator operable to calculate different respective displacements for different respective parts of the first three-dimensional computer model in dependence upon the silhouettes, and wherein the three-dimensional computer model editor is operable to change the first three-dimensional computer model in dependence upon the determined smoothing parameters and also in dependence upon the calculated displacements to generate the second three-dimensional computer model.

47. Apparatus according to claim 46, wherein the displacement calculator is operable to calculate a respective displacement for each of at least some of the surface points in the three-dimensional computer model defining the object surface.

48. Apparatus according to claim 47, wherein the displacement calculator is operable to calculate a respective displacement for each of the at least some surface points comprising a displacement to move the surface point to a position in three-dimensional space from which it projects to a position in at least one of the images closer to the silhouette boundary therein.

49. Apparatus according to claim 47, wherein the displacement calculator is operable to:
project each surface point in the three-dimensional computer model defining the object surface into at least one of the images;
calculate a respective displacement for each surface point in the three-dimensional computer model defining the object surface which projects to a point within a predetermined distance of the silhouette boundary in at least one image; and
use the calculated displacements to calculate a respective displacement for each surface point in the three-dimensional computer model defining the object surface which does not project to within the predetermined distance of the silhouette boundary in at least one image.

50. Apparatus according to claim 32, wherein the apparatus is operable to process a first three-dimensional computer model comprising a mesh of connected polygons having surface points comprising vertices of the polygons.

51. Apparatus according to claim 32, wherein the apparatus is operable to process a first three-dimensional computer model comprising a plurality of voxels having surface points comprising points on or within the voxels.

52. Apparatus according to claim 32, wherein the apparatus is operable to process a first three-dimensional computer model comprising data defining surface points in a three-dimensional space and a surface relative to the surface points.

53. Apparatus according to claim 32, wherein the apparatus is operable to process a first three-dimensional computer model defining a three-dimensional surface enclosing only part of the object.

54. Apparatus operable to generate a three-dimensional computer model of an object, comprising:
a data store to store data defining surface points in three-dimensional space defining a surface enclosing at least part of the object and data defining an outline of the object in the three-dimensional space from a plurality of different directions relative thereto;
a silhouette part selector operable to select a plurality of parts of the silhouettes in dependence upon the relative positions of the surface points and the silhouettes in three-dimensional space;
a geometric property measurer operable to measure at least one geometric property of the selected silhouette parts;
a smoothing parameter calculator operable to determine a different respective smoothing parameter for each of at least some parts of the surface defined by the surface points in dependence upon the geometric property measurements;
a displacement calculator operable to calculate a respective displacement for each of at least some of the surface points to change the position of the surface point in three-dimensional space relative to the silhouettes; and
a three-dimensional computer model generator operable to generate the three-dimensional computer model of the object in dependence upon the smoothing parameters and displacements.

55. Apparatus according to claim 54, wherein the geometric property measurer comprises a silhouette curvature calculator operable to calculate curvatures of the selected silhouette parts.

56. Apparatus according to claim 54, wherein the geometric property measurer comprises a silhouette width calculator operable to calculate at least one width for each of the selected silhouette parts.

57. Apparatus operable to process data defining a first three-dimensional computer model of the surface of an object, and data defining a respective silhouette of the object in each a plurality of images, to generate a second three-dimensional computer model representing the surface of the object, the apparatus comprising:
a surface point projector operable to project surface points in the first three-dimensional computer model from three-dimensional space into at least some of the images;
a geometric property calculator operable to calculate at least one geometric property for each of a plurality of different parts of the silhouettes in dependence upon the projected surface points; and
a three-dimensional computer model editor operable to change the number of surface points in the first three-dimensional computer model to generate the second three-dimensional computer model in dependence upon the at least one calculated geometric property.

58. Apparatus according to claim 57, wherein the geometric property calculator comprises a silhouette curvature calculator operable to calculate at least one respective curvature for each of the plurality of different parts of the silhouettes.

59. Apparatus according to claim 57, wherein the geometric property calculator comprises a silhouette width calculator operable to calculate at least one respective width for each of the plurality of different parts of the silhouettes.

60. Apparatus according to claim 59, wherein the three-dimensional computer model editor is operable to increase the number of surface points in regions from which surface points project to a silhouette part determined to have a relatively narrow width.

61. A storage medium storing a computer program instructions for programming a programmable processing apparatus to become operable to perform a method as set out in any one of claims 1, 23 and 26.

62. A physically-embodied computer program product carrying computer program instructions for programming a programmable processing apparatus to become operable to perform a method as set out in any one of claims 1, 23 and 26.

63. Apparatus operable to process data defining a first three-dimensional computer model of the surface of an object, and data defining a respective silhouette of the object in each of a plurality of images, to generate a second three-dimensional computer model representing the surface of the object, the apparatus comprising:
means for determining different respective smoothing parameters for different respective parts of the first three-dimensional computer model in dependence upon at least one geometric property of parts of the silhouettes corresponding to the surface parts; and
means for changing the first three-dimensional computer model in dependence upon the determined smoothing parameters, to generate a second three-dimensional computer model of the object surface.

64. Apparatus operable to generate a three-dimensional computer model of an object, comprising:
means for storing data defining surface points in three-dimensional space defining a surface enclosing at least part of the object and data defining an outline of the object in the three-dimensional space from a plurality of different directions relative thereto;
means for selecting a plurality of parts of the silhouettes in dependence upon the relative positions of the surface points and the silhouettes in three-dimensional space;
means for measuring at least one geometric property of the selected silhouette parts;
means for determining a different respective smoothing parameter for each of at least some parts of the surface defined by the surface points in dependence upon the geometric property measurements;
means for calculating a respective displacement for each of at least some of the surface points to change the position of the surface point in three-dimensional space relative to the silhouettes; and
means for generating the three-dimensional computer model of the object in dependence upon the smoothing parameters and displacements.

65. Apparatus operable to process data defining a first three-dimensional computer model of the surface of an object, and data defining a respective silhouette of the object in each a plurality of images, to generate a second three-dimensional computer model representing the surface of the object, the apparatus comprising:
means for projecting surface points in the first three-dimensional computer model from three-dimensional space into at least some of the images;
means for calculating at least one geometric property for each of a plurality of different parts of the silhouettes in dependence upon the projected surface points; and
means for changing the number of surface points in the first three-dimensional computer model to generate the second three-dimensional computer model in dependence upon the at least one calculated geometric property.
